(19) United States
(12) Patent Application Publication
(10) Pub. No.: US 2008/0183639 A1
(43) Pub. Date: Jul. 31, 2008

(54) System and Method for Securities Liquidity Flow Tracking, Display and Trading

(76) Inventor: Dean F. DiSalvo, Orlando, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/014,751

(22) Filed: Jan. 15, 2008

Related U.S. Application Data
(63) Continuation-in-part of application No. 11/106,423, filed on Apr. 14, 2005.
(60) Provisional application No. 60/885,090, filed on Jan. 16, 2007.

(51) Int. Cl. G06Q 40/00

(52) U.S. Cl. 705/36 R

(57) ABSTRACT

A method, system and computer program that receives, processes, and displays level one, level two, and time and sales securities data. Through a variety of charts, the data is analyzed to identify liquidity trade imbalances and trends in trading liquidity. A logic based trading algorithm utilizes the current market maker activity information and the historical liquidity tiers to execute trades automatically.

### RELATED APPLICATION DATA

The present application claims the benefit under Section 119(e) of the provisional patent application filed on Jan. 16, 2007 and assigned application No. 60/885,090.

### TECHNICAL FIELD

The invention relates generally to securities trading methodologies and more specifically to a real-time monitoring and historical analysis of securities market activity and liquidity flow for several securities simultaneously. The invention can be applied to any system that has multiple data sets to be graphed, analyzed, and optimized.

### BACKGROUND OF THE PRESENT INVENTION

In a securities market, shares of stock in corporations and options thereon, commodity futures and options thereon, currencies and the like are traded over a common system or exchange. Other traded items can include, but are not limited to, indices and mutual funds. For simplicity, however, the following discussion is limited to the purchase and sale of corporate stock, although the teachings of the present invention are not limited thereto and can be applied to all types of securities. Within the exchange, traders buy and sell securities using bids and offers. Offers are also referred to as asks. More specifically, market makers who are selling securities transmit “offers” or prices and volumes at which they will sell various securities. Market makers (also generally referred to as Market Players, ECNs, and Exchanges) who are buying securities transmit “bids” or prices and volumes at which they will buy various securities. Sellers attempt to sell at the highest possible price and buyers attempt to buy at the lowest possible price. The “inside market” represents the best price for sellers and buyers, and respectively is comprised of the lowest ask also known as the inside ask price or level one ask and the highest bid also known as the inside bid price or level one bid.

To maximize the profit taken from the securities market, traders desire certain information to determine when it is most advantageous to sell or buy a particular security. Traditionally, traders have tracked information derived from the “floor” of exchanges such as the New York Stock Exchange (NYSE), the National Association of Securities Dealers (NASDAQ), the Chicago Mercantile Exchange and the like. This information can be transmitted electronically in near real-time i.e., almost simultaneously with actual market activity, to computer workstations for traders to view and analyze in conjunction with buying and selling securities.

The information presently available to traders includes “level one” information and “level two” information. Level one information for a particular security typically includes, but is not limited to, the current trade value i.e., last trade, the current trade volume, the total volume of shares traded during the trading session, the price to earnings (PIE) ratio, the previous trading day's closing value, the present day's opening value, the high and low values for the day and for the previous 52 weeks, the change from the prior closing value, the lowest ask price and volume (inside ask), the highest bid price and volume (inside bid), the earnings per share, the market capitalization, the dividend paid per share, the dividend yield, news items and articles, and so forth. Also available are records of historical performance, which can be displayed graphically on a trade by trade basis or over periods of time ranging from fractions of seconds to years. Also available are statistics for an entire exchange, such as total volume of shares traded and statistics for calculated market indices, such as the Dow-Jones Industrial Average “The DOW”, the NASDAQ Composite, the Standard & Poor's 500 “S&P 500”, the Russell 2000, sector indices, etc.

Level two information for a particular security typically includes each market maker having an open or active bid or ask, the time when the bid or ask was placed, also referred to respectively as bid time and ask time, size or volume of the bid or ask i.e., number of shares (often reported in lots of 100) and the bid or ask price. Level two and market makers are typically associated with the NASDAQ market. For this invention, the term Level two (or market maker or market player) is not limited to the NASDAQ market, rather Level two (or market maker or market player) can apply to any Market, Exchange, ECN (Electronic Communication Network), or other entity that provides buy and sell quote order messages.

Many traders are interested in short term upward or downward price movements for selected securities. Upward and downward price movement can be predicted by observing level two information for trends of market makers as they offer and bid shares of various securities. Typically, the trader uses a computer monitor to display level two information for a few securities (for example, from one to three securities). The number of securities that can track from the displayed data is limited by the individual's memory capacity and cognitive ability. Obviously, it is impossible for a trader to assimilate tens or hundreds of dynamically updated informational items per security per second. As a result, most traders can effectively track only a few securities at a time. Skilled traders may be able to track several securities. Nevertheless, this technique is physically and mentally taxing on the trader. In addition, while a trader is tracking one or two securities, a purchase or sell opportunity for a different, untracked security may be missed.

At least one attempt to automate the analysis of level two information has been made. As discussed in U.S. Pat. No. 5,297,032, market depth for a watch list of securities is displayed by identifying the total number of market makers on the inside market for respective bid and offer quotes for each watch list security, along with arrows to indicate whether the number of market makers at these prices is increasing, constant, or decreasing. However, this system may not provide adequate or sufficient information for a trader to make a confident decision as to the appropriateness of purchasing or selling a particular security.

Accordingly, there exists a need in the art for a more sophisticated securities and market maker activity tracking system than the prior art provides.

### BRIEF DESCRIPTION OF DRAWINGS

The present invention can be more easily understood and the advantages and uses thereof more readily apparent when the following detailed description of the present invention is read in conjunction with the figures wherein:

FIG. 1 is a block diagram of a securities and market maker activity tracking system according to the present invention;

FIG. 2 illustrates the MB Trading main control GUI window 089 including a “Liquidity Flow” button 097.

FIGS. 3A and 3B illustrate a control GUI dialog box for the liquidity charting, pattern analysis, simulated trading, and automated trading.

FIG. 4 illustrates a more detailed view of certain elements of the control GUI dialog box with associated labels from FIG. 3.

FIG. 5 illustrates the display window for automated trade status and message update status.

FIG. 6 illustrates the MB Trading level 2 trade table.

FIG. 7 illustrates the chart hierarchy and various chart displays.

FIG. 8 illustrates a real-time or historical chart that shows the statistical liquidity (mean bid volume and mean ask volume) for several securities.

FIG. 9 illustrates a real-time or historical chart that shows the liquidity (or demand) for a security with price reaction across time (one hour in this example).

FIG. 10 illustrates a real-time or historical chart that shows the price tier and volume for every market maker for each security.

FIG. 11 illustrates a real-time or historical activity chart that shows the volume bid/ask per price tier for every market maker for each security for a given window of time (thirty minutes in this example).

FIG. 12 illustrates a real-time or historical chart that shows bid price, ask price, bid volume, and ask volume for a single market maker across time.

FIGS. 13A-13E are flowcharts that illustrate the data feed and process timers.

FIG. 14 is a flowchart that illustrates the trading process decisions.

FIG. 15 is a flowchart that illustrates the simulated trading process.

FIG. 16 is a flowchart that illustrates the trading algorithm pattern identification stages.

FIG. 17 illustrates a sample pattern definition table.

FIG. 18 illustrates a sample condition table.

FIG. 19 illustrates a sample algorithm table.

FIG. 20 illustrates a sample automated algorithm creation form.

FIG. 21 illustrates a sample user control GUI form

FIG. 22 illustrates a sample user control GUI form, highlighting the Chart Controls section.

FIG. 23 illustrates a sample user control GUI form, highlighting the Message and Display sections.

FIG. 24 illustrates a sample user control GUI form, highlighting the Active MPs and Trading Statistics sections.

FIG. 25 illustrates a sample graph with Trade Price, Level 1 Bid and Ask Price, and Trade Volume.

FIG. 26 illustrates a sample graph with Level 1 Bid and Ask Price, Market Player Bid and Ask Price, and Market Player Bid and Ask Volume in Raw format.

FIG. 27 illustrates a sample graph with Trade Price, Level 1 Bid and Ask Price, and Market Player Bid and Ask Volume in Binned format.

FIG. 28 illustrates a sample graph with Trade Price, Level 1 Bid and Ask Price, Market Player Bid and Ask Volume, and the Exponential Moving Average of the Market Player Bid and Ask Volume in Binned format.

FIG. 29 illustrates a sample graph with Trade Price, Level 1 Bid and Ask Price, Market Player Bid and Ask Volume, the Exponential Moving Average of the Market Player Bid and Ask Volume, and the difference between the Bid and Ask Exponential Moving Average in Binned format.

FIG. 30 illustrates a sample graph with Trade Price, Level 1 Bid and Ask Price, Market Player Bid and Ask Volume, the Exponential Moving Average of the Market Player Bid and Ask Volume, the difference between the Bid and Ask Exponential Moving Average, and a Table with the data values in Binned format.

FIG. 31 illustrates a sample XY scatter plot of the Bid Price and Ask Price Delta from Best Bid Price and Ask Price over time.

FIG. 32 illustrates a sample graph with multiple securities, multiple Bid and Ask price tiers, across time.

FIG. 33 illustrates a sample graph of Bid and Ask Price distribution in a histogram format.

FIG. 34 illustrates a sample user interface form that provides General graph feature options.

FIG. 35 illustrates a sample user interface form that provides Plot graph feature options.

FIG. 36 illustrates a sample user interface form that provides Subsets graph feature options.

FIG. 37 illustrates a sample user interface form that provides Points graph feature options.

FIG. 38 illustrates a sample user interface form that provides Font graph feature options.

FIG. 39 illustrates a sample user interface form that provides Color graph feature options.

FIG. 40 illustrates a sample user interface form that provides Style graph feature options.

FIG. 41 illustrates a sample user interface form that provides Axis graph feature options.

FIG. 42 illustrates a sample user interface form that provides Export graph feature options.

FIG. 43 illustrates a sample collection of data sources integrated into the trading system.

FIG. 44 illustrates a sample Insider Trading matrix.

Reference characters denote like elements throughout the figures and text.

### DETAILED DESCRIPTION OF THE INVENTION

Introduction

In the detailed description that follows, identical components have been given the same reference numerals in different embodiments of the present invention. To illustrate the present invention in a clear and concise manner, the drawings may not necessarily be to scale and certain features may be shown in somewhat schematic form. So as not to obscure the disclosure with details that will be readily apparent to those skilled in the art, certain conventional elements and steps have been presented with lesser detail, while the drawings and the specification describe in greater detail other elements and steps pertinent to understanding the invention.

The present invention relates to systems and associated methods of displaying, tracking and analyzing securities traded over a common market. The systems and associated methods assist a user to track and analyze the activity of market makers involved in the purchase and sale of the traded securities. In doing so, the systems and associated methods identify market maker activity trends, or indicators, potentially leading to short term (i.e., a limited duration of time, for example, between several seconds to perhaps as long as several hours) upward or downward price movement in a security. The systems and methods use sets of dynamically updated information elements relating to market maker activity and statistics derived there from to present the user with information regarding the activity of market makers involved in the purchase and sale of the traded securities.

It should be appreciated that the present invention may be practiced in a variety of ways beyond the specific details presented in this document. The invention can be adapted to any type of trading for domestic or foreign markets. The general concepts disclosed can be adapted for the display of any type of information. Specifically, the basic concepts disclosed can be expanded to any data sets and subsets of data.

It should be appreciated that network links connecting the elements can be wired or wireless, or any combination of wired and wireless. The only requirement is a “connection” that is capable of supplying the data. Under some circumstances, the user may enter the data manually.

It should be further appreciated that the trading methodology presented in this invention can be implemented in hardware, software, or a combination of hardware and software. Some examples of the hardware that can implement the trading methodology include: a computer, multiple computers networked together, a cell phone, a pocket PC, customized programmable logic, or any combination of the above.

The current art provides a wide variety of existing products intended to aid a trader or investor in making a trade decision. It should be appreciated that this invention can be used as a stand-alone tool, or can serve as a module within the existing or future trading system products. This invention is fully compatible and would provide a valuable improvement to all existing trading systems, such as TradeStation, TDAmeritrade's QuoteScope, and E-Trade to name a few.

While this invention allows the user to graphically visualize the balance (and therefore the imbalance) between supply and demand in the securities market, it can also be applied to any application where there is a negotiation between purchase price and sales price. This invention can be applied to any supply and demand situation, thus minimizing purchase price and maximizing selling price. As an example, a lumber company has identified several vendors that can supply their basic inventory of materials. The lumber company can apply the methodologies outlined in this invention to quantify required inventory, predict future inventory needs, negotiate an optimized price for such materials, and therefore maximize profits. The same lumber company can then apply the methodologies outlined in this invention to determine demand from their customers, review their current inventory, and set an optimized price for the resale of the materials.

Features defined in existing patents, trading systems, and software are fully compatible with the present invention. For example, user-defined line colors, styles, and types may not have been explicitly defined in this invention, but these option controls are common practice among most existing graphical software products. For completeness, the specific features associated with TradeStation (version 8.2) are presented along with how the feature applies to the present invention. If the feature is specific to the TradeStation software package, then the compatibility of this new invention will be noted. Where this invention can provide an improvement to current trading systems, such as TradeStation, the improvements and advantages are presented.

According to one aspect of the invention, a method includes tracking activity of a plurality of market makers (or other trading entities, such as Exchanges or ECNs) relating to securities traded on at least one common exchange where the market makers place bids and asks. The method includes receiving a dynamically updated data stream containing level one and level two data related to a plurality of securities traded over at least one exchange, the level one data comprising at least the last trade price, the best bid price, and the best ask price of each security and the level two data comprising a bid price, a bid time, a bid volume, a security identifier, and a market maker identifier for each bid, and an ask price, an ask volume, an ask time, a security identifier and a market maker identifier for each ask for a selected security.

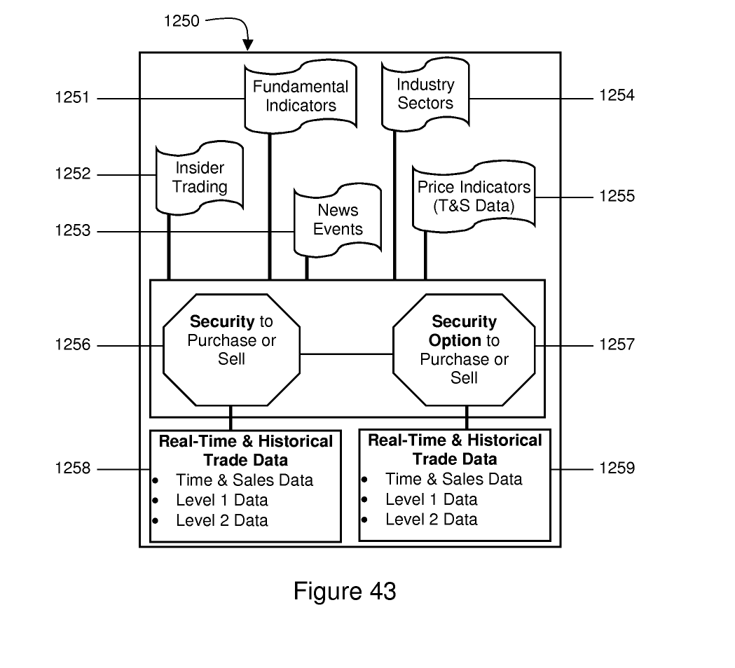

The current art provides a variety of methods to evaluate a security and determine the best time to enter a position or exit a position. For example, some traders focus on news events to evaluate a security, closely watching the Internet, newspaper, television and other media outlets for the latest updates on a security. If an unexpected earnings reports good news, the trader may then review a few fundamental indicators (such as profit to earnings ratio) and decide to purchase shares of the security. According to one aspect of the invention, a method that unites those trading strategies onto one platform is presented in FIG. 43 (1250). The user can define analysis alerts based on “Insider Trading” (1252), “Fundamental Indicators” (1251), “News Events” (1253), “Industry Sectors” (1254), “Price Indicators” (1255), “Security Order & Trade Data” (1258), and “Options Order & Trade Data” (1259). These alerts will alert the user to Buy or Sell the security. The invention can load data from all sources specified by the user, combine the various types of data onto customized graph(s) or table(s), simulate trading, alert the user in real-time, and perform automated trading. For example, the user may enable an alert to be displayed when the earnings report from a “News Event” (1253) occurs along with strong Level 2 Security Buying Pressure (1258). The “Alert” in simulated trading or automated trading can be based on any combination of the trading strategies.

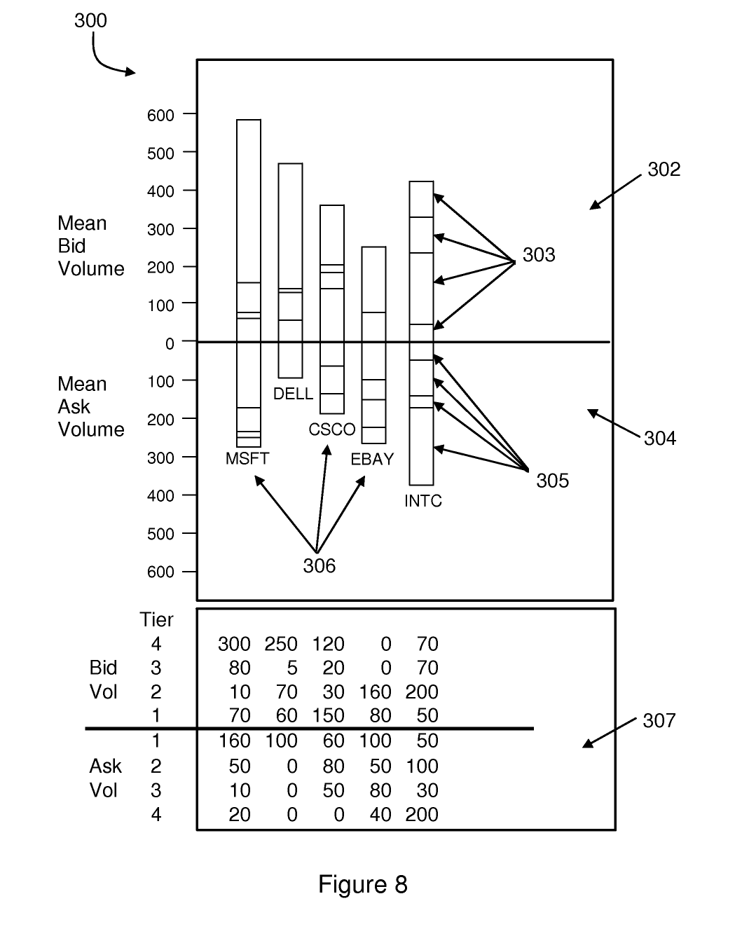

The current art provides tables, charts, simulated trading and automated trading based on a real-time snapshot of the level two data. The user can choose to permit the present invention to automatically trade or to display an alert. Traditionally, a trader uses his/her experience and memory to recognize a favorable pattern and place a trade when that pattern is identified. A method that allows the trader to view the liquidity imbalance (also referred to as the liquidity trade imbalance or the liquidity flow imbalance) of several securities at once, according to the teachings of the present invention and as illustrated in FIG. 8, is an improvement to the current art. The invention is further advantageous in that it allows for the aggregation of the level one, level two and time and sales data across a plurality of market makers, Exchanges and ECN'S.

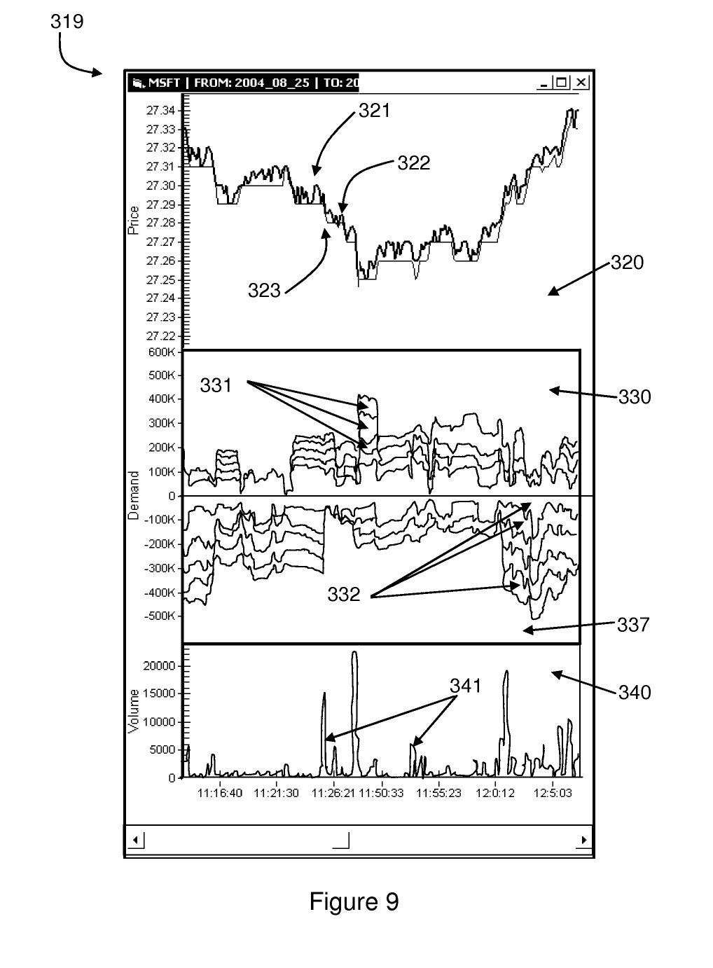

The current art further provides tables, charts, and automated trading based on a real-time snapshot of the level one, level two, and time and sales data. Viewing only a real-time snapshot fails to show the relationship between the level two data and the resulting price change. According to one embodiment of the present invention as illustrated in FIG. 9, an historical chart showing the liquidity imbalance and trade price reaction, as a function of time, provides a greater insight into the understanding and analysis of market activities.

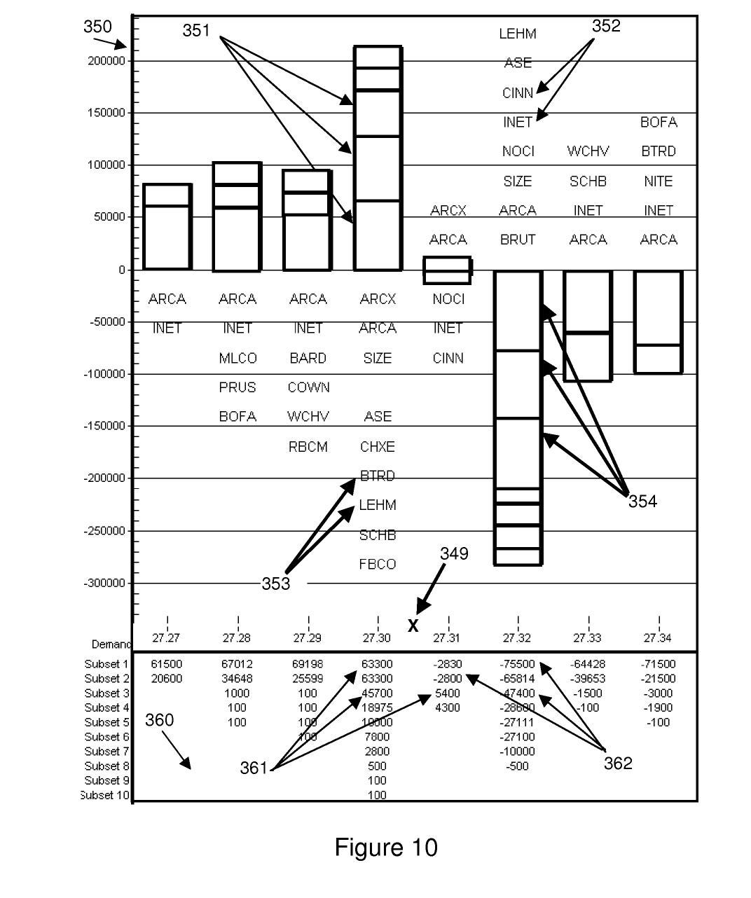

The current art provides a method for viewing real-time market maker liquidity. But, the current art fails to highlight the depth of the market imbalance. This invention provides an improved method of viewing the real-time market maker liquidity. As illustrated in FIG. 10, the chart has each market maker bid price and bid volume per price tier on a single positive axis, and each market maker ask price and ask volume per price tier on a single negative axis. Market imbalances, such as a crossed market, isolated pockets of liquidity and short-term price runs are quickly identified according to this method of viewing real-time market maker liquidity. For example, a large ramp up on the bid side for a few market makers with a large volume indicates an increase in demand, which typically results in an increase in trade price.

A “price tier”, as defined in the invention, is based on the bid price and ask price. The first price tier is the best bid price and the best ask price. The second price tier is one cent below the best bid price and one cent above the best ask price. The tenth price tier is nine cents below the best bid price and nine cents above the best ask price.

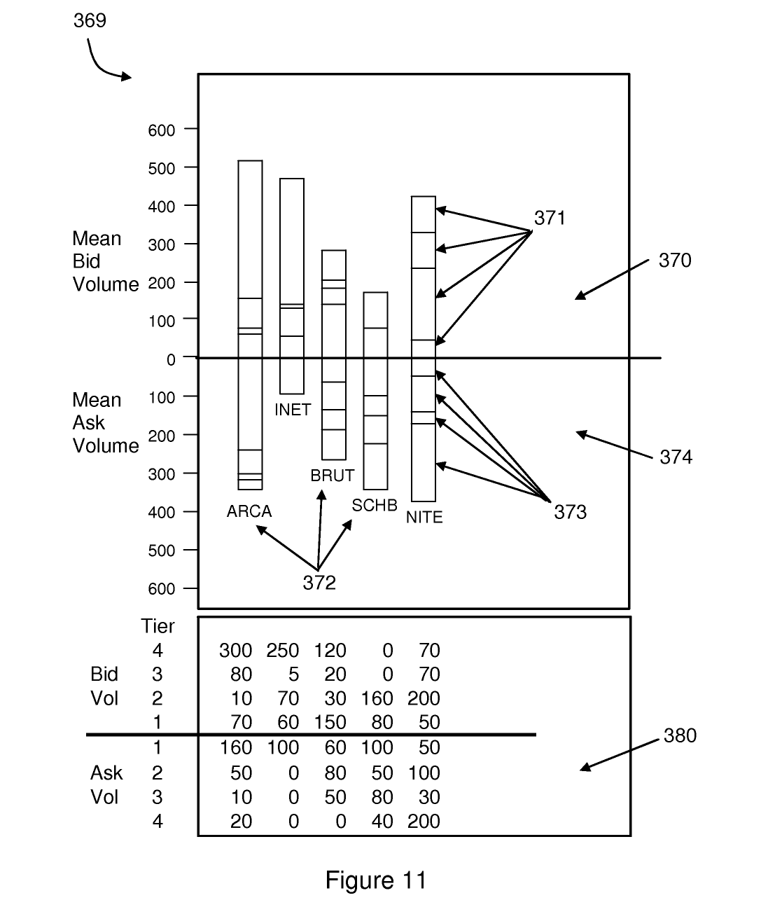

The current art attempts to identify market maker intentions by counting the number of times the market maker is on the “inside” market during a given time interval. Inside the market means the market maker has a bid or ask price at the best price. According to the teachings of the present invention, an improved method of identifying the market maker trading intentions, as illustrated in FIG. 11, is to view the volume for each market maker at each price tier for a given time window. Each market maker can be analyzed over a plurality of timeframes or time windows to isolate short-term and long-term trading patterns.

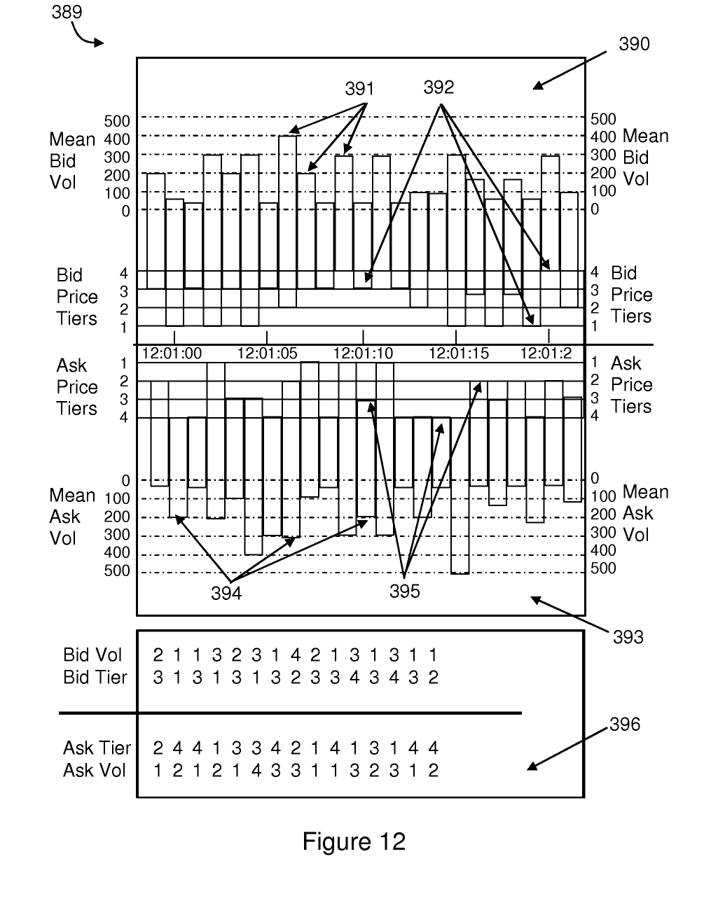

The current art provides tables, charts, and automated trading based on a real-time snapshot of the level one, level two, and time and sales data. The current art does not provide a method of viewing the historical bid price, bid volume, ask price, and ask volume for specific market maker. A chart that shows the market makers trading history across time is illustrated in FIG. 12. This method of charting provides a better depth and understanding of the market maker's true trading intentions.

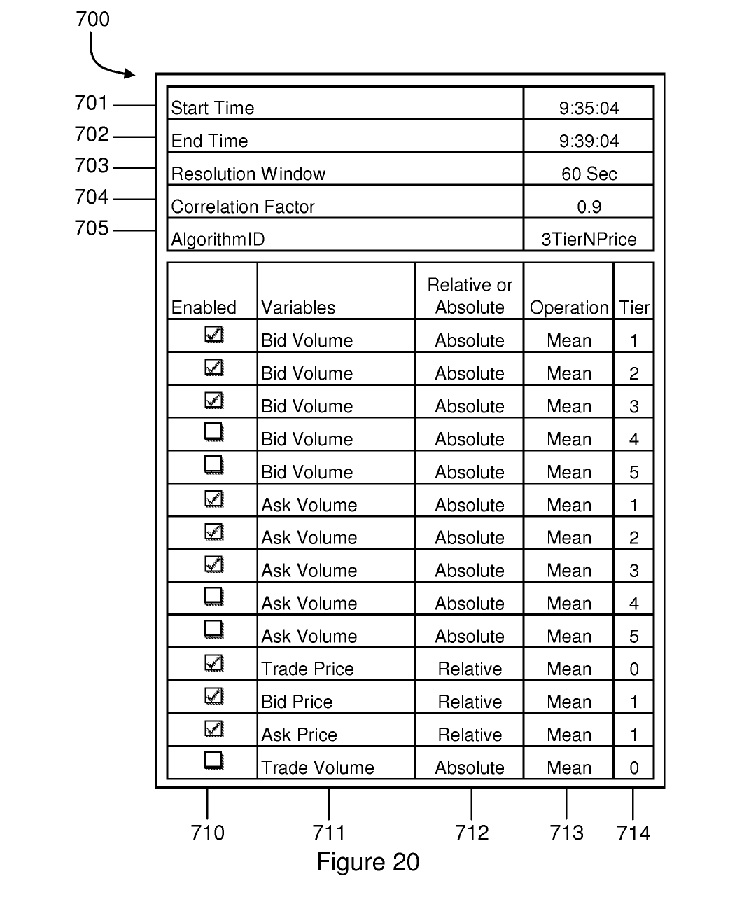

The present invention further comprises a method that allows the trader to specify favorable patterns in the level one, level two, and time and sales data. The pattern control variables can be defined either manually or automatically as illustrated in FIG. 20. Once the trading algorithm definitions are complete, the user can simulate trading with historical data, simulate trading with real-time data or perform automated trading, i.e., buying and selling of securities (all referred to as security transactions).

The information displayed to the user, including the calculated statistics, is dynamically sorted so that with each screen refresh, the displayed information is ordered appropriately according to the display method selected by the user.

Securities Liquidity Flow Tracking, Display and Trading System Overview

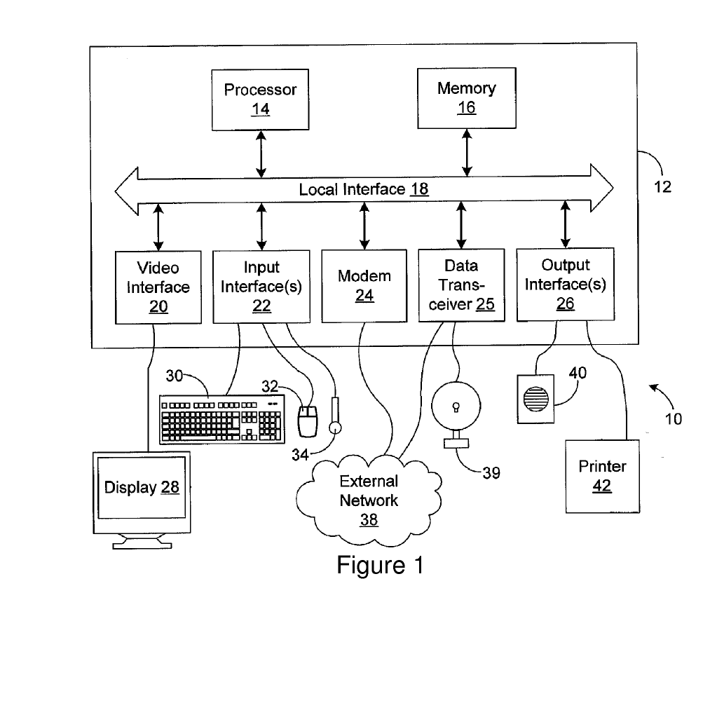

FIG. 1 illustrates a block diagram of a securities and market maker activity tracking system 10 embodying concepts of the present invention. As used herein, the term “security” or “securities” is intended to include, but is not limited to, shares of stocks in corporations or options thereon, corporate or government bonds, commodity futures or options thereon, currencies, options, indices, mutual funds and all other items traded over a common system or exchange. The term security can also include indices, such as for example, “the Dow”, “the NASDAQ composite”, a sector index or indicator and so forth. The term “symbol” or “symbols” includes securities and indices. Briefly, the system 10 is a data processor having a graphical user interface to assist a securities trader in analyzing information from security markets for opportune times to purchase or sell a particular security. Although the invention has application in tracking and analyzing securities of any type, the following discussion relates to the tracking and analysis of information related to the trading of shares of corporate stock on an exchange or exchanges, although the invention is not limited to the trading of corporate stock on an exchange. For example, the invention can be used by a buyer and seller of a product, such as lumber, as described above.

More specifically, the activity of market makers i.e., placement of bids and asks is analyzed according to the present invention as described further below. Many of the described operational modes according to the present invention are intended to identify temporary, typically short term, i.e., lasting from several seconds to perhaps as long as several hours, imbalances in individual or collective market maker activity that can lead to a price change in a particular security or index. These imbalances are also referred to as upward or downward price pressures and may last for few seconds, minutes or hours depending on market conditions.

The system 10 includes a computer system 12, that in one embodiment includes multiple remotely-located computers that communicate with the computer system 12 via known communications channels. However, in the illustrated exemplary embodiment of FIG. 1, the computer system 12 includes a single computer. The computer system 12 comprises one or more processors 14 for executing instructions, usually in the form of computer code, to carry out a specified logic routine. The computer system 12 further comprises a memory 16 for storing data, software, logic routine instructions, computer programs, data files, operating system instructions, and the like, as is well known in the art. The memory 16 comprises several devices, for example, volatile and non-volatile memory components. Volatile memory components typically do not retain data values upon a loss of power. Non-volatile memory components retain data upon a loss of power. Thus the memory 16 comprises, for example, random access memory RAM, read only memory ROM, hard disks, floppy disks, compact disks including, but not limited to, CD-ROM, DVD-ROM, and CD-RW, tapes, and/or other memory components, further comprising associated drives and players for these memory types. In a multiple-computer embodiment, the processor 14 can comprise multiple processors on one or more computer systems linked locally or remotely. According to one embodiment, the software of the present invention is segregated so that different software segments can be executed by different computers located locally or remotely from each other.

The processor 14 and the memory 16 are coupled to a local interface 18. The local interface 18 comprises, for example, a data bus with an accompanying control bus, or a network between a processor and/or processors and/or memory or memories. In various embodiments, the computer system 12 further comprises a video interface 20, one or more input interfaces 22, a modem 24 and/or a data transceiver interface device 25. The modem 24, the data receiver 25 and any other device for receiving and/or transmitting data are also referred to herein as a receiver, a receiving means and/or a transceiver. The computer system 12 further comprises a number of output interfaces 26 each being coupled to the local interface 18.

The system 10 further comprises a display 28 coupled to the local interface 18 via the video interface 20. Although shown as a single cathode ray tube CRT type display, multiple displays can be accommodated. Also, the display device can alternatively comprise, for example, a liquid crystal display LCD, a plasma display, an electro-luminescent display, indicator lights, or light emitting diodes LEDs. In other embodiments, the system 10 comprises several input devices including, but not limited to, a keyboard 30, a mouse 32, a microphone 34, a digital camera not shown and a scanner not shown, each being coupled to the local interface 18 via the input interfaces 22. The modem 24 and/or data receiver 25 can be coupled to an external network 38 enabling the computer system 12 to send and receive data signals, voice signals, video signals and the like via the external network 38 as is well known in the art. The external network 38 comprises, for example, the Internet, a wide area network WAN, a local area network LAN, a direct data link, or other similar network or communications link, including wireless networks. The modem 24 and/or the data receiver 25 can be coupled to receive data from a satellite transceiver 39, co-axial cable, fiber optic cable, etc. It is noted that the system 10 can be accessed and used by a remote user via the external network 38 and modem 24. The system 10 also comprises output devices coupled to the local interface 18 via the output interfaces 26, such as audio speakers 40, a printer 42, and the like.

The computer system 12 is programmed to display and execute a securities tracking software tool, according to the present invention, in graphical user interface GUI format. The computer system 12 also executes commands of the securities tracking software tool of the present invention as stored in the memory 16 or available remotely through the external network 38.

In one embodiment of the invention, in lieu of executing the software routines of the present invention on a local computer such as the computer system 12, a remote server receives pertinent data for analysis according to the teachings of the present invention, such as level one and level two data, and analyzes the data stream to produce statistics as described herein. The server outputs a data set, including the statistics, to a client computer or terminal over a network or communications link. The client can further process the received data and generate appropriate user displays.

According to one embodiment, the present invention receives data feeds from and utilizes the API (i.e., application programmers interface) with MB Trading Company of El Segundo, Calif. to gain access to level one data, level two data and time and sales data, and to conduct automated trading. As part of this API, several Active-X interfaces are made available to the user. These interface windows include watch lists, balances, alerts, level two information, open orders and positions. Those skilled in the art recognize that the present invention is capable of operating with securities information data feeds supplied by others, as the MB Trading Company feed is merely exemplary.

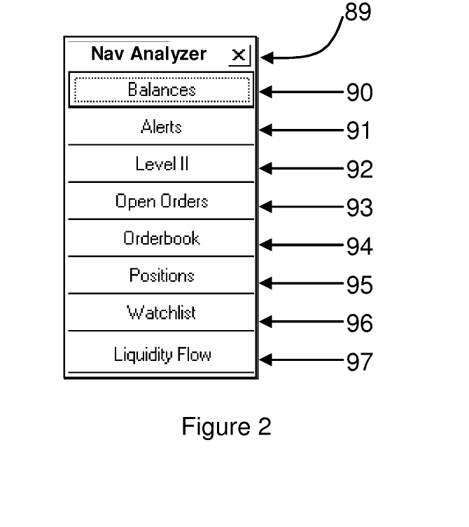

Referring to FIG. 2, a GUI diagram window 89, comprises, in one embodiment, eight mouse click buttons 90-97, wherein the button 97 launches a software module comprising features associated with the present invention. Each button is discussed in detail below.

The MB Trading “Balances” button 90 launches an Active-X window that provides user access to account balance and trading activity statistics such as buying power, account value, profit and loss.

The MB Trading “Alerts” button 91 launches an Active-X window that displays any trade errors that may have occurred, such as incorrectly submitting a trade order.

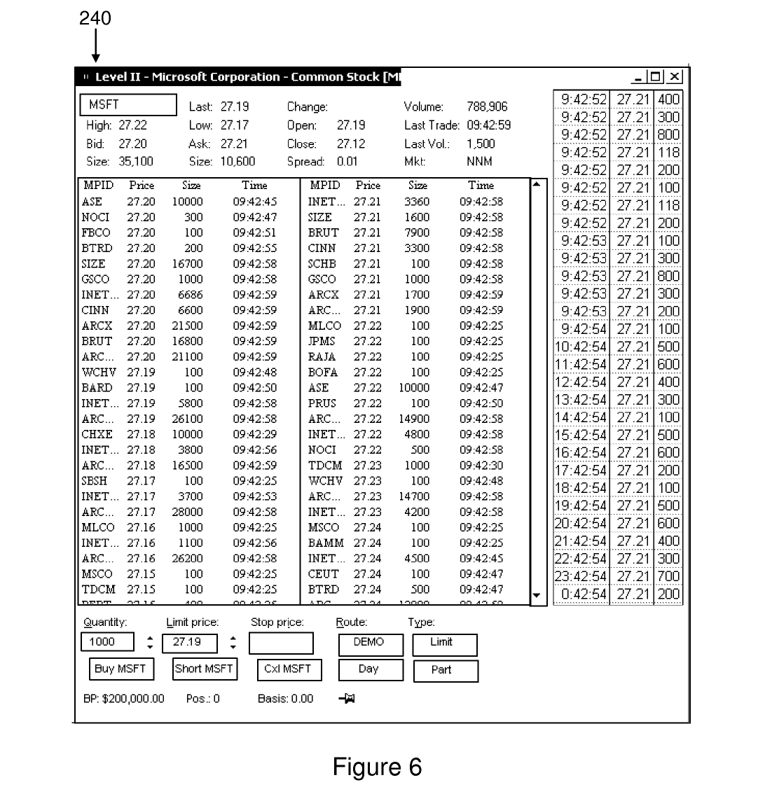

The MB Trading “Level II” button 92 launches an Active-X window that displays, in tabular form, the ticker symbol, market maker bid price, volume and time along one side of the table, and the market maker ask price, volume and time on the other side. The MB Trading Level II window is illustrated and further described in conjunction with FIG. 6. Other securities information such as high, low, bid, ask, change, size, spread, volume, last trade, and last volume are also included in the table display.

The MB Trading “Open Orders” button 93 launches an Active-X window that displays current live-order market status to the trader. All listed open orders are displayed along with the ticker symbol, desired bid or ask price, the current bid price, current ask price, and time when the order was placed.

The MB Trading “Orderbook” button 94 launches an Active-X window that displays all trade orders that have been placed for the day. All placed and executed orders are listed along with the ticker symbol, entry price, buy or sell, short or cover, trade route, and time.

The MB Trading “Positions” button 95 launches an Active-X window that displays current market positions to the trader. All currently held positions are listed along with ticker symbol, quantity, last trade price, change, basis, open, total, and stop price.

The MB Trading “Watch List” button 96 launches an Active-X window that displays for the user-defined trading information, such as ticker symbol, last trade price, bid price, bid size, ask price, ask size, high, low, previous close and volume.

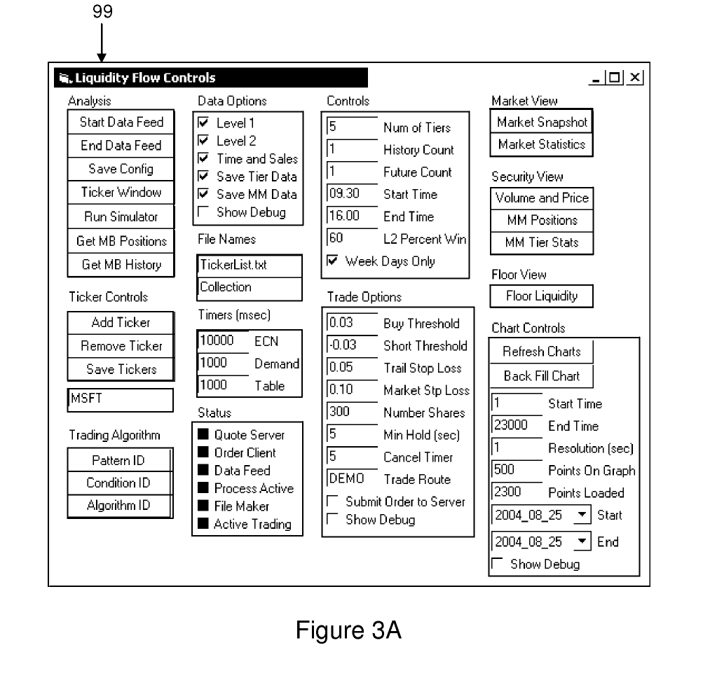

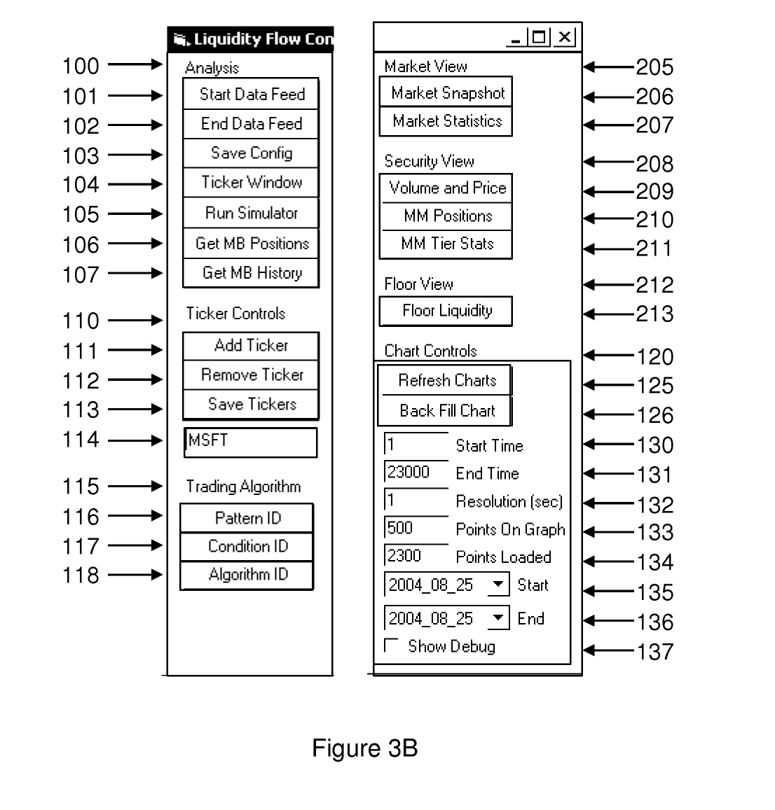

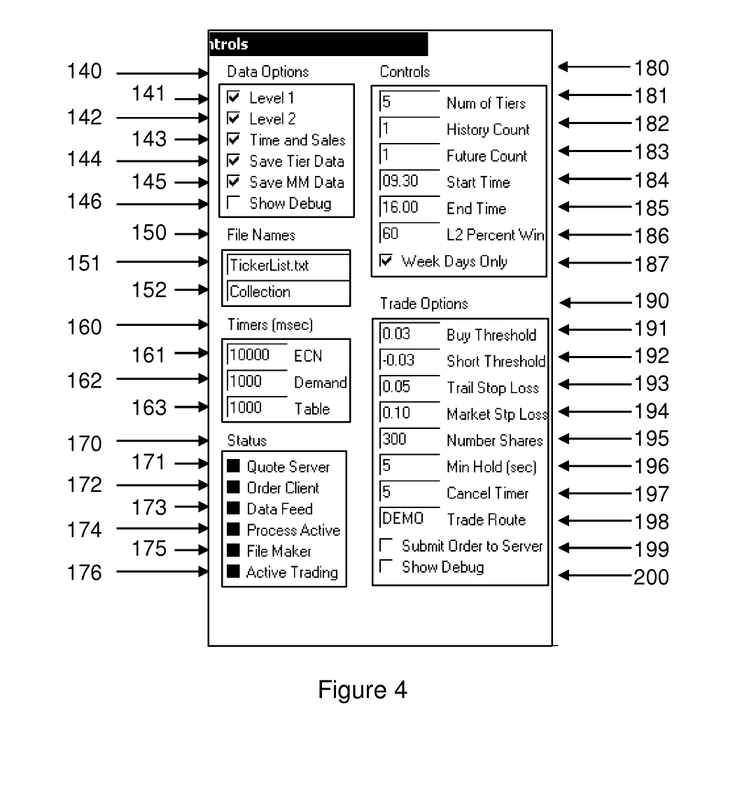

This invention presents a “Liquidity Flow” button 97 that launches a GUI liquidity flow controls interface 99 illustrated in FIGS. 3 and 4, comprising a plurality of user-controlled interface controls (i.e., input elements) that permit the user to filter and control the securities data supplied (for example by MB Trading Company), execute trades, control the contents and update frequency of the tier and market maker data files, control the simulated buy/sell options, control the automated buy/sell options and control the display or charting features. Generally, the GUI control interface 99 provides user control over execution of the liquidity flow program of the present invention. Using the GUI control interface 99, the user can, for example, load the chart windows (displays), backfill the charts with historical data, set automated trade options, perform trade simulations, begin and stop level one, level two, and time and sales data feeds, and set various timers and settings. With continuing reference to FIGS. 3 and 4, the GUI liquidity flow controls interface 99 contains user interface controls for the liquidity flow analysis, charting and trading, according to the teachings of the present invention. The liquidity flow controls are separated into several groups including: analysis 100, ticker controls 110, trading algorithm 115, data options 140, filenames 150, timers 160, status 170, controls 180, trade options 190, market view 205, security view 208, floor view 212, and chart controls 120. Each of these controls is described below.

Liquidity is defined generally as the degree to which a security can be purchased or sold without affecting the security. Liquidity flow is defined generally as the bid price, bid volume, ask price, and ask volume over time. A liquidity imbalance (or liquidity flow imbalance) is present if there is an unusually high bid volume or ask volume. As further described below, the imbalance can be identified automatically by the present invention according to user-defined trading algorithms or manually as the user reviews graphs and charts created according to the present invention.

The “Analysis” group 100 comprises, in one embodiment, seven mouse click buttons that initiate an action by the program. The mouse click buttons include: start data feed 101, end data feed 102, save configuration 103, ticker window 104, run simulator 105, get MB positions 106, and get MB history 107. Each of these mouse buttons is discussed below.

Upon clicking on the “Start Data Feed” button 101, the program sends a message to the data server enabling the level one, level two and time and sales streaming data feed for a ticker list of user-provided securities. The program dynamically creates the memory objects as necessary to process the streaming data feed.

Upon clicking on the “End Data Feed” button 102, the program sends a message to the data server disabling the level one, level two and time and sales streaming data feed for a user-defined list of securities or symbols. The program dynamically removes the memory objects as necessary.

Upon clicking on the “Save Configuration” button 103, the program saves the current variable settings to file. The file name for the configuration is defined in a textbox 151 of FIG. 4.

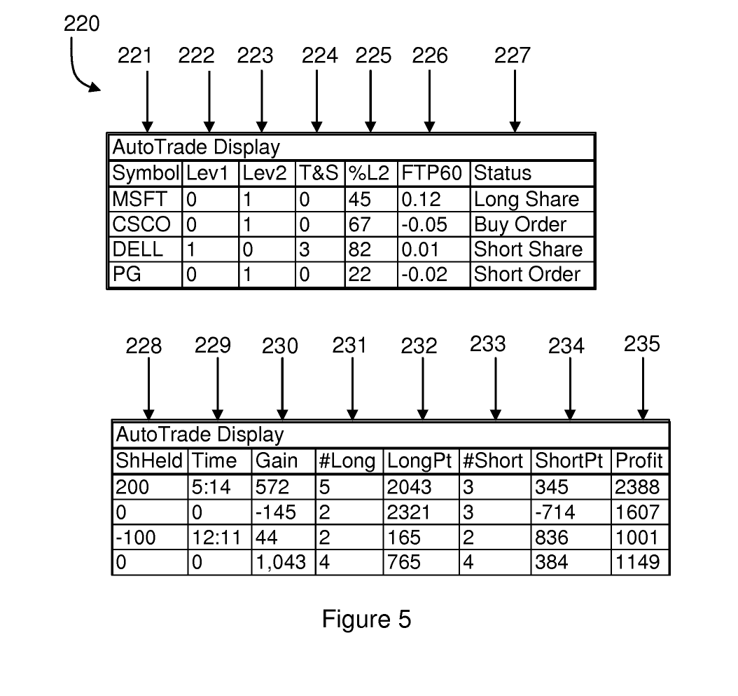

Upon clicking on the “Ticker Window” button 104, the program opens the auto trade display window 220 of FIG. 5.

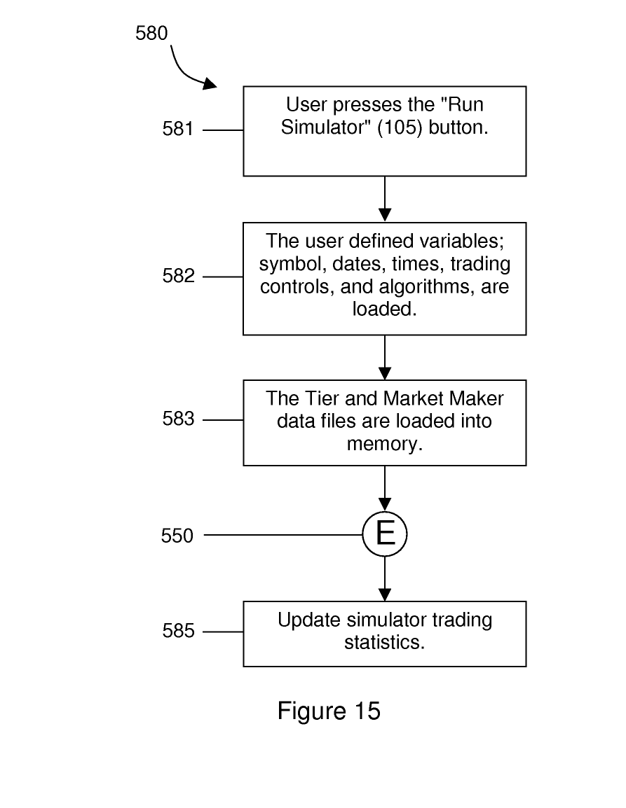

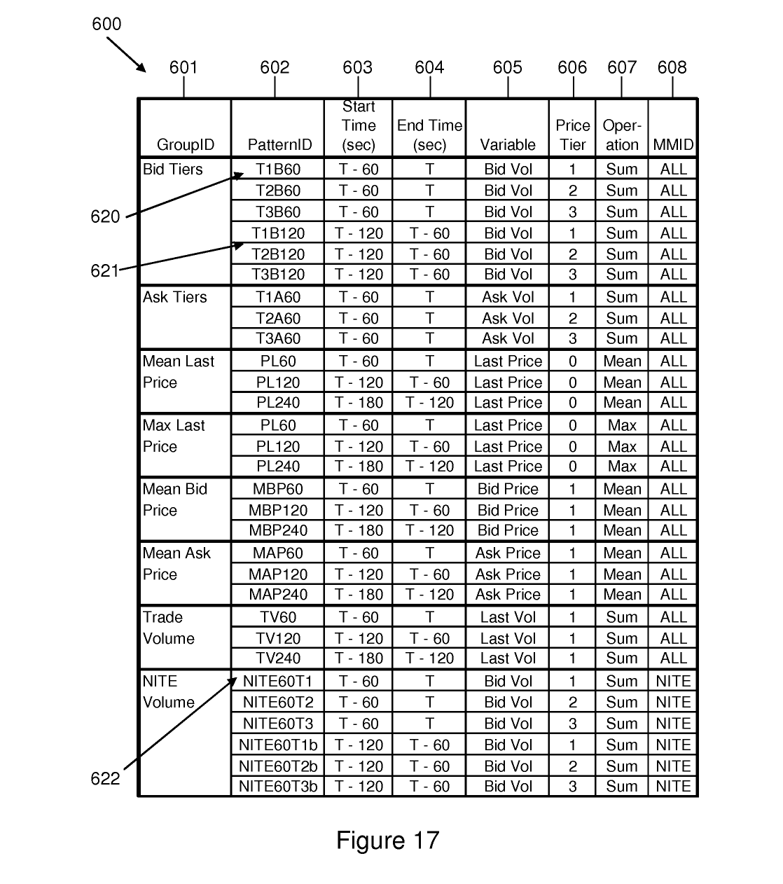

Upon clicking on the “Run Simulator” button 105, the program simulates trading based on threshold variables in the trade options 190 control group of FIG. 4, using historical securities data as recorded under user control by selecting the “Save Tier Data” checkbox 144 of FIG. 4. A flowchart for the simulated trading is illustrated in FIG. 15. As will be described further below, the user defines the simulation algorithms according to FIGS. 17-19. Clicking the “Run Simulator” button 105 causes the simulator to load the tier files and the market maker files into the memory 16. The simulator then checks the data for each timestamp entry to determine if a user-defined algorithm pattern is recognized. If a pattern is recognized, the simulator purchases the security based on the best ask price. The simulator holds the security until conditions indicate that it is time to sell (a trailing stop has been crossed, for example). The simulator sells the security based on the best ask price. The simulator tracks each trade and produces a final result of total trades and profit over the defined trading period.

Upon clicking on the “Get MB Positions” button 106, the program sends a message to the data server requesting an update of the currently held positions.

Upon clicking on the “Get MB History” button 107, the program sends a message to the data server requesting an update of the trade history for the day.

The “Ticker Controls” group 110, as part of the liquidity flow controls GUI 99, contains various ticker controls for the user. The controls include: an add ticker button 111, a remove ticker button 112, and a save ticker button 113 and a ticker textbox 114.

Upon clicking on the “Add Ticker” button 111, the program adds the ticker that is listed in the ticker textbox 114 to the ticker list. If data is currently being collected, the program also enables the collection of level one, level two and time and sales messaging (data streaming) for the security represented by the newly added ticker. Also, in one embodiment, whenever any of the chart windows or display windows of the present invention is displayed, the user can right mouse click to call up an option to add a ticker.

Upon clicking on the “Remove Ticker” button 112, the program removes the ticker that is highlighted in an auto trade display window 220 (see FIG. 5) from the ticker list. If data is currently being collected for that ticker symbol, the program disables further data collection for the deleted ticker. In one embodiment, a right mouse click permits the user to remove a ticker during display of the charts and windows of the present invention.

Upon clicking on the “Save Tickers” button 113, the program saves the tickers listed in the auto trade display window 220 (see FIG. 5) to a file.

The “Trading Algorithm” group 115, as part of the liquidity flow controls GUI 99, comprises three buttons that launch the algorithm control tables. The button controls include: PatternID 116, ConditionID 117, and AlgorithmID 118.

Upon clicking on the “PatternID” button 116, the program launches the pattern definition table illustrated in FIG. 17 and described below.

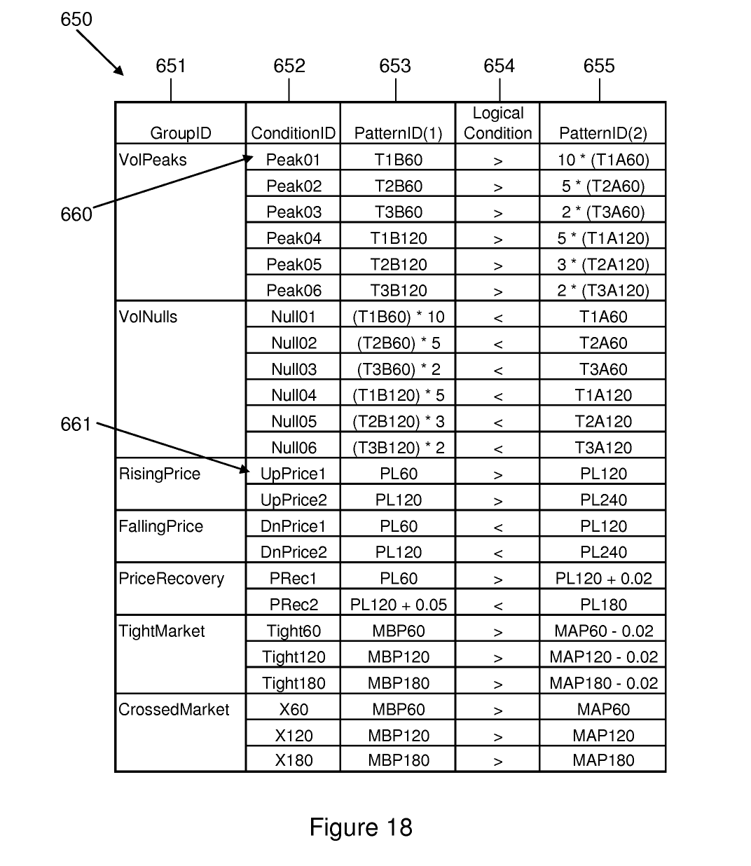

Upon clicking on the “ConditionID” button 117, the program launches the condition definition table illustrated in FIG. 18 and described below.

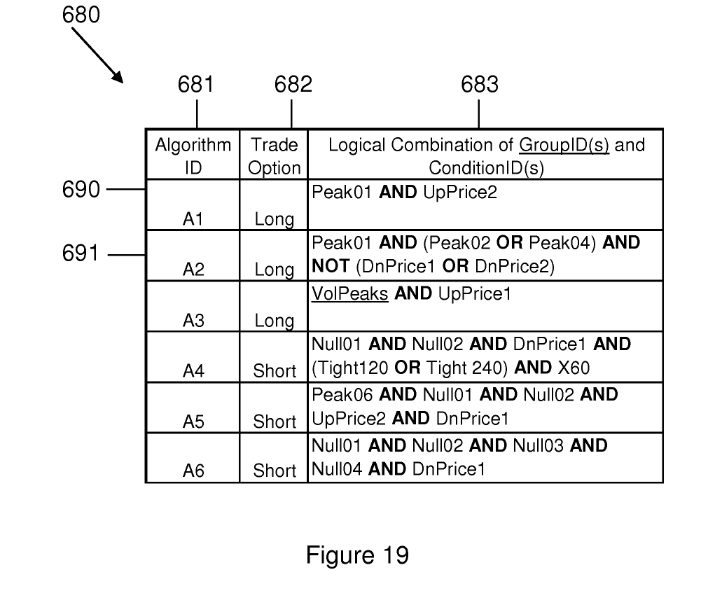

Upon clicking on the “AlgorithmID” button 118, the program launches the algorithm definition table illustrated in FIG. 19 and described below.

The “Market View” group 205, as part of the liquidity flow controls GUI 99, contains two buttons that launch the market view charts. The charting buttons include: market snapshot 206, and market statistics 207.

Upon clicking on the “Market Snapshot” button 206, the program launches a new chart window containing a snapshot of current market liquidity, as illustrated in FIG. 8.

Upon clicking on the “Market Statistics” button 207, the program launches a new chart window containing summary statistics of current market liquidity, as illustrated in FIG. 8. The statistics can be presented in text or graph form, such as the FIG. 8 bar graph.

The ‘Security View group 208, as part of the liquidity flow controls GUI 99, contains three buttons that launch the security view charts. The charting buttons include: volume and price 209, market maker positions 210 and market maker tier stats 211.

Upon clicking on the “Volume and Price” button 209, the program launches a new chart window containing the liquidity flow with price reaction information, as illustrated in FIG. 9.

Upon clicking on the “MM Positions” button 210, the program launches a new chart window containing a real-time snapshot of market maker price tier and volume information, as illustrated in FIG. 10.

Upon clicking on the “MM Tier Stats” button 211, the program launches a new chart window containing the real-time market maker statistical tiers, as illustrated in FIG. 11.

The “Floor View” group 212, as part of the liquidity flow controls GUI 99, contains one button that launches the market floor chart. The button is labeled “Floor Liquidity” 213.

Upon clicking on the “Floor Liquidity” button 213, the program launches a new chart window containing the real-time detailed market maker volume across time, as illustrated in FIG. 12.

The “Chart Controls” group 120, as part of the liquidity flow controls GUI 99, contains various charting controls for the user. The button controls include: refresh charts 125, and backfill chart 126. The textbox controls include start time 130, end time 131, resolution 132, points on graph or display time (typically in minutes) 133, points loaded 134, start date 135, end date 136 and show debug 137.

Upon clicking on the “Refresh Charts” button 125, the program sends a command to the open charts to refresh the graphics or update plot variables.

Upon clicking on the “Backfill Chart” button 126, the program loads the data defined by start date 135, end date 136, start time 130 and end time 131 into memory. The data is then loaded into a chart display.

By changing the “Start Time” textbox 130 the user sets the starting time in memory or a specific time in the day that the charts display.

By changing the “End Time” textbox 131 the user sets the final time in memory or a specific time in the day that the charts display.

By changing the “Resolution” textbox 132 the user sets a resolution filter for the display of data. A value of one includes every data point collected on the time charts. A resolution of two includes every other data point collected on the time charts. A resolution of three includes every third data point, and so on.

By changing the “Points On Graph” textbox 133 the user sets the number of x-axis points that are graphed in the liquidity flow price reaction chart as shown in FIG. 9.

By changing the “Points Loaded” textbox 134 the user sets the number of points loaded into memory for the liquidity flow price reaction chart of FIG. 9. The “points loaded” is the total number of points loaded into memory for a graph. If loading a historical graph, the program will load the 2300 points (as set forth in the exemplary textbox 134 of FIG. 3) into memory for graphing. A horizontal scroll bar is used to move the graph beyond the number of points displayed on the graph (as set for the in the exemplary textbox 133 of FIG. 3) If using a real-time graph, the program loads the historical data needed to fill the graph with the 2300 points. While the streaming feed is continuous, the graph updates occur on a user-defined time interval (typically, once every second).

By clicking on the “Start” date pull down textbox 135 the user sets the starting date for chart data and simulator analysis.

By clicking on the “End” date pull down textbox 136 the user sets the ending date for chart data and simulator analysis.

By clicking on the “Show Debug” checkbox 137 the user enables the viewing of several debug messages to the screen. The “Data Options” group 140, see FIG. 4, as part of the liquidity flow controls GUI 99 comprises messaging controls including: level one 141, level two 142, time and sales 143, save tier data 144, save market maker data 145 and show debug 146.

By selecting the “Level One” checkbox 141, the program sends a message to the data server enabling the level one messaging for all symbols in the ticker list. By unselecting the “level One” checkbox 141, the program sends a message to the data server disabling the level one messaging for all symbols listed in the auto display window 220 of FIG. 5.

By selecting the “Level Two” checkbox 142, the program sends a message to the data server enabling the level two messaging for all symbols in the ticker list. By unselecting the “level Two” checkbox 142, the program sends a message to the data server disabling the level two messaging for all symbols listed in the auto trade display window 220.

By selecting the “Times and Sales” checkbox 143, the program sends a message to the data server enabling the times and sales date feed for all symbols in the ticker list. Times and sales is a messaging format that is the actual ticker tape of trade activity. By unselecting the “times and sales” checkbox 143, the program sends a message to the data server disabling the times and sales messaging for all symbols in the ticker list.

By selecting the “Save Tier Data” checkbox 144, the program creates tier data files for all symbols in the ticker list. Each tier data file includes the following information, typically updated once every second: timestamp hour, minute, second, last price, tick, total volume, quote bid price, quote ask price, bidvoltier1 (bid volume tier 1), askvoltier1, bidvoltier2, askvoltier2, etc. The number of tiers is a user-defined parameter 181. A single tier, for example, provides the user with the best bid price, best ask price and their associated volumes. Although this is important information, it is limited in scope. For example, there may be a major seller of the security located at five cents above the best ask price. By requesting more than a single data tier, the user can see the large selling pressure that is five cents from the best ask price. This historical tier data file is later used to backfill various charts and perform simulated trading as described below.

By selecting the “Save MM Data” checkbox 145, the program creates the market maker “MM” data files for all symbols in the ticker list. The market maker data file includes the following information, typically updated once every second: timestamp hour, minute, second, market maker ID, market maker bid price, market maker ask price, market maker bid volume, market maker ask volume for each market maker within a user-defined number of price tiers. This historical market maker file is later used to backfill various charts and perform simulated trading.

By clicking on the “Show Debug” checkbox 146 the user enables the viewing of several debug messages to screen.

The “File Names” group 150, as part of the liquidity flow controls GUI 99, comprises the file name and location for the ticker list 151 and collection files 152.

The “TickerList.txt” textbox 151 defines the file name for the ticker list.

The “Collection” textbox 152 defines the directory where the tier files and market maker files are located.

The “Timers (msec)” 160 as part of the liquidity flow controls GUI 99, contains the various data collection and update timers. These include memory cleanup 161, demand calculations 162 and table updates 163.

The value in the “ECN” (Electronic Communications Network) textbox 161, as part of the liquidity flow controls GUI 99, controls how often (in milliseconds) the program goes through the market maker memory objects, in one embodiment, once every ten seconds. The memory objects are removed if they are not active. ECNs are public trade platforms where day traders, stock brokers, and even market makers place orders to buy and sell securities. The program of the present invention stores a memory object for every bid price, bid volume, ask price and ask volume, for each market maker and each ECN. As the trade price changes, more objects are created. The program eliminates the memory objects if their price is not within the current trade price, plus or minus the two times (in the preferred embodiment) the number of tiers as set forth in a number of tiers box 181.

The value in the “Demand” textbox 162, as part of the liquidity flow controls GUI 99, controls the frequency (or time interval) for calculating the volume per price tier from each market maker object, updates the memory objects for each graph and refreshes the view for each graph. The exemplary value of 1000 msec indicates that the algorithm calculations, such as check market maker memory objects and update the tier memory objects, write to file, perform automated trading, etc., are updated every second.

The value in the “Table” textbox 163, as part of the liquidity flow controls GUI 99, controls the update frequency (or time interval) of the auto trade display window 220. A value of 1000 msec indicates that the display window is updated every second.

The “Status” group 170, as part of the liquidity flow controls GUI 99, contains various data collection, data processing and active trading indicators. These indicators include: quote server 171, order server 172, data feed 173, process active 174, file maker 175 and active trading 176.

The light indicator “Quote Server” 171, as part of the liquidity flow controls GUI 99, shows the user the current connection status to the data quote server. If the color is green, the program is currently connected to the data quote server. If the color is red, the program is not connected to the quote server. The quote server is used to receive the level one, level two and time and sales data messages. Without a connection to the quote server, the charts and simulator utilize only historical data.

The light indicator “Order Server” 172, as part of the liquidity flow controls GUI 99, shows the user the current connection status to the order server. If the color is green, the program is currently connected to the order server. If the color is red, the program is not connected to the order server. The order server is used to execute trade commands and to access account information.

The light indicator “Data Feed” 173, as part of the liquidity flow controls GUI 99, shows the user the current data feed status. If the color is green, the program is receiving live level one, level two and time and sales data from the quote server. If the color is red, the program is not receiving live level one, level two, and time and sales data from the quote server.

The light indicator “Process Active” 174, as part of the liquidity flow controls GUI 99, shows the user the current program analysis status. If the color is green, the program is processing data for a simulation. If the color is red, the program is not processing data for a simulation.

The light indicator “File Maker” 175, as part of the liquidity flow controls GUI 99, shows the user the current program file making status. If the color is green, the program is writing to a file. If the color is red, the program is not writing data to file. The file types include configuration settings, ticker list, tier data files, and market maker data files.

The light indicator “Active Trading” 176, as part of the liquidity flow controls GUI 99, shows the user the current program trading status. If the color is flashing green, the program is in automatic trade mode. Thus in this mode if a data value falls below or rises above a predetermined trading threshold, the program trades of the present invention is automatically requested. If the color is red, the program is in manual trade mode, i.e., the user must manually initiate a trade.

The “Controls” group 180 as part of the liquidity flow controls GUI 99, contains various data collection and analysis control settings. The following textboxes are part of the controls group: number of tiers 181, history count 182, future count 183, start time 184, end time 185, level two percent window 186 and the checkbox week days only 187.

The “Num of Tiers” 181 textbox, as part of the liquidity flow controls GUI 99, tells the program the number of tiers that should be considered while performing data collection, simulations and charting. For example, assume a given security is trading at $48.80, while the best bid price is at $48.79. An order is then placed for 10 million shares at $48.75, which is considered a large order. The $48.75 price is four tiers away from the best bid price of $48.79. Thus if the “Num of Tiers” 181 textbox contains a four, the $48.75 price is considered in performing the various program operations. If the “Num of Tiers” 181 textbox contains a three, the $48.75 order is not considered by the program. Note that the 10 million shares order sets a trading minimum and indicates the price will be going up in the near future. Thus it would be preferable to include that order in the program processing.

The “History Count” textbox 182, as part of the liquidity flow controls GUI 99, tells the program the number of historical data samples that the simulator should use in calculations.

The “Future Count” textbox 183, as part of the liquidity flow controls GUI 99, tells the program the number of future data samples that the simulator should use in calculations to determine expected future trade price delta.

The “Start Time” textbox 184, as part of the liquidity flow controls GUI 99, tells the program the time to start collecting data and perform trading. If the Automatic trading option is selected trading begins at the Start Time.

The “End Time” textbox 185, as part of the liquidity flow controls GUI 99, tells the program the time to stop collecting data and end trading.

The “L2 Percent Win” textbox 186, as part of the liquidity flow controls GUI 99, tells the program the amount of time in seconds the trades are tracked to correspond to a securities exchange that provides level two data. As is known, stock trades are occurring on many different exchanges simultaneously for a single stock. Level two data (bid and ask prices and volume) is only available from certain exchanges and ECNs. For example, level two data is not currently available from the NYSE. Level one data is based on all trading activity (not just the bid and ask activity). The user will see the level one data from every exchange and ECN. Therefore, the “L2 Percent Win” is the percentage of trades that occur on exchanges (or ECNs) where the level two data is provided.

The “Week Days Only” checkbox 187, as part of the liquidity flow controls GUI 99, tells the program to only allow a data feed during weekdays Monday-Friday.

The “Trade Options” group 190 as part of the liquidity flow controls GUI 99, contains various options for the automatic trading and simulator algorithms. The control variables include buy 191 and short 192 thresholds, trailing stop loss value 193, market loss value 194, trade shares 195, minimum trade hold time 196, trade cancel timer 197, trade route 198, submit order checkbox 199 and show debug 200 option.

The “Show Debug” textbox 200, as part of the liquidity flow controls GUI 99, tells the program to display the various states of execution. For example, the user may choose to run the simulator for a specific stock ticker and timeframe. The Debug messages displayed will display that the data has been read into memory, then display the calculations are being performed for each date, then display the simulator calculations are completed. The objective of the debug messages is to provide the user with an update of the calculation status.

The “Buy Threshold” textbox 191, as part of the liquidity flow controls GUI 99, tells the program the necessary future trade price value to initiate a buy order either in a simulation or automated trading.

The “Short Threshold” textbox 192, as part of the liquidity flow controls GUI 99, tells the program the necessary future trade price value to initiate a short order either in a simulation or automated trading.

The “Trail Stop Loss” textbox 193, as part of the liquidity flow controls GUI 99, tells the program the trailing stop loss value necessary to exit a position either during simulation or automated trading.

The “Market Stop Loss” textbox 194, as part of the liquidity flow controls GUI 99, tells the program the market stop loss value necessary to exit a position either during simulation or automated trading.

The “Number Shares” textbox 195, as part of the liquidity flow controls GUI 99, tells the program the number of shares to be traded either during simulation or automated trading.

The “Min Hold Time (sec)” textbox 196, as part of the liquidity flow controls GUI 99, tells the program the minimum hold time for automated trading. Setting an adequate minimum threshold prevents prematurely exiting of a security position.

The “Cancel Timer sec” textbox 197, as part of the liquidity flow controls GUI 99, tells the program the maximum time to allow a live order to remain on the market floor without being completely filled. The cancel timer begins when the order is first placed. If the order is filled, the cancel timer is deleted. If the order is not completely filled, and the order has been live for more seconds than the cancel timer allows; the program automatically cancels the current live orders for this security.

The “Trade Route sec” textbox 198, as part of the liquidity flow controls GUI 99, tells the order server 172 which route, e.g., Market Maker or ECN to use to place the current order.

The “Submit Order to Server” textbox 199, as part of the liquidity flow controls GUI 99, tells the program to run the algorithm and submit actual orders to the order server 172. The submit order to server checkbox needs to be selected for automated trading to be enabled.

Referring to FIG. 5, a table window 220 contains trade status and message update information for a security. The information included in the auto trade display window includes: symbol 221, level one 222, level two 223, time and sales 224, percent level two 225, FTP60 226, status 227, shares held 228, time 229, gain 230, number long 231, long profit 232, number short 233, short profit 234 and profit 235.

The “Symbol” table header 221, as part of the auto trade display window 220, tells the user the current ticker symbol for table update/s.

The level one, “Lev1,” table header 222, as part of the auto trade display window 220, tells the user the time, in seconds, that has elapsed since the last level one message has been received for this security.

The level two, “Lev2,” table header 223, as part of the auto trade display window 220, tells the user the time, in seconds, that has elapsed since the last level two message has been received for this security.

The “Time and Sales” table header 224, as part of the auto trade display window 220, tells the user the time, in seconds, that has elapsed since the last time and sales message has been received for this security.

The “Level Two Percent” table header 225, as part of the auto trade display window 220, tells the user the percent of trades that have occurred on an exchange that has level two data posted on the trading floor.

The “Future Trade Price” table header 226, as part of the auto trade display window 220, tells the user the predicted trade price delta for this security. As described further below, when a user runs the trade simulator, the user-defined algorithms execute using the historical security data. The trading statistics are presented and a look-up table is created. The table includes each pattern with historical price performance results.

The “Status” table header 227, as part of the auto trade display window 220, tells the user a current status of the automatic trading for this security.

The “Shares Held” table header 228, as part of the auto trade display window 220, tells the user the status of the number of shares currently held in this security for the automatic trading.

The “Time” table header 229, as part of the auto trade display window 220, tells the user how long the current long or short position has been held. Once the position is closed, the timer is reset to zero.

The “Gain” table header 230, as part of the auto trade display window 220, tells the user the trading grain for this security's previous trade during automated trading.

The “Number Long” table header 231, as part of the auto trade display window 220, tells the user the number of long trades for this security that have been placed during the current automated trading session.

The “Long Profit” table header 232, as part of the auto trade display window 220, tells the user average long profit for this security from the current automated trading session.

The “Number Short” table header 233, as part of the auto trade display window 220, tells the user the number of short trades for this security that have been placed during the current automated trading session.

The “Short Profit” table header 234, as part of the auto trade display window 220, tells the user the average short profit for this security from the current automated trading session.

The “Profit” table header 235, as part of the auto trade display window 220, tells the user the average profit for this security from the current automated trading session

Referring to FIG. 6, a table window 240, that is part of the MB Trading Active-X module, contains the market maker bid and ask status. The table status information includes market maker identification code, bid price, bid size, time of last bid, ask price, ask size, and time of last ask update. Other trading information includes a running list of each trade time, price and volume size. MB trading also includes dynamic trade controls through this display window.

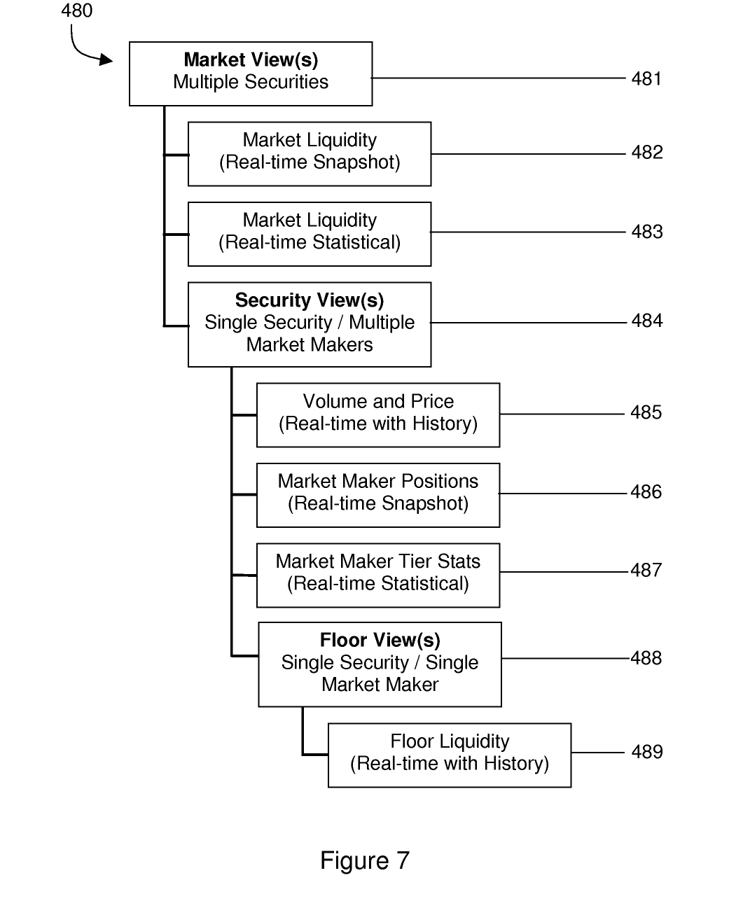

FIG. 7 is a diagram illustrating the chart display hierarchy of views according to the present invention. The charting hierarchy breaks the market data into three separate views: market view 481, security view 484 and floor view 488.

The market view 481 shows the liquidity information for multiple securities. The charts are updated with real-time data on a user defined frequency, typically once every second, as determined by the user-entry into the textbox 162 of FIG. 4. The market view chart comprises either a real-time snapshot of the current liquidity tiers 482 or a real-time moving average of the current liquidity tiers 483. The real-time snapshot view 482 includes a chart with the current bid volume and ask volume liquidity tiers cumulative for each security. The statistical summary view 483 is a chart with the moving average of the cumulative bid volume and ask volume tiers across a user defined timeframe, typically 60 minutes, as determined by the user-entry into the textbox 133 of FIG. 3.

The security view 484 shows the liquidity for a single security. In one embodiment, the security view chart comprises three types of charts. All three charts are updated with real-time data on a user defined frequency, typically once every second. The first chart, volume and price 485, shows the real-time security liquidity with history. The history window is a user-defined timeframe, typically 60 minutes. The second chart, market maker positions 486, shows the real-time snapshot of liquidity per market maker. The third chart, market maker tier bias 487, displays the moving average of the bid volume and ask volume for each market maker tier across a user defined timeframe, typically 60 minutes, as determined by the user entered value in the text box 133 of FIG. 3.

The floor view 488 shows the liquidity for a single market maker or ECN. The floor view charting level includes one chart. The floor view chart is updated with real-time data on a user defined frequency, typically once every second. The floor liquidity chart 489 shows the real-time bid volume and ask volume per price tier with history for a specific market maker or ECN. The history window is a user-defined timeframe, typically 60 minutes.

By right clicking with the mouse on any FIG. 7 chart displayed on the display 28 of FIG. 1, a window opens to provide the user with the option to launch or switch to any of the other charts. Additionally, the user can drill down to more detailed views within any chart. For example, a right mouse click on the market view chart (481/482/483), allows the user to see more details for that specific security. The user could further drill down from the security view to the floor view.

Referring to FIG. 8, a chart window 300 and a table window 307, illustrate one method for viewing the market liquidity for several securities simultaneously. That is, FIG. 8 illustrates the market view 481 of FIG. 7, either the real-time snapshot of the current liquidity tiers 482 or a real-time moving average of the current liquidity tiers 483. The chart window 300 displays the bid volume 302 (comprising a bid volume element 303 for each security) as vertical bars on the positive y-axis and the ask volume 304 (comprising an ask volume element 305 for each security) as vertical bars on the negative y-axis. A length of each region of each bar represents the volume at each bid/ask tier. Each security is identified with a security ticker label 306 representing the ticker symbol. The chart can display multiple timeframes, typically one hour, two hours or three hours simultaneously to help identify liquidity trends and bias. According to various embodiments of the invention, the chart can simultaneously display bid and ask volumes for a first timeframe (the last hour, for example) and bid and ask volumes for a second timeframe (the last two hours, for example), allowing the user to identify volume changes. Also, the volume data can be a real-time snapshot, an average (calculated over a predetermined time window) or a moving average (with a predetermined averaging time window and a time increment for updating the moving average) or a combination of the preceding. In the table window 307 a display of the raw data values for the bid and ask chart is optionally displayed. The chart can be viewed with various display methodology such as line, area, bar, point, etc., at the user's selection. Generally, the chart controls 120 of FIG. 3 control the display aspects of the various charts of the present invention.

Referring to FIG. 9, a chart window 319 comprises four chart areas for a single security. The chart areas include trade price block area 320 with a price vertical axis, bid volume per price tier block area 330 and ask volume per price tier block area 337 with a demand vertical axis, and trade volume block area 340 with a volume vertical axis. The chart areas are synchronized along the same x-axis, which is based on a user defined length of time. The chart can be viewed with various display formats such as line, area, bar, point, etc.

The trade price 320 chart area contains three plotted variables, best ask price 321, best trade price 322 and best bid price 323. Data processing methods that help in viewing the data are available; such as moving average, candle stick charts, etc.

The bid volume 330 chart area contains the cumulative bid volume for all market makers and ECNs at each bid price. Tier 01 bid price is the best bid price. Tier 01 bid volume is the cumulative bid volume at the tier 01 bid price. Tier 02 bid price is the best bid price −$0.01. Tier 02 bid volume is the cumulative bid volume at the tier 02 bid price. Tier 03 bid price is the best bid price −$0.02. Tier 03 bid volume is the cumulative bid volume at the tier 03 bid price. The number of displayed tiers is a user defined variable 181 of FIG. 4.

The ask volume 337 chart area contains the cumulative ask volume for all market makers and ECNs at each ask price. Tier 01 ask price is the best ask price. Tier 01 ask volume is the cumulative ask volume at the Tier 01 ask price. Tier 02 ask price is the best ask price +$0.01. Tier 02 ask volume is the cumulative ask volume at the tier 02 ask price. Tier 03 ask price is the best ask price +$0.02. Tier 03 ask volume is the cumulative ask volume at the tier 03 bid price. The number of tiers is a user defined variable 181 of FIG. 4.

The trade volume 340 chart area contains a cumulative trade volume. As new time and sales messages are received, the program takes the trade volume and adds it to a cumulative counter. As the demand timer 162 see FIG. 4 runs, the program takes the cumulative trade volume, sends that value to the chart, refreshes the chart, and resets the sum to zero. Typically, the demand timer 162 is set to a one-second resolution.

FIG. 10 illustrates a chart window 350 and a table window 360. Price is plotted along the x-axis. The average of the best bid price and the best ask price is at a center 349 of the x-axis, the actual bid and ask prices are shown on the x-axis at the bottom of the chart window 350. The chart can be rendered with various display formats such as line, area, bar, point, etc.

The bid volume 351 is charted as a positive stacked bar graph, with each stack element representing a different market maker or ECN as listed below each bar for the bid volume information and above each bar for the ask volume information. A height of each stack element represents the bid/ask volume corresponding to the market maker. Tier 01 bid price is the best bid price. Tier 01 bid volume is the bid volume for each market maker at the tier 01 bid price. Tier 02 bid price is the best bid price −$0.01. Tier 02 bid volume is the bid volume for each market maker at the tier 02 bid price. Tier 03 bid price is the best bid price −$0.02. Tier 03 bid volume is the bid volume for each market maker at the tier 03 bid price. The number of tiers is a user defined variable 181 in FIG. 4. Each market maker identification label is listed corresponding to the volume 353.

The ask volume 354 is charted as a negative stacked bar graph, with each stack element representing a different market maker or ECN. The ask volume is charted as negative to isolate the display from the bid volume. Tier 01 ask price is the best ask price. Tier 01 ask volume is the ask volume for each market maker at the tier 01 ask price. Tier 02 ask price is the best ask price +$0.01. Tier 02 ask volume is the ask volume for each market maker at the tier 02 ask price. Tier 03 ask price is the best ask price +$0.02. Tier 03 ask volume is the ask volume for each market maker at the tier 03 ask price. The number of tiers is a user defined variable 181 of FIG. 4. Each market maker identification label is listed corresponding to the volume 352.

The bid volume and ask volume table 360 comprises data values that correspond to the volume charts above. Bid values are listed as positive 361 and ask values are listed as negative 362 to highlight their differences.

FIG. 11 illustrates a chart window 369 and a table window 380 for a single security. The chart window 369 displays each market maker's total bid volume 371 per price tier (each region of the bar representing a different price tier) as a positive value. To help isolate the two variables, the total ask volume 373 per price tier is displayed as a negative value (with each region of the bar representing a different price tier). Tier 01 bid price is the best bid price at that time and tier 01 ask price is the best ask price at that time. The volume across the past hour, for example, is summed for each price tier. The chart can display multiple timeframes typically, 1 hour, 2 hour, 3 hour simultaneously to identify market maker trends and biases. The volume data can be a real-time snapshot, a moving average, or a combination of the two. The chart 369 comprise labels 372 that identify the market maker or ECN. The data values that correspond to the bid volume and ask volume chart are displayed in the optional table 380. The chart can be viewed with various display methodologies such as line, area, bar, point, etc.

FIG. 12 illustrates a chart window 389 and a table window 396. The chart window 389 displays the trade interest for a specific market maker (or ECN) across time. The chart is comprised of three sections, bid volume 390, ask volume 393 and the data table 396. The chart can be viewed with various display methodologies such as line, area, bar, point, etc.

The bid volume section 390 includes four bid price tiers 392 along the positive y-axis and the bid volume magnitude indicated as vertical bars 391 for each price tier. A lower edge of each vertical bar 391 is within one of the bid price tiers and thereby indicates the bid price tier associated with the vertical bar 391. Time increments are indicated along the x-axis.

The ask volume section 393 includes ask price tiers 395 along the negative y-axis and the ask volume magnitude indicated as vertical bars 394 for each ask price tier. An upper edge of each vertical bar 394 is within one of the ask price tiers and thereby indicates the ask price tier associated with the vertical bar 304.

Data values corresponding to the bid volume/price and ask volume/price data presented in the chart window 389 are displayed in the optional table 396.

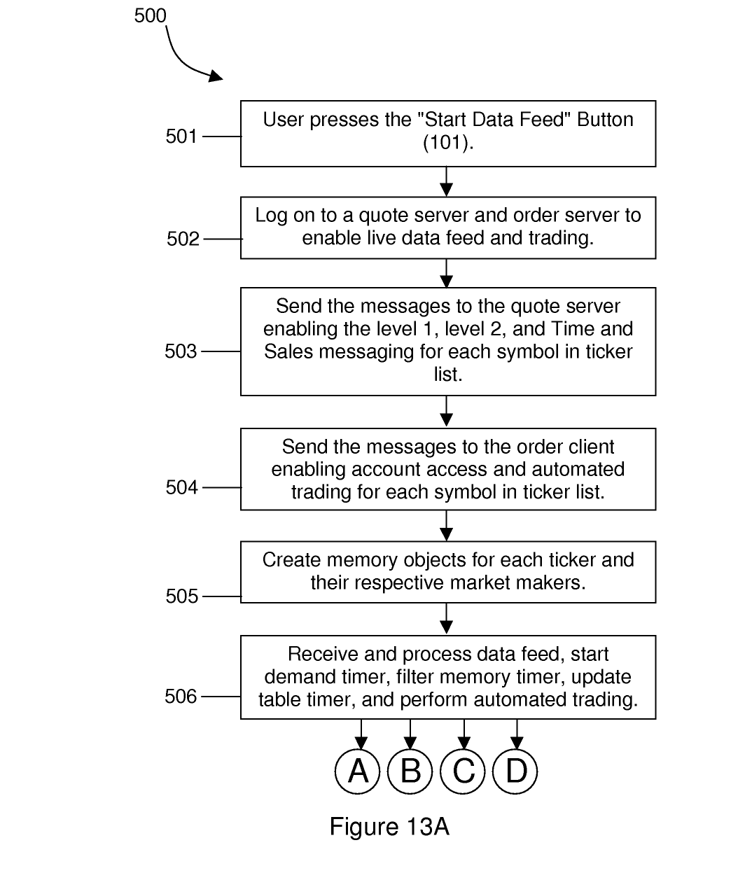

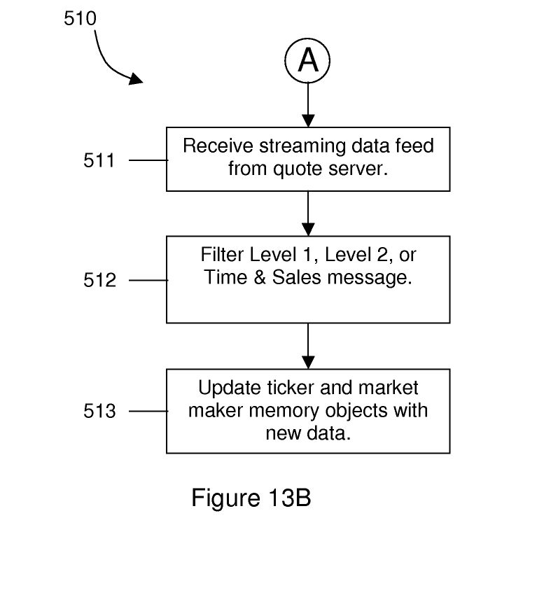

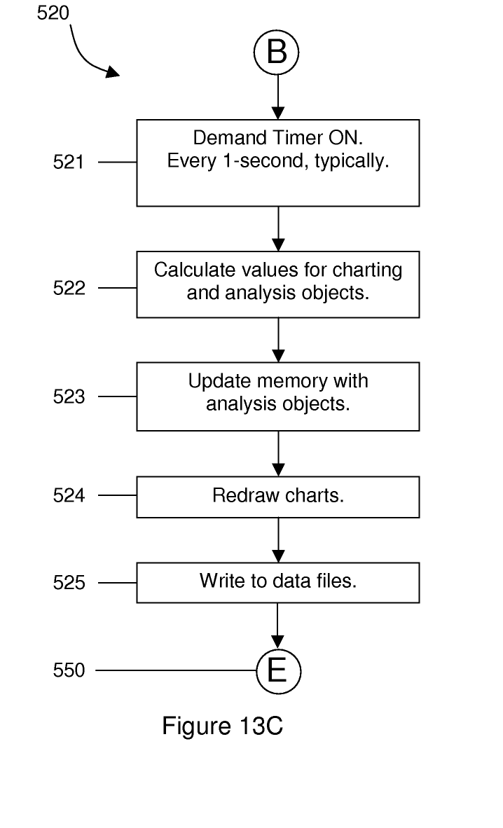

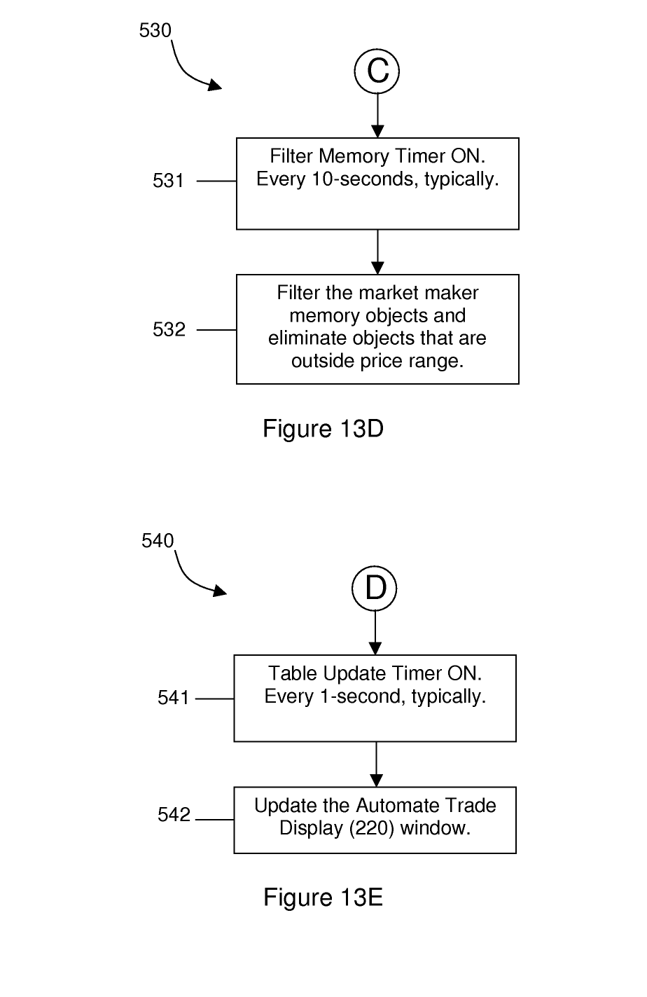

FIG. 13A depicts a flowchart 500 of the program data feed and process timers. The data feed begins at a step 501 when the user presses the “Start Data Feed” button 101 in FIG. 3. A message is sent to the data server to enable level one, level two and time and sales messages (assuming the user has selected those data types in the FIG. 3 check boxes 141-143) and several timers are started. Each timer is indicated on a different flowchart branch with a short description of functions called within that timer. The first timer, demand 520, is updated in one embodiment every 1-second interval. Within the demand 520 flowchart branch, liquidity variables are calculated 522, charts are redrawn 524, data files are written 525 and automated trading 550 is performed. A filter memory timer 530 cycles through the market maker memory objects and eliminates any objects that are no longer active. A table update timer 540 updates each column in the automated trade display 220 window of FIG. 5. The chart can be viewed with various display methodologies such as line, area, bar, point, etc.

Returning to the “Start Data Feed” button 501, when the user presses the “Start Data Feed” Button 501, which is an element in the data feed flowchart 500, the data feed begins. The user is required to log on to the quote and order servers 502. The program connects to the quote server and sends messages enabling level one, level two and time and sales streaming data feed 503 for all tickers in the ticker list. The program then connects to the order server and sends messages enabling account access and automated trading 504. Memory objects are initialized 505 and prepared to receive and process the streaming data feed 510. Finally, the calculation and refresh timers are started 506.

The streaming data feed branch 510 of the flowchart 500 shows the data is first received from a quote server 511. The message data is filtered to a level one, level two or times and sales message 512. The memory objects are then updated 513 with the relative message information.

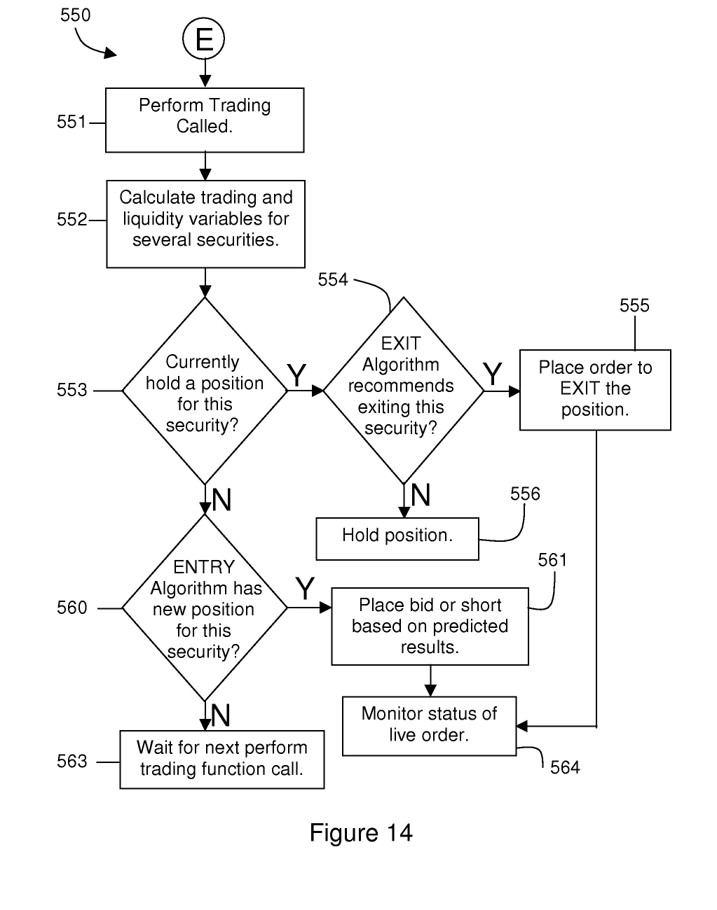

The demand timer branch 520 of the flowchart 500 shows the various function calls that occur in the demand timer. In one embodiment the timer is set to update once every second 521. The demand timer calls several functions that calculate variables 522 and load memory arrays 523 necessary for charting and automated trading. The chart views are then refreshed with the new object variables 524. Next, the demand timer updates the tier and market maker data files. The final function that the demand timer calls is the “perform trading” algorithm, which is displayed as a flowchart branch 550 in FIG. 14.

The filter memory timer branch 530 of the flowchart 500 shows the function calls that occur in the filter memory timer. In one embodiment the timer is set to update once every ten seconds 531. The filter memory timer calls a function that eliminates any market maker memory objects that are no longer active 532.

The table update timer branch 540 of the flowchart 500 shows the function calls that occur in the table update timer. In one embodiment the timer is set to update once every second 541. At a step 542 the table update timer updates the information in the automated trade display window 220 of FIG. 5.

The perform trading algorithm branch 550 illustrated in FIG. 14 is a continuation of the demand timer branch 520 of FIG. 13C, which is in turn a continuation of the data feed flowchart 500 of FIG. 13A. The branch 550 shows the decision logic for simulated and automated trading. The demand timer 521 calls the “perform trading” branch 550 as represented by perform trading called 550.

Trading and liquidity variables are then calculated 552. The liquidity variables that are collected include: bid volume and bid price and ask volume and ask price for each market maker (and ECN), market maker identification, last trade price and last trade volume. The liquidity variables that are calculated include: bid volume and ask volume per price tier, the statistical bid volume and ask volume per price tier activity summary (for the past thirty minutes, for example) and the statistical bid volume and ask volume for each market maker activity summary (for the past thirty minutes, for example). If the user currently holds a position in a security 553, the program checks to see if market values have been met to exit the position in the security. The market values can be defined by the user. For example, the market values may include items for the specific security such as trade price (trailing stop loss, market stop loss), liquidity imbalance for an instance in time, a liquidity imbalance pattern over time. The market values can also be defined by the user to be independent of the currently held security. For example, if a market indicator (such as Dow Jones) is rapidly moving downward then exit the position. The user can define the exit position trading thresholds in the liquidity flow controls of FIG. 3. If the market conditions are good for exiting a position, the program places an exit order 555 to the server or simulates exiting the position when in the simulation mode.

The perform trading algorithm 550 then checks the algorithm table 680 of FIG. 19 (derived from the pattern table 600 of FIG. 17 and the condition table 650 of FIG. 18), against the specific securities conditions or more general market conditions to determine whether the user should enter a new position for each security 560. If the algorithm table has a match with current market conditions, a long or short order is placed to the order server as set forth in the algorithm table 680. The algorithm table 680 can be manually created by the user. The user automatically creates an element in the algorithm table by highlighting a section of the graphs in FIGS. 8-12 and FIGS. 25-33 and then right mouse clicking on the “algorithm generator” option. An automated algorithm creation form appears in response. A sample of the automated algorithm creation form is illustrated in 700 (FIG. 20). The automated “algorithm generator” can be used on any type of data being graphically displayed or in a table, such as those identified in 1250 (FIG. 43): “Insider Trading” (1252), “Fundamental Indicators” (1251), “News Events” (1253), “Industry Sectors” (1254), “Price Indicators” (1255), “Security Order & Trade Data” (1258) and “Options Order & Trade Data” (1259). Simulated and automated trading can be performed on a variety of auction-based systems, including but not limited to: Equities, Intra-day Options data, Futures data, intra-day Forex data, and Eurex Futures and Index Data. Other systems not specifically defined above can also be applied to this invention. Simulated and automated trading can be performed on equities fundamental data, such as price to earnings ratio and dividend yield. Simulated and automated trading can be performed on user-defined thresholds or patterns for insider trading information, such as inside trader name and/or inside trade size. Simulated and automated trading can be performed on other data types not specifically defined in this invention.

The simulated trading flowchart 580, as illustrated in FIG. 15, shows the decision logic for simulated trading. The same basic logic is applied when performing automated trading. The simulator begins 581 when the user clicks on the “Run Simulator” 105 button of FIG. 3. User defined variables (as entered in the liquidity control window 99 of FIG. 3) such as symbol, start date, end date, start time, end time, trailing stop loss, and market stop loss are loaded into memory 582. The simulated algorithm then loads the tier files and market maker files into memory for processing 583. The historical data files can be stored locally on the user's computer or remotely on a server. Historical data includes: Equities, equities fundamental data, Intra-day Options data, Futures data, intra-day Forex data, and Eurex Futures and Index Data. Other data types not specifically defined can also be applied to this invention. The perform trading algorithm 550 is then called to simulate trading based on the current historical data values. Simulated trading can be performed based on equities fundamental data, such as price to earnings ratio and dividend yield. Simulated trading can be performed on user-defined thresholds or patterns for insider trading information, such as inside trader name and/or inside trade size. Finally, the simulator trading statistics are updated for later analysis 585.

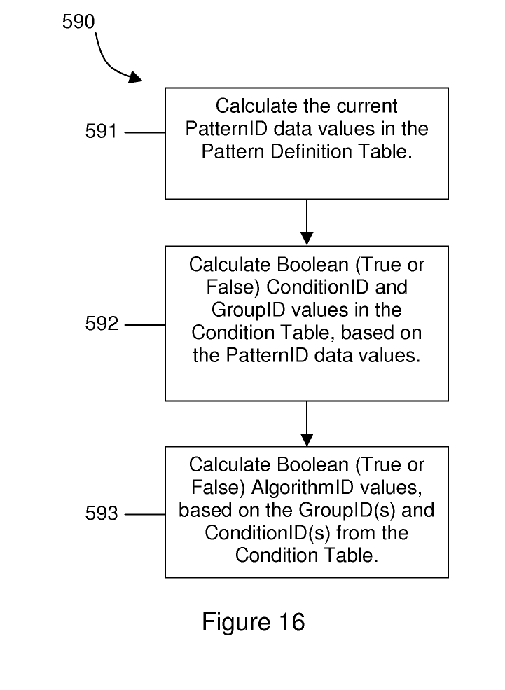

The trading algorithm flowchart 590, as illustrated in FIG. 16, shows how the trading algorithm identifies a pattern in the data. The trading algorithm flowchart is called during simulated trading and during automated trading of FIG. 14. The program first performs the necessary calculations from the pattern definition table 600 of FIG. 17 and updates current PatternID variables 591. Based on the PatternID variables, the program performs the necessary Boolean logic calculations from the condition table 650 of FIG. 18 and updates the current ConditionID and GroupID variables 592. Based on the ConditionID and GroupID variables, the program performs the necessary Boolean logic calculations from the algorithm table 680 and updates the current AlgorithmID variables 593.

The pattern definition table 600, as illustrated in FIG. 17 identifies patterns in the level one, level two and times and sales data. These patterns are used by the flowcharts during simulated trading and actual trading to determine the thresholds for buying and selling securities. The table 600 is broken into user-defined groups based on similar pattern types 601. For example, the patterns that are associated with bid volume per price tier are all listed in the “Bid Tiers” group header 620. The patterns that are associated with the mean last price are all listed in the “Mean Last Price” group header 621.

The “PatternID” column 602, from the pattern definition table 600, is a user-defined name for each specific pattern. Each PatternID is a unique value. The PatternIDs are entered manually by the user at this step 602 or through a graphical user interface.

The “Start Time” column 603 and “End Time” column 604, from the pattern definition table 600, are a user-defined time reference identifying when the pattern begins and ends relative to the current time T. For example, the first pattern 620 listed in the pattern definition table 600 has a start time of “T-60” and an end time of “T”. The “T-60” pattern start time means the pattern began 60 seconds ago. The “T” pattern end time means the pattern ends at time T, which is the current time for the real-time data feed. As another example, the fourth pattern 621 listed in the pattern definition table 600 has a start time of “T-120” and an end time of “T-60”. This means the pattern represents a timeframe from 120 seconds in the past to 60 seconds in the past.

The “Variable” column 605, from the pattern definition table 600, is a user-defined parameter of the pattern data types. The pattern can be based on the volume or price for the bid tiers, the ask tiers, or the last trade data. In one embodiment, the different variables include: bid volume, bid price, ask volume, ask price, last volume, and last price.

The “Price Tier” column 606, from the pattern definition table 600, is a user-defined parameter for the pattern price tier. If the user is defining a pattern based on the last trade price or last trade volume, the price tier will automatically be set to zero. If the user is defining a pattern based on the bid price, ask price, bid volume or ask volume, then the associated price tier is defined in this column. The price tier can be any integer between 0 and 100. For example, if the user wants to define a pattern for the bid volume at the best bid price, then the price tier would be one. If the user wants to define a pattern for the bid volume, at a price one cent below the best bid price, then the tier would be equal to two. As the tier number increase to 20 for example, the bid price tier is 19 cents below the best bid price. The tiers that are closest to the best bid price or best ask price have more influence on the price change than the price tiers further away from the best bid price or best ask price.

The “Operation” column 607, from the pattern definition table 600, is a user-defined mathematical operation that is used to calculate the PatternID value. The mathematical operations include sum, mean, median, max, and min. For example, the first row 620 uses the “Sum” operation, which means that the value for the PatternID is equal to the sum of the first tier bid volumes from 60 seconds in the past to the present.

The “MMID” column 608, from the pattern definition table 600, is a user-defined parameter for the market maker ID. The “MMID” value is used to identify which market makers are included in the PatternID calculations. For example, the first row 620 uses a value of “ALL” for the market maker ID. This means that all market makers and ECNs are included in the calculation for the first tier bid volume. Looking at another example 622, the specific market maker is defined as “NITE”. The value of the PatternID is the sum of the first tier bid volume for the market maker NITE from 60 seconds ago to the present.

The condition table 650, as illustrated in FIG. 18, is used to logically compare multiple PatternIDs created in the pattern definition table 600. Each conditional relationship is given a unique ConditionID 652. Similar ConditionIDs are grouped into a user-defined GroupID 651. The first PatternID is displayed in the third column 653 as “PatternID1.” The second PatternID is displayed in the fifth column 655 as “PatternID2”. The “Logical Condition” 654, defines the relationship between PatternID1 and PatternID2. The “Logical Condition” is a Boolean operator that includes greater than >, greater than or equal >=, less than <, less than or equal <=, and equal =.

The following examples explain the condition table 650 in more detail. The first example looks at the first row 660, which has a GroupID named “VoIPeaks” and a ConditionID named “Peak01”. The “Peak01” condition is true if the “Tier 1, Bid Volume Sum for the past 60 seconds” is greater than “10 times the Tier 1, Ask Volume Sum for the past 60 seconds”.

The next example identifies a rising price condition 661. The GroupID is named “RisingPrice” and the ConditionID is named “UpPrice1”. The “UpPrice1” condition is true if the “Mean Last Trade Price from 60 seconds ago to present” is greater than the “Mean Last Trade Price from 120 seconds ago to 60 seconds ago.”

The algorithm table 680, as illustrated in FIG. 19, is used to logically compare multiple GroupIDs and ConditionIDs created in the condition table 650. Each algorithm relationship is given a unique AlgorithmID 681. The logical operations used to compare the various GroupIDs and ConditionIDs include: AND, OR, and NOT. If the logical combination 683 is determined to be true, then the algorithm will execute the trade as defined in the “Trade Option” 682. The trade option can be “Buy Long”, “Sell Long”, “Sell Short”, or “Cover Short”.

The following examples explain the algorithm table 680 in greater detail. The first example looks at the first row 690, which has an AlgorithmID named “A1”. The “A1” algorithm condition is true if the ConditionIDs “Peak01” and “UpPrice2” are both true at this instant in time.

Another example from the algorithm table 680 is named “A3” 691 (JOHN—691 should be referring to “A3”, not “A2”). This algorithm shows the combination of GroupIDs with ConditionIDs. The GroupID named “VoIPeaks” from the condition table 650 is true if all of the ConditionIDs in the “VoIPeaks” Group are true. This means that “Peak01”, “Peak02”, “Peak03”, “Peak04”, “Peak05”, and “Peak06” all need to be true. The AlgorithmID “A3” is true if the “VoIPeaks” GroupID and the “UpPrice2” ConditionID are both true at this instance in time.

The trading algorithm, as illustrated in FIG. 16, is based on the logical combination of the Pattern Table, the Condition Table, and the Algorithm Table. See the step 593 of FIG. 16. This logic-based algorithm provides the user with flexibility to track and trade based on a variety of trading variables and timeframes as specified by the user.

While the user has the ability to manually enter the patterns into the tables of FIGS. 17, 18 and 19, according to another embodiment an automatic methodology is provided to improve efficiency and reduce errors in entering the PatternIDs, ConditionIDs, and AlgorithmIDs. The automatic algorithm generator is illustrated in FIG. 20. The user first highlights a section of the graphs in FIGS. 8-12 and then right mouse clicks on the Algorithm Generator option. In response, the algorithm generator creates FIGS. 17-19 based on previously established user thresholds and tolerances. A window form 700 with a list of highlighted variables is displayed, as illustrated in FIG. 20. The form includes a start time 701 that defines the beginning time desired for the algorithm pattern analysis. The form also includes an end time 702 that defines the ending time of the algorithm pattern analysis.

As part of the automated algorithm creation form 700, the patterns may need to be converted into a more discrete waveform. The “Resolution Window” 703 is a user-defined period of time indicating the resolution of the waveform.

As part of the automated algorithm creation form 700, the required level of correlation between the AlgorithmID pattern and the real-time data stream pattern is defined by the variable “Correlation Factor” 704. A correlation value of one means that the two patterns need to be exactly the same. A correlation value of 0.9 means that for each resolution window, the components for the two patterns need to be 90 percent correlated, or the values need to be within a 10 percent of each other.

As part of the automated algorithm creation form 700, the user has the option to define the name for the AlgorithmID 705. The PatternIDs and ConditionIDs are automatically named while using the automated algorithm creation.

As part of the automated algorithm creation form 700, the user has the option to enable or disable each variable that is present from the highlighted chart. The user clicks on the enabled 710 checkbox to enable a specific variable. The user clicks on the enabled 710 checkbox again to disable a specific variable.

As part of the automated algorithm creation form 700, the variable type is automatically listed. Variables can include bid volume, ask volume, trade volume, bid price, ask price, and last trade price.

As part of the automated algorithm creation form 700, the user has the option to define how the pattern is recognized by selecting the “Relative or Absolute” 712 option. If the user selects the “Relative” data option, the algorithm is created using relative values, which are based on the relative change from the previous value in the pattern. For price changes, the relative change is the difference from the first resolution window to the next resolution window. For example, trade price has increased five cents from the previous resolution time window. The actual trade price value does not play a part when using “Relative” pattern recognition option. For volume changes, the relative change is the percentage change from the first resolution window to the next resolution window. For example, volume has increased ten percent from the previous time window. If the user selects the “Absolute” data option, then the algorithm will be created using the raw data values, such as the absolute last trade price. An example of “Absolution” pattern recognition, using a correlation factor of 0.9, if the last trade price is $40.00, then the algorithm pattern will be met if trade price is between $38.00 (minus five percent) and $42.00 (plus five percent).

As part of the automated algorithm creation form 700, the user has the option to define how the pattern is computed by selecting the “Operation” 713 option. The operation defines how the data values are combined within each resolution window. Typically, the mean value is adequate for all algorithms. The user does have the option to use the mean, median, max, or min for the resolution window variable value. There is also an option for the user to define alternative or unique statistical manipulation of the data, such as exponential moving average, weighted moving average, or difference between two moving averages.

As part of the automated algorithm creation form 700, the program automatically includes the tier value for each bid volume and ask volume. A tier value of one for bid volume is equal to the volume at the best bid volume.

According to another embodiment of the invention, a neural network is employed to perform more complicated data analyses and pattern comparisons to determine the existence of a trade imbalance. Such a neural network can also optimize the patterns and parameters based on historical data. The neural network can be used to optimize any of the Level 1, Level 2, and Times and Sales data; such as: last trade price, best bid price, best ask price, trader bid price, trader bid volume, trader ask price, trader ask volume, number of messages for a trader at the inside bid price, and last trade volume. The neural network is also employed to determine optimized trading values, such as trailing stop loss value and number of shares to purchase or sell. The neural network can be used to optimize trades for other data sets defined by the user.

According to another embodiment of the invention, an alert can be presented in a varied of forms, such as on the computer screen, an email to user-defined email addresses, a text message to a cell phone or sent to a pager. Other alert methods can also be utilized.

According to another embodiment of the invention, alerts can be placed on a chart to tell the user when a specific pattern or indicator is identified. For example, when a news event occurs, it can be displayed on a chart, which is linked to the actual news article. As another example, when an insider-trading event occurs, it can be displayed on a chart, which is linked to the actual insider trading details. During simulated trading, the various orders to buy, sell, short, or cover can be displayed on a chart. During live trading or automated trading, the various orders to buy, sell, short, or cover can be displayed on a chart. All of the display indicators and alerts can be modified by symbol, color or style by the user.

According to another embodiment of the invention, there are no limits on the number of data points a user can have on a chart. The user can use any custom time interval, such as: 1-minute, 5-minutes, or 10-minutes on an individual chart or graph. Using the mouse, the user can zoom in on any chart or graph to provide greater detail. The user can zoom back to the original view by selecting the “z” button on the keyboard. All indicators, studies and trend lines on a chart are recalculated and redrawn automatically for the new time interval.

According to another embodiment of the invention, the user can simulate trading, perform automated trading, and view chart or tables on pre-market hours only, post-market hours only, pre- and post-market hours combined, normal market hours, or any custom times the user defines.

According to another embodiment of the invention, the user can compare multiple stocks or intervals on a single chart. There is no limit on the number of sub graphs per chart the user can have. With the mouse, the user can select the same time period simultaneously across all the charts. The price axis can be expanded or compressed by dragging it vertically, thus changing the range for the price axis.

According to another embodiment of the invention, the user can enable labels for each data set being displayed on a chart or graph, such as Trade Price value, Market Player Bid Price value, Market Player Ask Price value, Market Player Name or Identification, Best Bid Price value, Best Ask Price value and Trade Volume value.

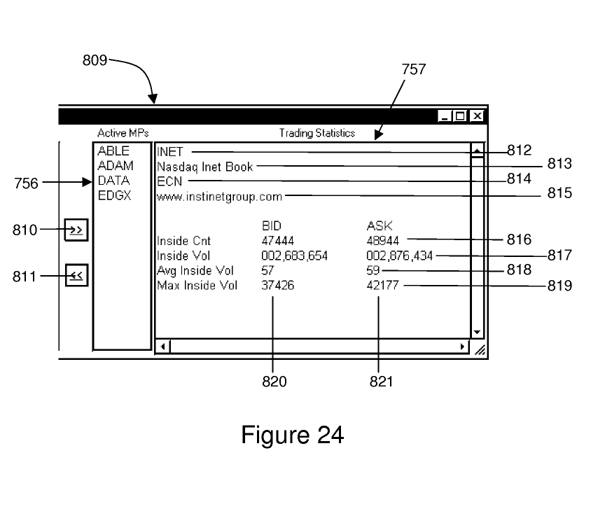

According to another embodiment of the invention, the user can click on any data set and a location marker will appear. All of the data values in the current graph, for the corresponding timeframe (such as one second), are then displayed in the Trading Statistics Window (757, FIG. 24). By pressing the Left or Right key on the keyboard, the marker moves to the previous or next data value displayed in the graph and the information in the Trading Statistics Window (757) is automatically updated to represent the new location market location.

According to another embodiment of the invention, the data is filtered or adjusted to take into account the market events, such as: mergers, stock splits, spin-offs, acquisitions, bankruptcies and symbol changes.

According to another embodiment of the invention, the user can mouse click on any chart, graph or table to submit a trade for the displayed security at the selected price. If multiple securities are displayed, the user can select a specific security data being graphed and a submit trade window is displayed.

According to another embodiment of the invention, the user can place a limit or stop order depending on where the user clicks on the bid volume and ask volume on any of the charts, without having to change the order type. For example, clicking on the bid volume on a chart at the inside ask will place a market order, while clicking any chart below that will place a limit order. The user can also make a trade to a specific Exchange, ECN, or trader by selecting the desired trader within any of the charts, graphs or tables.

According to another embodiment of the invention, the user can replay the historical data to give the look and feel of real-time trading. While in “Replay Mode”, the invention can perform simulated trading on a historical data set, highlight the trade executions, and produce a summary report of trades. The user can speed up or slow down the “Replay Mode” based on personal preference.

According to another embodiment of the invention, the simulator uses actual Level two data for the trading. The Level two data includes time an order was placed, the number of shares desired to purchase or sell, and price to purchase or sell the shares. The trading simulator uses the Level two data to determine if a trade would have occurred. For example, suppose the user enables the invention to run through a simulation of trading based on some basic indicators. When a buy order is issued on the simulator at a specific price and number of shares, the simulator will check to see if those shares are available for sale at the price desired. Even if some shares are available at the desired price, the simulated trade may be partially executed because other traders have already posted their buy orders at the same price. Those other traders who already have their trades posted will have a priority in a real-life trading scenario. By looking at the Level two existing buy orders and sell orders, a realistic simulation of the actual number of shares that would have been traded if this were real trading occurs.

According to another embodiment, the invention will automatically update the computer's local clock based on a user-defined source. Software products are available which can synchronize computer's clock with Atomic Time Servers. This invention is compatible with those clock synchronization programs.

According to another embodiment of the invention, the invention presents a high-level statistical analysis of the Security Level two bid order and ask order data. The statistical analysis can be customized or can include any of the standard price indicators, as applied to Level two bid and ask orders. A few examples of these indicators include: moving average, convergence, divergence, momentum, Relative Strength Index, and on-balance volume.

According to another embodiment of the invention, the trading can be simplified for most common traders and investors. Standard alerts can be defined by companies, individuals, and others and posted onto a common server, web page or other network location. The trader with limited technical skills can simply load these indicators or level two patterns into their trading module. The program can then give the user an alert, such as a large green arrow point up when the security is expected to rise and a large red arrow pointing down when the security is expected to decline. The indicators can change based on the current position held. For example, if the user is short on a position, then the red arrow could be displayed if the security price is expected to rise.

According to another embodiment of the invention, the invention includes a “help” and “users guide” to assist the user in understanding the various features of the invention.

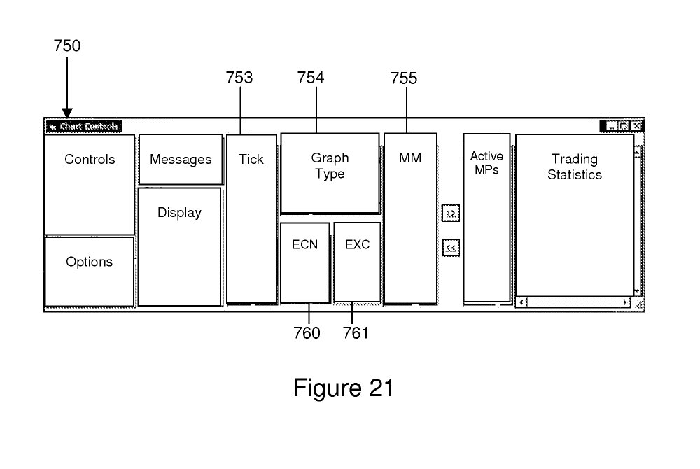

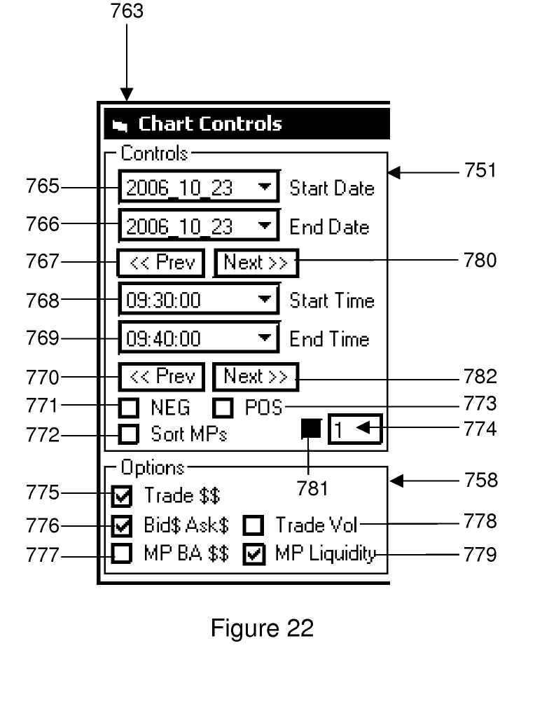

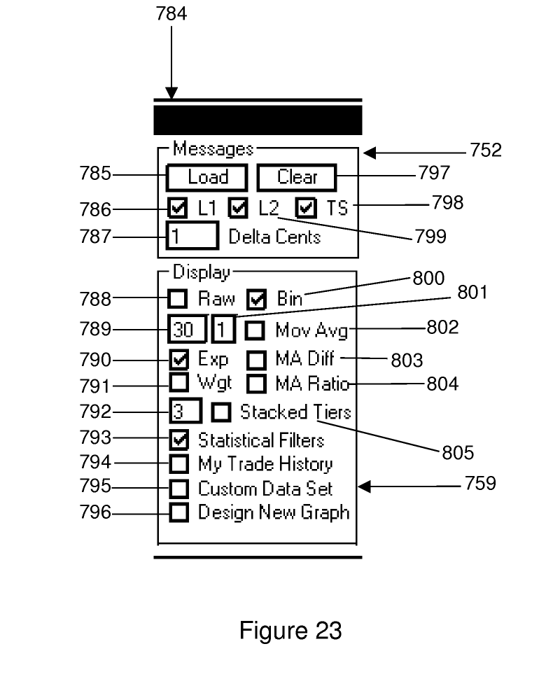

According to another embodiment of the invention, the user can create and control the display options for graphs and tables using the “Chart Controls” Graphical User Interface (GUI) illustrated in 750 (FIG. 21). The GUI is separated into several sections including: Controls 751 (within GUI 763, FIG. 22), Options 758 (within GUI 763, FIG. 22), Messages 752 (within GUI 784, FIG. 23), Display 759 (within GUI 784, FIG. 23), Tick 753 (within GUI 750, FIG. 21), Graph Type 754 (within GUI 750, FIG. 21), ECNs 760 (within GUI 750, FIG. 21), Exchange 761 (within GUI 750, FIG. 21), MMs 755 (within GUI 750, FIG. 21), Active MPs 756 (within GUI 809, FIG. 24) and Trading Statistics 757 (within GUI 809, FIG. 24). Each of these sections is described below.

According to another embodiment of the invention, the user can control the historical data loaded for a specific security with the “Tick” textbox 753 of the Chart Controls (750, FIG. 21) dialog box. A watch list of the various securities being tracked is displayed in “Tick” textbox 753 (within GUI 750, FIG. 21). If the user clicks on a security in the “Tick” textbox (within GUI 753, FIG. 21) the data will be loaded for that security, the graphs and tables will be updated automatically with that security.

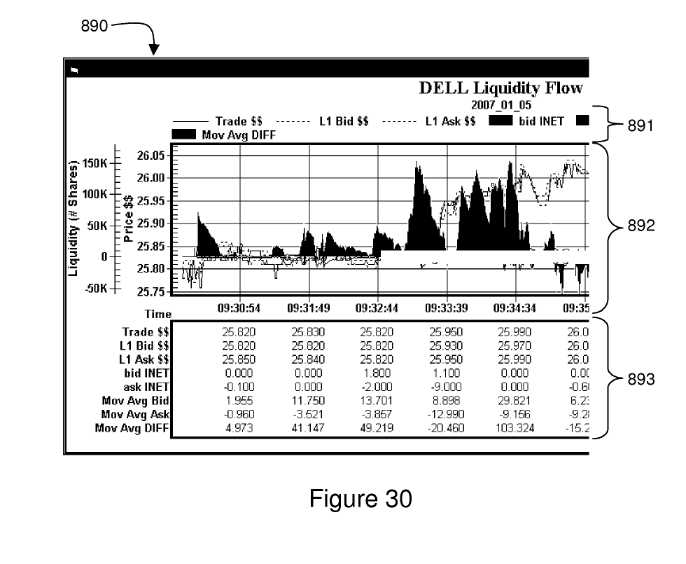

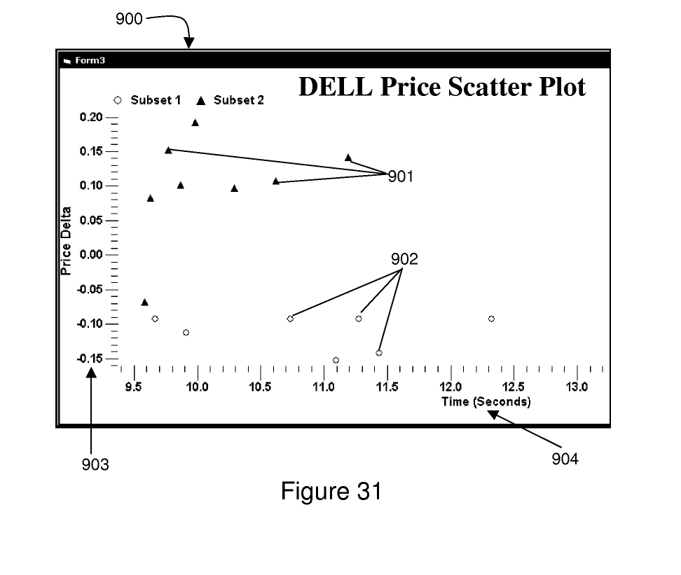

According to another embodiment of the invention, the user can select the specific graph and table to be displayed with the “Graph Type” textbox 754 of the Chart Controls (750, FIG. 21) dialog box. If the user selects a standard chart, or a customized chart, from the “Graph Type” textbox 754, the chart associated with that type will be displayed. For example, clicking on the “033 Liquidity” text within the “Graph Type” 754 textbox will display a chart similar to that illustrated in 890 (FIG. 30). As another example, clicking on the “034 High-Low Vol” text within the “Graph Type” textbox 754 will display a chart similar to that illustrated in 900 (FIG. 31). The user can create customized chart types which will be displayed in the “Graph Type” textbox 754.

According to another embodiment of the invention, the invention will automatically filter each of the Market Players based on a user-defined classification. If the user selects a security from the “Tick” textbox 753 of the “Chart Controls” (750, FIG. 21) dialog box, all of the Level two data files for the date(s) defined will be scanned, identifying all of the active Market Players for that specific security. As an example, the Market Players are filtered into three groups, ECNs 760, Exchanges 761, and MMs 755. The user can define more classifications as desired. A lookup table includes each Market Player, their classification, their complete name, and contact information such as web page, phone numbers, fax numbers, email and instant messaging accounts. The user can define the specific information stored in the lookup table. If the user clicks on a specific ECN for example, the lookup table information for that ECN will be displayed in the “Trading Statistics” textbox 757 (within GUI 809, FIG. 24).

According to another embodiment of the invention, the invention will perform calculations on a single selected Market Player, several selected Market Players, or all Market Players. The user can select multiple Market Players (from categories such as ECNs, Exchanges, Market Makers) with the mouse by holding down the “control” key or the “shift” key on the keyboard. The user can then add the selected Market Players using the “>>” button 810 in the GUI displayed in FIG. 24 (809). Each of the selected Market Players is then added to the “Active MPs” textbox 756. In the example from 809 (FIG. 24), the four Market Players listed in “Active MPs” 756 are ABLE, ADAM, DATA, and EDGX. When the user desires to view a graph or table, by clicking on one of the Market Players in the “Active MPs” textbox 756 will display the Level two data for each Active Market Player. If the graph is displaying the data as “binned” 800 (within GUI 784, FIG. 23), and multiple Market Players are active during the same one-second interval, the bid volume and ask volume order data will be stacked for each Market Player for that one-second interval. The user can also view the multiple Market Players in a tabular format, simulate trading and perform automated trading for a specific set of Market Players. If the user selects the “<<” button 811 (within GUI 809, FIG. 24), then the selected Market Player from the “Active MPs” textbox 756 (within GUI 809, FIG. 24) will be removed from the “Active MPs” textbox 756.

According to another embodiment of the invention, the invention will perform calculations on a selected Market Player. The user can select a Market Player from the “ECNs” textbox 760, the “Exchange” textbox 761, the “MPs” textbox 755, and the “Active MPs” textbox 756 from the Chart Controls 750 (FIG. 21) dialog box or any other customized classification for Market Players. Once a Market Player is selected, some statistics are calculated associated with the defined Date(s) 765 and 766 (within GUI 763, FIG. 22) and Timeframes 768 and 769 (within GUI 763, FIG. 22). A sample of the calculated statistics is illustrated in FIG. 24 (809). The “Inside Cnt” 816 (within GUI 809, FIG. 24) is the total number of messages, within the price filter “Delta Cents” 787 (within GUI 784, FIG. 23) for the bid side and ask side orders. The “Inside Vol” 817 (within GUI 809, FIG. 24) is the total order volume, within the price filter “Delta Cents” 787 (within GUI 784, FIG. 23) for the bid side and ask side orders. The user can customize the statistical calculations presented in the “Trading Statistics” textbox 757 (within GUI 809, FIG. 24).

According to another embodiment of the invention, the user can control the historical data loaded with the “Controls” 751 (within GUI 763, FIG. 22) section of the Chart Controls 750 (FIG. 21) dialog box. A portion of the dialog box is enlarged for better reference in FIG. 22 (763). The user can define the “Start Date” 765 and “End Date” 766 to be displayed in a table or graph. When the user selects the “Previous” 767 button, the “Start Date” 765 and “End Date” 766 pull down boxes will change to the previous trading dates. When the user selects the “Next” 780 button, the “Start Date” 765 and “End Date” 766 pull down boxes will change to the next trading dates. The user can define the “Start Time” 768 and “End Time” 769 to be displayed in a table or graph. When the user selects the “Previous” 770 button, the “End Time” 769 is changed to the “Start Time” 768 and the “Start Time” 768 is decreased by the difference of the “Start Time” and “End Time”. As illustrated in 763 (FIG. 22), pressing the “Previous” button 770 once would change “Start Time” 768 to “09:20:00” and the “End Time” 769 to “09:30:00”. When the user selects the “Next” 782 button, the “Start Time” 768 is changed to the “End Time” 769 and the “End Time” 769 is increased by the difference between the “Start Time” and “End Time”. As illustrated in 763 (FIG. 22), pressing the “Next” button 782 once would change “Start Time” 768 to “09:40:00” and the “End Time” 769 to “09:50:00”.

According to another embodiment of the invention, the user can identify times when a security had the largest decline in trade price for a given time period. By selecting the “NEG” 771 (within GUI 763, FIG. 22) checkbox, the user is indicating they wish to find the biggest decrease(s) the security has experienced during the Date(s) 765 and 766 loaded, for a ten-minute period for example. Pressing the “Next” button 782 while the “NEG” 771 checkbox is selected will display the ten-minute period of time the security experiences the largest decline in trade price. Clicking the “Next” button 782 again, will take the graph to the second largest decline for a ten-minute period of time, and so forth. The window of time (ten minutes in the above example) is based on the user-defined difference between “Start Time” 768 and “End Time” 769. Clicking the “Prev” button 770 will take the graph to the previously viewed largest decline for a ten-minute period of time.

According to another embodiment of the invention, the user can identify times when a security had the largest increase in trade price for a given time period. By selecting the “POS” 773 (within GUI 763, FIG. 22) checkbox, the user is indicating they wish to find the biggest increase(s) the security has experienced during the Date(s) 765 and 766 loaded, for a ten-minute period for example. Pressing the “Next” button 782 while the “POS” 773 checkbox is selected will display the ten-minute period of time the security experiences the largest increase in trade price. Clicking the “Next” button 782 again, will take the graph to the second largest increase for a ten-minute period of time, and so forth. The window of time (ten minutes in the above example) is based on the user-defined difference between “Start Time” 768 and “End Time” 769. Clicking the “Prev” button 770 will take the graph to the previously viewed largest increase for a ten-minute period of time.

According to another embodiment of the invention, the user can sort the Market Players (such as, Exchanges, ENCs, Market Makers, etc.) based on number of Level two messages they have submitted to purchase or sell the selected security 753 (within GUI 750, FIG. 21) in the displayed timeframe, between “Start Time” 768 (within GUI 763, FIG. 22) and “End Time” 769 (within GUI 763, FIG. 22) for the defined Dates 765 and 766. By selecting the “Sort MPs” 772 checkbox, the user is indicating they wish to sort the Market Players based on activity (such as: number of shares, number of messages, etc.). When the user selects one of the securities in the selection box 753 (within GUI 750, FIG. 21), the invention will scan all Market Players and sort them based on the user-defined activity. The results of the sort are then displayed in the text box 757 (within GUI 809, FIG. 24). The sorted Market Players displayed in text box 757 are separated based on their classification (ECN, Exchange, Market Maker for example). The user can filter the Market Players orders using the “Delta Cents” 787 (within GUI 784, FIG. 23) text box to require the orders to be within a specified price range. Setting “Delta Cents” 787 equal to “1”, for example, would eliminate orders that are not within the best bid or best ask.

According to another embodiment of the invention, the user can enable or disable any of the messages to be graphed or displayed in tabular format from Level 1, Level 2, or Times and Sales Data from the “Options” 758 (within GUI 763, FIG. 22) section. The user can turn on the Last Trade Price for a graph (such as 892, within 890, FIG. 30) or table (such as 893, within 890, FIG. 30) by selecting the “Trade $$” checkbox 775 (within GUI 763, FIG. 22). The user can turn off Last Trade Price for a graph 892 or table 893 by unselecting the “Trade $$” checkbox 775. The user can turn on the Best Bid Price and Best Ask Price for a graph 892 or table 893 by selecting the “Bid$ Ask$” checkbox 776. The user can turn off the Best Bid Price and Best Ask Price for a graph 892 or table 893 by unselecting the “Bid$ Ask$” checkbox 776. The user can turn on the Last Trade Volume for a graph 892 or table 893 by selecting the “Trade Vol” checkbox 778. The user can turn off the Last Trade Volume for a graph 892 or table 893 by unselecting the “Trade Vol” checkbox 778. The user can turn on the Market Player (Exchange, ECN, Market Maker, or other) Bid and Ask orders for a graph 892 or table 893 by selecting the “MP Liquidity” checkbox 779. The user can turn off the Market Player Bid and Ask orders for a graph 892 or table 893 by unselecting the “MP Liquidity” checkbox 779. Other data sets can be displayed or removed from display in a similar method.

According to another embodiment of the invention, the user can enable or disable loading any of the files containing messages from Level 1, Level 2, or Times and Sales Data located within the “Messages” 752 (within GUI 784, FIG. 23) section. If the user selects the “L1” checkbox 786, then the Level one data will be loaded when the “Load” button 785 is selected or when a security is selected from the textbox labeled “Tick” 753 (within GUI 750, FIG. 21). If the user unselects the “L1” checkbox 786, then the Level one data will not be loaded when the “Load” button 785 is selected or when a security is selected from the textbox labeled “Tick” 753 (within GUI 750, FIG. 21). Similarly, if the user selects the “L2” checkbox 799, then the Level two data will be loaded when the “Load” button 785 is selected or when a security is selected from the textbox labeled “Tick” 753. If the user unselects the “L2” checkbox 799, then the Level two data will not be loaded when the “Load” button 785 is selected or when a security is selected from the textbox labeled “Tick” 753. Finally, if the user selects the “TS” checkbox 798, then the Time and Sales data will be loaded when the “Load” button 785 is selected or when a security is selected from the textbox labeled “Tick” 753. If the user unselects the “TS” checkbox 798, then the Level two data will not be loaded when the “Load” button 785 is selected or when a security is selected from the textbox labeled “Tick” 753.

According to another embodiment of the invention, the user can Load or Clear the memory contents by selecting the “Load” button 785 (within GUI 784, FIG. 23) or the “Clear” button 797 located within the “Messages” 752 (within GUI 784, FIG. 23) section. If the user selects the “Load” button 785, then the invention will load the data files defined in Level one 786, Level two 799, and Times and Sales 798 checkboxes. If the user selects the “Clear” button 797, then the invention will empty the data files from memory which are defined in Level one 786, Level two 799, and Times and Sales 798 checkboxes. The invention also dynamically clears the data loaded into memory when needed. The same methodology can be applied to any data set defined by the user.

According to another embodiment of the invention, the user can define the bid and ask price levels to be filtered with the “Delta Cents” textbox 787 located within the “Messages” 752 (within GUI 784, FIG. 23) section. If the “Delta Cents” textbox 787 is equal to one, for example, then only the bid volume orders and ask volume orders that are located at or better than the best bid price and the best ask price (for each Market Player for example) will be used in the graphical display, tabular display, simulated trading, and automated trading. If the “Delta Cents” textbox 787 is equal to two, for example, then only the bid volume orders and ask volume orders that are located at or better than the one cent less than the best bid price and one cent greater than the best ask price (for each Market Player for example) will be included in the graphical display, tabular display, simulated trading, and automated trading.

According to another embodiment of the invention, the user can define how the graphs and tables are shown and processed within the “Display” 759 section (within GUI 784, FIG. 23). If the user selects the “Raw” checkbox 788, then all of the Level one, Level two, and Time and Sales data will be included on a message-by-message basis for all of the included invention features, such as graphical display, tabular display, simulated trading, and automated trading. The Level two data may be filtered as discussed above using the “Delta Cents” textbox 787 price filter.

According to another embodiment of the invention, the user can define how the graphs and tables are shown and processed within the “Display” section 759 (within GUI 784, FIG. 23). If the user selects the “Bin” checkbox 800 then each of the Level one, Level two, and Time and Sales data subsets will be binned on a user-defined interval, such as, second-by-second basis for all of the included invention features, such as graphical display, tabular display, simulated trading, and automated trading. For example, suppose the stock price traded 10 times in the last second. The binned data would combine the 10 different trade occurrences (either as max, min, average, median, candlestick or other method defined by the user) into a single data point. The Level two data may be filtered as discussed above using the “Delta Cents” textbox 787 price filter. A candlestick display method is traditionally used to show trade price information. The candlestick has a vertical bar representing the high price and low price for that timeframe along with a dash to the left (initial price) and a dash to the right (final price). The candlestick display method can be applied to any data set presented in this invention.

According to another embodiment of the invention, the user can define how the data is processed within the “Display” section 759 (within GUI 784, FIG. 23). The statistical filters (such as moving average) timeframe is defined in the textbox 789. For example, a value of 30 in the textbox 789 will calculate 30 second statistical filtering. Sometimes the statistical filtering is too small to view, relative to the other information being displayed. Textbox 801 is a multiplying factor for the calculated statistical filtering. For example, if a value of 2 is typed into textbox 801, then each calculation of statistical filtering (such as moving average) is multiplied by 2. This statistically filtered data can be applied to any of the features in this invention, such as graphical display, tabular display, simulated trading, and automated trading.

According to another embodiment of the invention, the user can define how the data is processed within the “Display” section 759 (within GUI 784, FIG. 23). If the user selects the “Mov Avg” checkbox 802, then a moving average for each of the Level one, Level two, and Time and Sales data subsets will be calculated. If the user selects the “Exp” checkbox 790, then an exponential moving average for each of the Level one, Level two, and Time and Sales data subsets will be calculated. The exponential moving average is calculated by taking the most recent value, adding the previous value (divided by two), then adding the next previous value (and dividing by three) and so forth. Once all of the values for the past 30 seconds are added, for example, the total is divided by 30. The objective is to have a moving average with more emphasis on the most recent values.

According to another embodiment of the invention, the user can define how the data is processed within the “Display” section 759 (within GUI 784, FIG. 23). If the user selects the “Wgt” checkbox 791 then a weighted moving average for each of the Level two data subsets will be calculated. The weighted moving average is calculated by taking the total order bid volume at the best bid price, plus the total order bid volume at the one cent below the best bid price divided by two, plus the total order bid volume at two cents below the best bid price divided by three, and so forth. Once all of the values for the past 30 seconds are added, for example, the total is divided by 30. The objective is to have a weighted moving average with more emphasis on the best bid volume and best ask volume. Additionally, the user can define the specific weight values.

According to another embodiment of the invention, the user can define how the data is processed within the “Display” section 759 (within GUI 784, FIG. 23). If the “MA Diff” checkbox 803 is selected, the invention will calculate the difference between the statistical filters for the bid volume orders and the ask volume orders. As an example, say the user has selected the moving average statistical filter using checkbox “Mov Avg” 802 with a timeframe of 30 seconds 789. The moving average will be calculated for the bid volume orders and the ask volume orders, that fall within the price filter 787, on a second-by-second basis for the past 30 seconds. With the “MA Diff” checkbox 803 selected, the difference between the moving average bid volume and the moving average ask volume will be calculated by subtracting the moving average ask volume from the moving average bid volume. One benefit of the statistical calculation Moving Average Difference, is that the imbalance between bid volumes and ask volume becomes much easier to identify.

According to another embodiment of the invention, the user can define how the data is processed within the “Display” section 759 (within GUI 784, FIG. 23). If the “MA Ratio” checkbox 804 is selected, the invention will calculate the ratio between the statistical filters for the bid volume orders and the ask volume orders. As an example, say the user has selected the moving average statistical filter using checkbox “Mov Avg” 802 with a timeframe of 30 seconds 789. The moving average will be calculated for the bid volume orders and the ask volume orders, that fall within the price filter 787, on a second-by-second basis for the past 30 seconds. With the “MA Ratio” checkbox 804 selected, the ratio between the moving average bid volume and the moving average ask volume will be calculated by dividing the moving average bid volume by the moving average ask volume. One benefit of the additional statistical calculation, Moving Average Ratio, is that the imbalance between bid volumes and ask volume becomes much easier to identify.

According to another embodiment of the invention, the user can define how the data is processed within the “Display” section 759 (within GUI 784, FIG. 23). If the user selects the “Stacked Tiers” checkbox 805, then the bid volume orders at each bid price will be separately displayed. Additionally, the ask volume orders at each ask price will be separately displayed. The user can define the number of stacked tiers to be used with the textbox 792. For example, suppose the user types a 3 into the textbox 792 and selects the “Stacked Tiers” checkbox 805. The graphical display will include the bid volume orders at the best bid price (in red), the bid volume orders at once cent below the best bid price (in green), and the bid volume orders at two cents below the best bid price (in blue), each stacked on a bar chart. Similarly, the ask volume orders at each price tier will be displayed on a stacked chart. The user can define the specific colors to be displayed.

According to another embodiment of the invention, the user can define customized statistical filters for any of the Level one, Level two, and Time and Sales data. In the “Display” section 759 (within GUI 784, FIG. 23), selecting “Statistical Filters” checkbox 793, the invention will utilize various customized statistical filters. These customized statistical filters can be applied to graphical display, tabular display, simulated trading, and automated trading.

According to another embodiment of the invention, the user can view the specific entry points and exit point from simulated trading and actual trading on historical and real-time graphs. In the “Display” section 759 (within GUI 784, FIG. 23), selecting “My Trade History” checkbox 794, the invention will display all trading history on the graph. This feature is a benefit in trouble shooting the various trading techniques or trading patterns.

According to another embodiment of the invention, the user can view any custom data set in a graph or table and use it for simulated trading, trading alerts, or automated trading. In the “Display” section 759 (within GUI 784, FIG. 23), selecting “Custom Data Set” checkbox 795, the invention will read the custom files and perform the operations when basic indicators are identified.

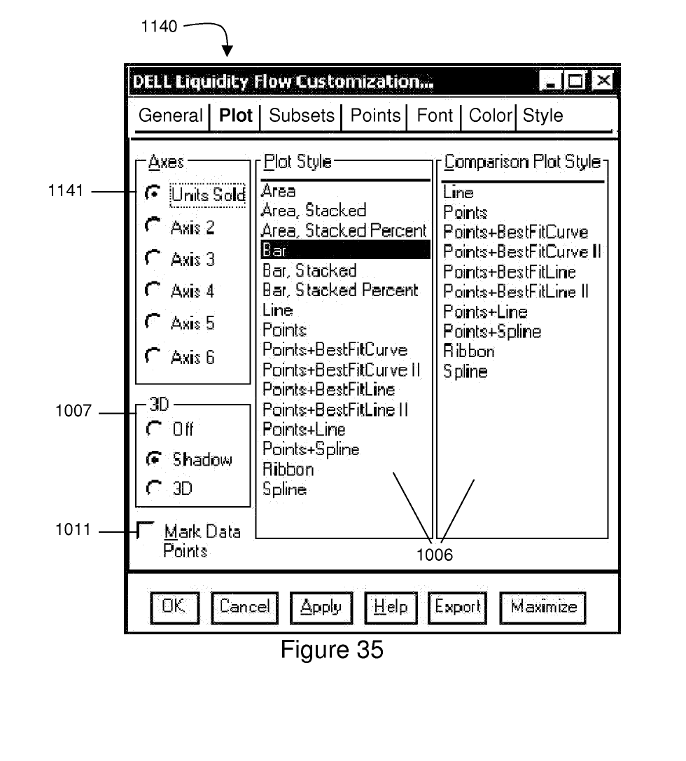

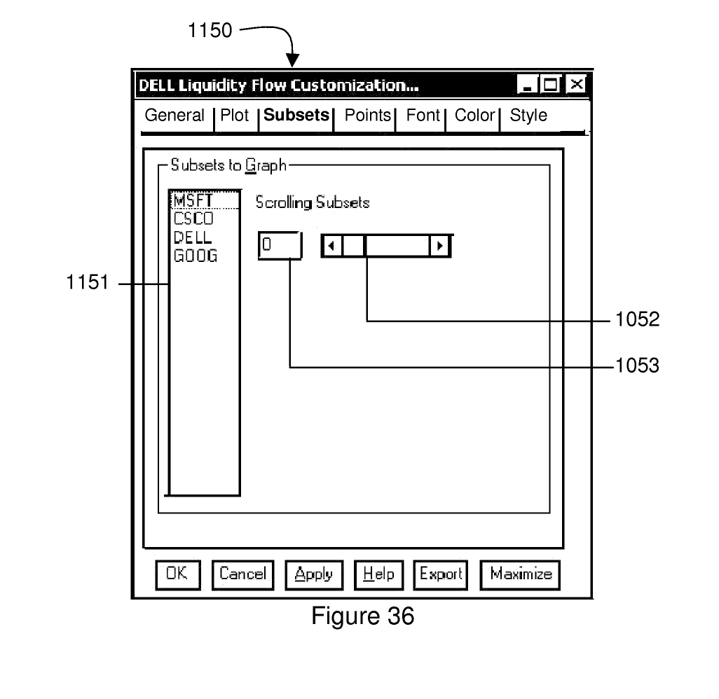

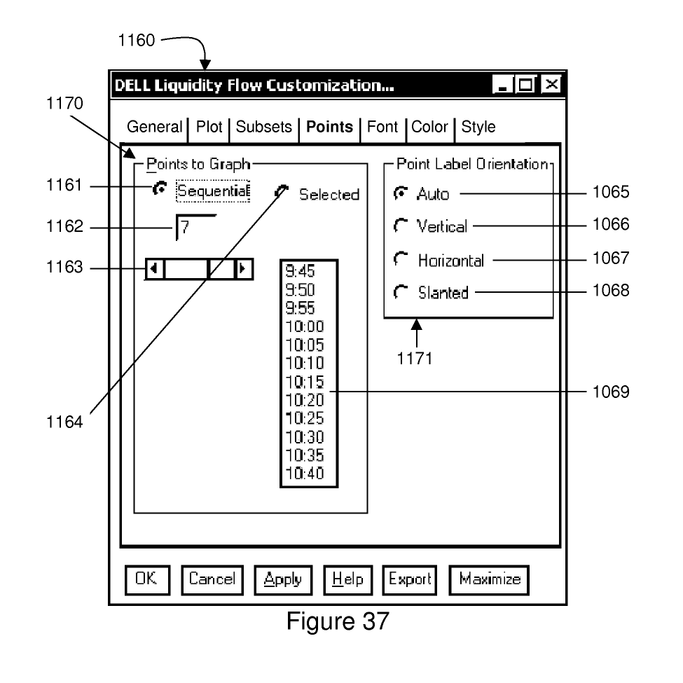

According to another embodiment of the invention, the user can design a custom graph or table and use it for simulated trading, trading alerts, or automated trading. The user defines the “Plot Style” 1006 (within GUI 1140, FIG. 35) for each axis. The user then defines the “Subsets to Graph” 1151 (within GUI 1150, FIG. 36). Finally, the user defines the “Points to Graph” 1170 (within GUI 1160, FIG. 37).

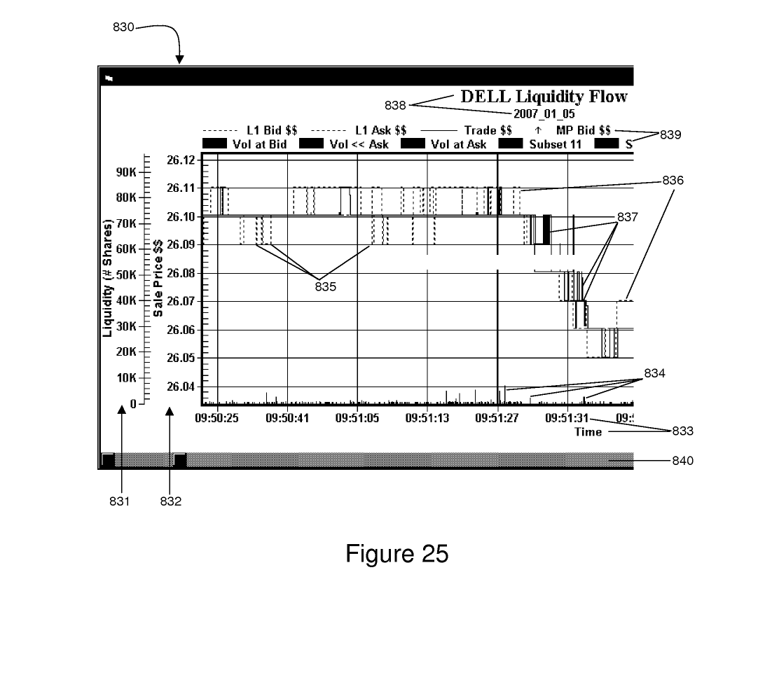

According to another embodiment of the invention, the user can display a graph as illustrated in 830 (FIG. 25). This graph has two Y-axis scales, “Liquidity (#Shares)” 831 and “Price $$” 832. The title information describes this graph as a “DELL Liquidity Flow” along with the date(s) being displayed 838. A legend 839 defines the various data sets being graphed. There is a horizontal scroll bar 840, allowing the user to more forward or backward on the x-axis Time 833 scale. On this sample graph, the data sets that are being displayed include: Level 1 best bid price 835, Level 1 best ask price 836, Time and Sales last trade price 837, and Time and Sales last trade volume 834. Each of the displayed data sets can be color coded or assigned a unique style by the user. Any data set can be graphed on this chart. The graph information can be displayed on the same graph, a split graph or multiple graphs.

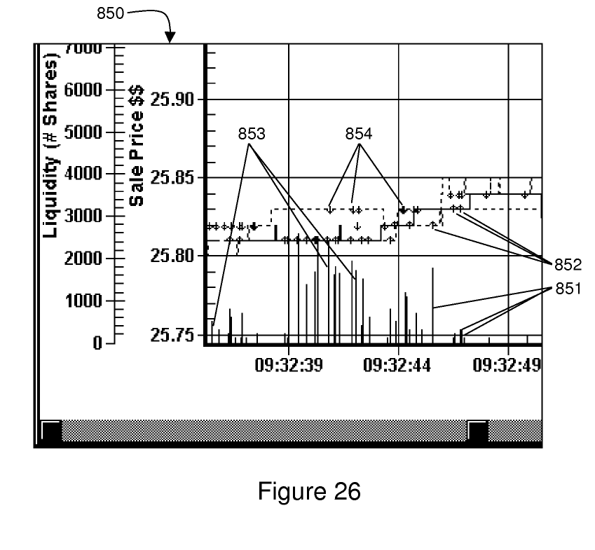

According to another embodiment of the invention, the user can display a graph as illustrated in 850 (FIG. 26). This sample graph has the same characteristics as that described above for 830 (FIG. 25) with some additional data. The additional data sets include: Market Player raw bid volume 853, Market Player raw ask volume 851, Market Player ask price 854, and Market Player bid price 852. Each of the displayed data sets can be color coded or assigned a unique style by the user. Any data set can be graphed on this chart.

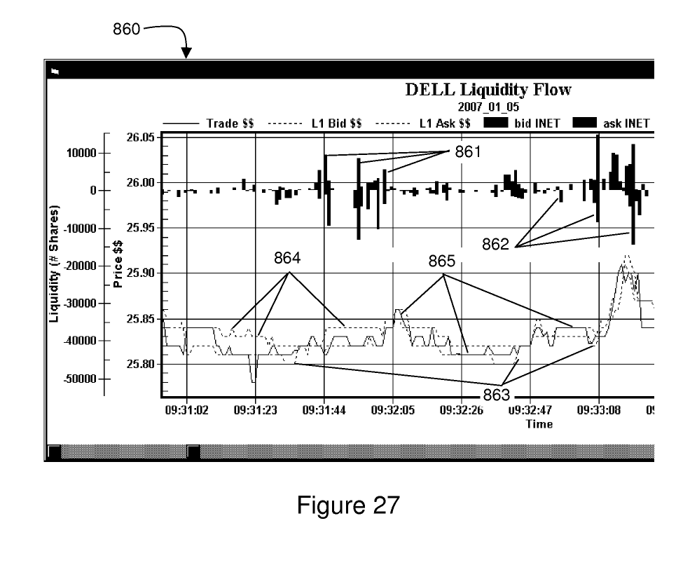

According to another embodiment of the invention, the user can display a graph as illustrated in 860 (FIG. 27). This graph has the same characteristics as that described above for 830 (FIG. 25) with some additional data. The additional data sets include: Market Player binned bid volume 861, Market Player binned ask volume 862, Level 1 best bid price 863, Level 1 best ask price 864, and Time and Sales last trade price 865. Each of the displayed data sets can be color coded or assigned a unique style by the user. Any data set can be graphed on this chart.

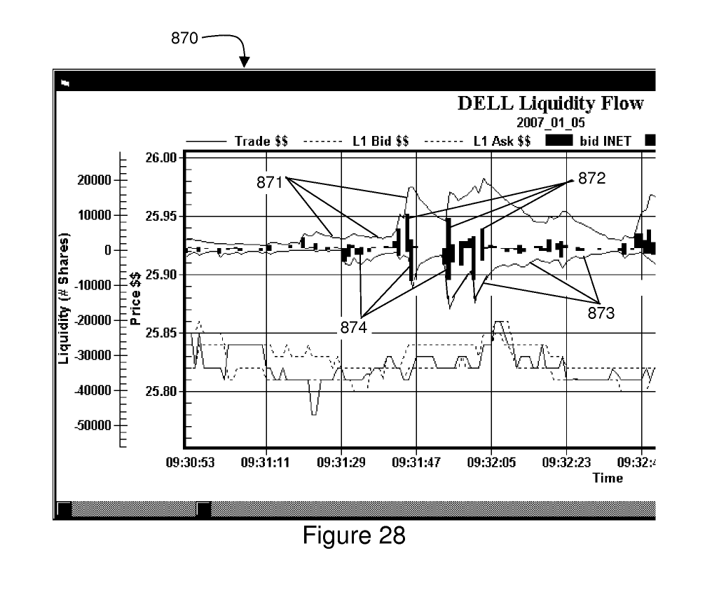

According to another embodiment of the invention, the user can display a graph as illustrated in 870 (FIG. 28). This graph has the same characteristics as that described above for 830 (FIG. 25) with some additional data. The additional data sets include: Market Player binned bid volume 872, Market Player binned ask volume 874, Market Player bid volume 30-second Exponential Moving Average 871, Market Player ask volume 30-second Exponential Moving Average 873. Each of the displayed data sets can be color coded or assigned a unique style by the user. Any data set can be graphed on this chart.

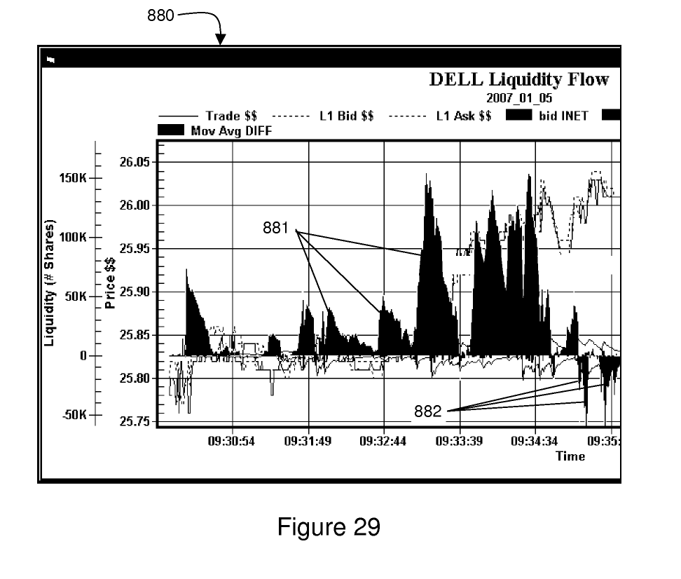

According to another embodiment of the invention, the user can display a graph as illustrated in 880 (FIG. 29). This graph has the same characteristics as that described above for 830 (FIG. 25) with some additional data. The additional data set is the difference between the bid volume and ask volume for a Market Player 30-second Exponential Moving Average (881, 882). The bid volume Exponential Moving Average is greater than the ask volume Exponential Moving Average in 881. The bid volume Exponential Moving Average is less than the ask volume Exponential Moving Average in 882. Each of the displayed data sets can be color coded or assigned a unique style by the user. Any data set can be graphed on this chart.

According to another embodiment of the invention, the user can display a graph or a table as illustrated in 890 (FIG. 30). This graph has the same characteristics as that described above for 830 (FIG. 25) with a legend 891 and table 893 added. The graph section of the display 890 is identified as 892. The table section of the display 890 is identified as 893. The legend section of the display 890 is identified as 891.

According to another embodiment of the invention, the user can display a graph as illustrated in 900 (FIG. 31). This graph has a Y-axis labeled “Price Delta” 903 and the X-axis labeled “Time (Seconds)” 904. As an example, the maximum gain trade opportunities, for a given 10-minute window, are plotted as 901. As an example, the maximum loss trade opportunities, for a given 10-minute window, are plotted as 902. The user can define the timeframe for the calculation. The user can also define the specific variables to be graphed on the x-y scatter plot. Each of the displayed data sets can be color coded or assigned a unique style by the user. Any data set can be graphed on this chart.

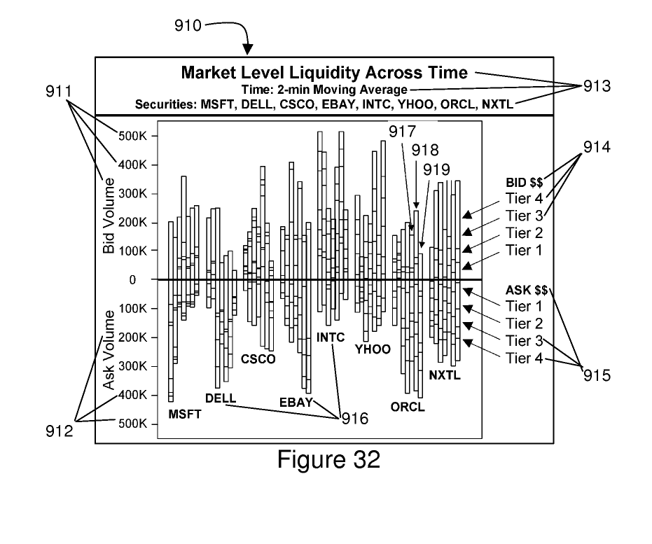

According to another embodiment of the invention, the user can display a graph as illustrated in 910 (FIG. 32). For this example, the graph has a split Y-axis labeled. One axis is labeled “Bid Volume” 911 and the other labeled “Ask Volume” 912. The legend information is displayed at the top of the graph 913. This graph includes the cumulative (of several selected) Market Players bid and ask volume for several securities 916 simultaneously. There is also a historical reference for the Market Players bid and ask volume. For example, the most recent display for ORCL is identified as 919. This is the latest 2-minute moving average for ORCL. The data set identified as 918 is the previous 2-minute moving average (2-4 minutes in the past). The data set identified as 917 is the moving average 4-6 minutes in the past. For this example, the stacked price tiers for the bid volume 914 and the ask volume 915 are labeled. The moving average timeframe is a user-defined variable. The user can also display the chart based on raw messages if desired. Each of the displayed data sets can be color coded or assigned a unique style by the user. Any data set can be graphed on this chart.

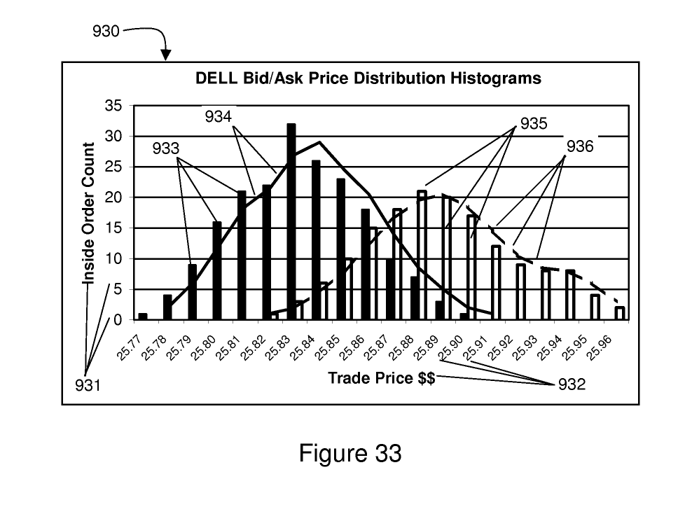

According to another embodiment of the invention, the user can display a graph as illustrated in 930 (FIG. 33). For this example, the y-axis 931 is the inside order count. The x-axis 932 is the price. This graph displays two histograms of data, one for the bid price 933 and one histogram for the ask price 935 distribution. The bid price moving average 934 and ask price moving average 935 are also included. Moving Average is used to as example. Any statistical filtering can be applied to the graphs and charts. Each of the displayed data sets can be color coded or assigned a unique style by the user. Any data set can be graphed on this chart.

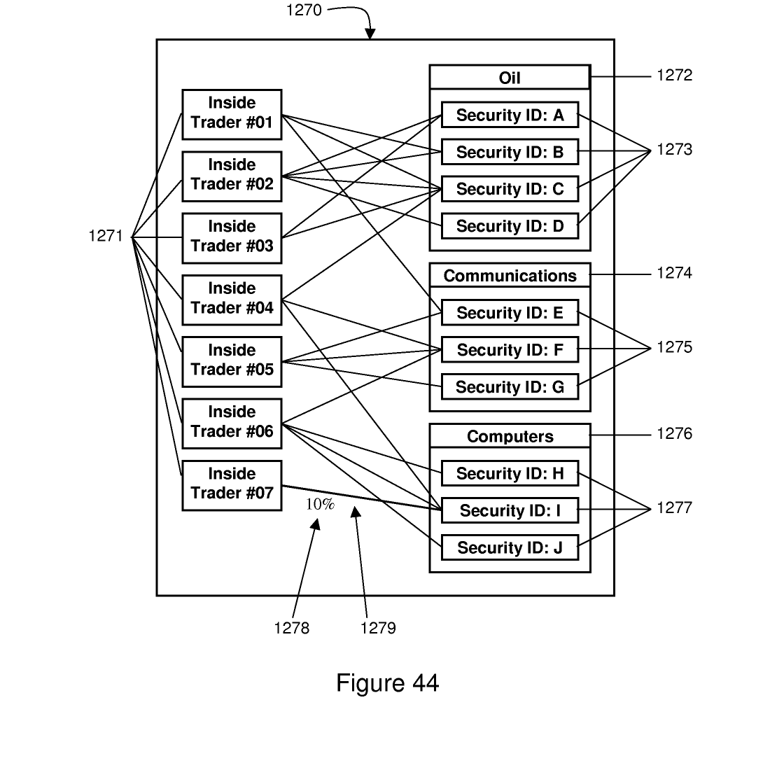

According to another embodiment of the invention, the user can display a graph that links the Insider Traders with a specific security and industry sector as illustrated in 1270 (FIG. 44). The “Insider Traders” 1271 are those who hold a major position in a security. Once an individual or entity holds a significant number of shares in a company (for example 8% of total number of shares), the “Insider Traders” 1271 must disclose to the Securities and Exchange Commission any purchases or sales of the securities. The trades are generally on a large-scale basis and the information is public knowledge, available on various Internet web pages. The invention can read the information from a user-defined Internet source or other location/method and download the insider trade information, specifically who is trading, what securities they are trading, and number of shares traded. Once this information is captured, the graphical view introduced in 1270 (FIG. 44) can be created, as an example. This graphical display shows a link 1279 between each of the “Insider Traders” 1271 and the “Security” 1273, 1275, 1277 that they hold a major position. The securities and classified into various “Industry Sectors” 1272, 1274, 1276. The total position held is also displayed in 1278. When the user clicks on any of the “Inside Trader” 1271, all of the links connected to various “Security” 1273, 1275, 1277 are highlighted. Similarly, when the user clicks on one of the “Security” 1273, 1275, 1277, all of the “Inside Traders” 1271 that hold a major position is highlighted. The user can define how the highlight is performed, either with alternate color or other style. The specific trades can also be graphed with other information to help the user understand the impact of the inside trades.

According to another embodiment of the invention, the present invention utilizes existing charting software module and application programmers interface (API) called ProEssentials, which is developed by Gigasoft, Inc of Keller, Tex. Those skilled in the art recognize that the present invention is capable of operating with charting modules supplied by others, as ProEssentials is merely exemplary. The graphing capabilities of the invention are not limited to the specific features defined by ProEssentials.

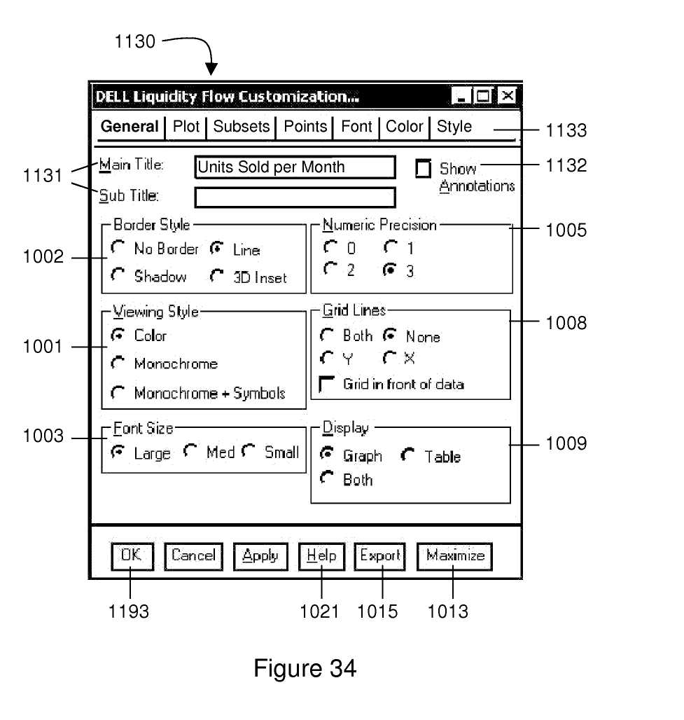

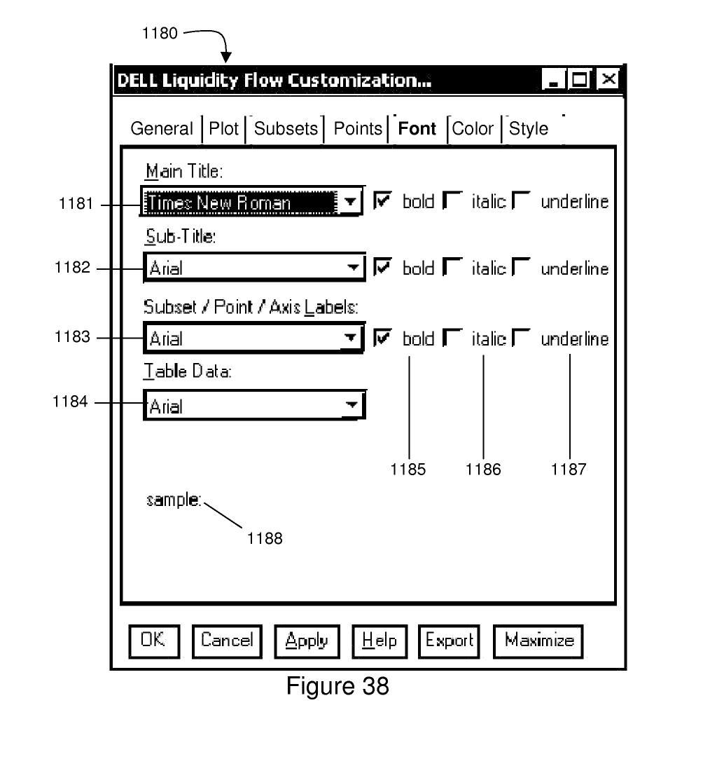

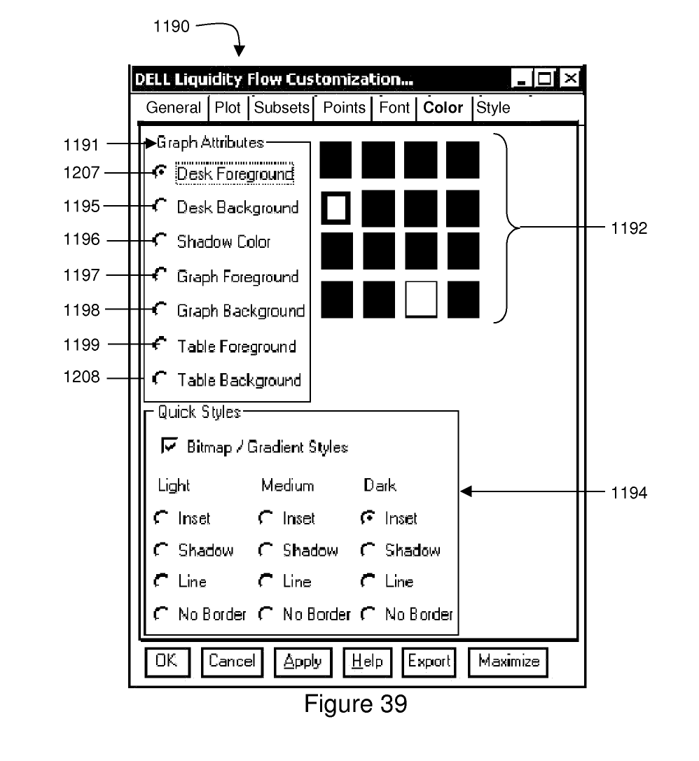

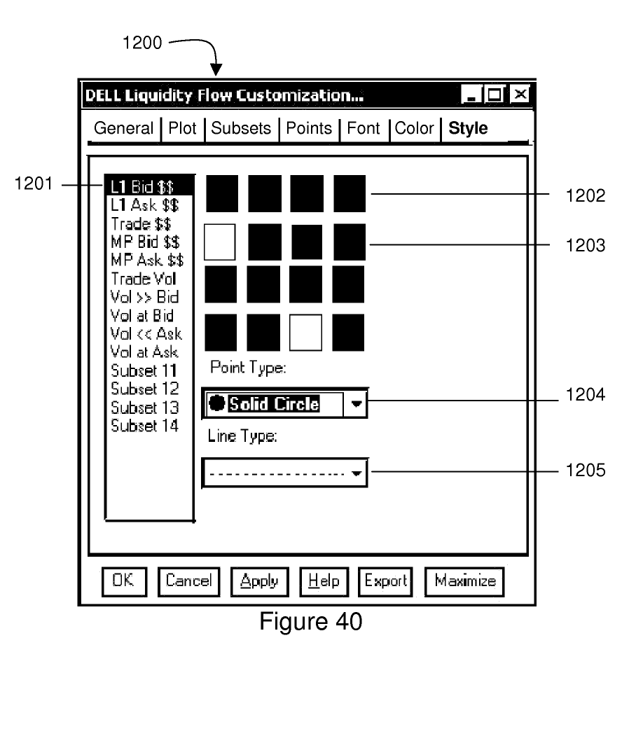

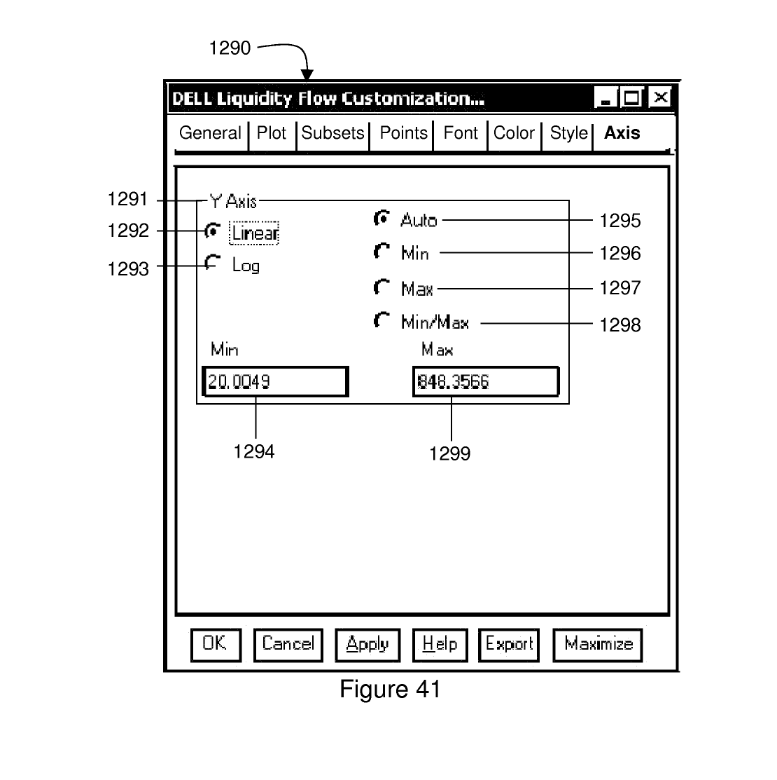

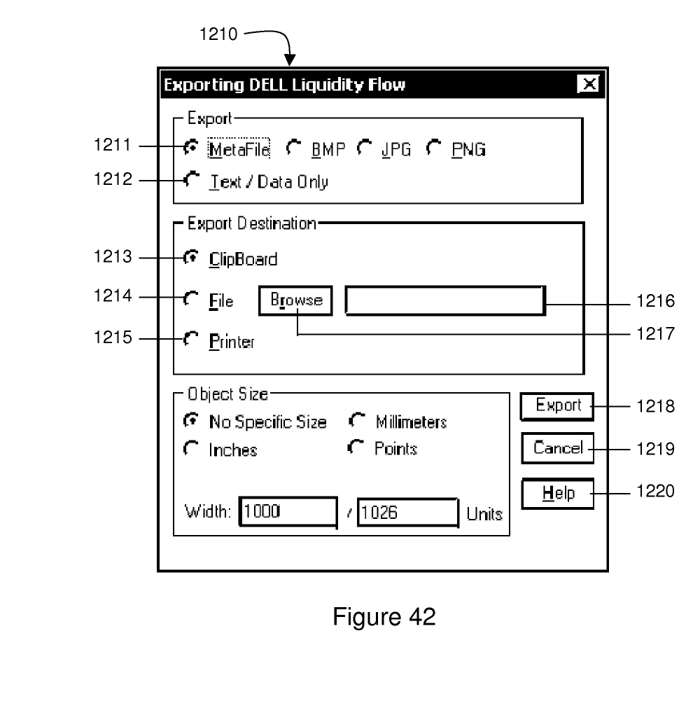

The ProEssentials charting software enables the user of this invention to define customized settings associated with each chart, table and data set. The user can access the ProEssentials options dialog by right clicking with the mouse button on any chart or table. A sample “Dialog Box” control menu is presented in 1130 (FIG. 34). The custom dialog box has several selection tabs to organize the various options. A sample of each Customize Dialog Selection Tab is presented for completeness in FIGS. 34-42 for the following tab headers: “General” 1130 (FIG. 34), “Plot” 1140 (FIG. 35), “Subsets” 1150 (FIG. 36), “Points” 1160 (FIG. 37), “Font” 1180 (FIG. 38), “Color” 1190 (FIG. 39), “Style” 1200 (FIG. 40), and “Axis” 1290 (FIG. 41). Finally, by selecting the “Export Dialog” button 1015 in the Dial Box control menu 1130 (FIG. 34) a new control box 1210 (FIG. 42) appears. Based on the GigaSoft ProEssentials help documentation, a high-level overview of the various controls available through ProEssentials is discussed below.

In the ProEssentials charting software customization dialog box “General” tab 1130 (FIG. 34) enables the user of this invention to define the “Main Title” or “Sub Title” in 1131. These two edit-boxes allow adding, editing, and deletion of main and sub titles. If no title is present, entering one will add one. If the user removes all the characters from a title, it will be deleted from the chart or graph.

The ProEssentials charting software customization dialog box “General” tab 1130 (FIG. 34) enables the user of this invention to define the “Viewing Style” in 1001. The Graph Object supports three viewing styles: Color, Monochrome, and Monochrome with Symbols. This customization allows the user to quickly adjust the image to best suite printing on a monochrome printer. In another embodiment of this invention, the user can define the other viewing styles for each graph object.

The ProEssentials charting software customization dialog box “General” tab 1130 (FIG. 34) enables the user of this invention to define the “Font Size” in 1003. The Graph Object supports three font sizes, Large, Medium, and Small. Depending on the size of the graph, the user can select the font size that is most readable. There are occasions the graph may automatically reduce the size of the font in order to produce a higher quality image. In another embodiment of this invention, the user can define the specific font size or type for each graph object.

The ProEssentials charting software customization dialog box “General” tab 1130 (FIG. 34) enables the user of this invention to “Show Annotations” in 1132. If the object contains annotations, this check box allows the user to remove/add the annotations from the image.

The ProEssentials charting software customization dialog box “General” tab 1130 (FIG. 34) enables the user of this invention to define the “Numeric Precision” in 1005. When placing information into a table, or exporting Text/Data from the Export Dialog, the number of decimal positions can be between 0 to 7. Depending on the implementation, the maximum precision may vary. In another embodiment of this invention, the user can define the maximum precision of any data set with no limitations.

The ProEssentials charting software customization dialog box “General” tab 1130 (FIG. 34) enables the user of this invention to define the “Graph Grid Lines” in 1008. The Graph Object can contain vertical grid lines, horizontal grid lines, both vertical and horizontal grid lines, or no grid lines. By checking the “Grid in front of data” 1091 option, the graph's grid is placed in front of the data graphics. Otherwise, the data graphics are drawn on top of the graph's grid.

The ProEssentials charting software customization dialog box “General” tab 1130 (FIG. 34) enables the user of this invention to define the “Graph and/or Table” in 1009. The Graph Object can display a graph, table, or both graph and table. The user can define the display to include a Graph, a Table, or both a Graph and a Table. The font size of the text inside the table depends on the number of points, and the numeric precision of the output. The more points and higher precision that is to be in a table, the smaller the font must be in order for the information to fit. In another embodiment of this invention, the user can define any font size without it being automatically changed.

The ProEssentials charting software customization dialog box “Plot” tab 1140 (FIG. 35) enables the user of this invention to define the “Plot Styles” in 1006. The Graph Object has 21 possible plotting methods for the primary plotting style: Area, Area Stacked, Area Stacked Percent, Bar, Bar Stacked, Bar Stacked Percent, Box-Plot (Candle Stick), High-Low-Bar, High-Low-Line, High-Low-Close, Histogram, Horizontal Bar, Line, Open-High-Low-Close, Point, Points plus Best Fit Curve, Points plus Best Fit CurveII (Best Fit Curve for graphed points), Points plus Best-Fit-Line, Points plus Best-Fit-LineII (Best-Fit-Line for graphed points), Points plus Spline, and Spline. Depending on the implementation, some plotting methods may not be available. Also, many but not all of these plotting styles can be set for a secondary comparison plotting style. If the graph has multiple y axes, then the user can control plots and comparison plotting styles for each individual axis by selecting the axis in the axis-button group. The Histogram plotting method displays a histogram of the data that is currently selected. The Histogram is most meaningful with larger data sets (at least 15 data points). If the Histogram is for only one subset, then bars represent the number of occurrences. If the Histogram is for multiple subsets, then lines will represent the different frequency distributions. As another embodiment of this invention, there are no limitations on the number of Plot Styles that can be used.

The ProEssentials charting software customization dialog box “Plot” tab 1140 (FIG. 35) enables the user of this invention to define the “Mark Data Points” in 1011. Checking this checkbox will cause little circular marks to be placed at data point locations. As another embodiment of this invention, the user can define the type of data point markers.

The ProEssentials charting software customization dialog box “Plot” tab 1140 (FIG. 35) enables the user of this invention to define the “3D” in 1007. This feature allows the user to adjust 3D effects added to plotting methods. Possible values are: (a) None-No 3D effect is added, or (b) Shadows—Draw shadows behind bars, points, and the area of an area graph, or (c) 3D—Bars and area charts are drawn in a 3D fashion.

The ProEssentials charting software customization dialog box “Subsets” tab 1150 (FIG. 36) enables the user of this invention to define the “Subsets To Table” in 1151. If the Graph Object is currently displaying a table, then the table can include either: the subset(s) that are currently selected to be graphed, or all subset information that is included in the object. If all Subsets are being tabled then those subsets that are currently graphed will be highlighted. If the table includes only those subsets that are graphed, and permanent subsets are displayed along with scrolling subsets, then permanent subsets will be highlighted.

The ProEssentials charting software customization dialog box “Subsets” tab 1150 (FIG. 36) enables the user of this invention to define the “Subsets to Graph” in 1151. This group allows the user to view subset information in a variety of ways, such as: (a) If nothing is selected in the list box 1151 and Scrolling Subsets 1053 equals zero, then the object will display all subset information (14 subsets graph maximum, and no limit on the amount of subsets tabled), or (b) If there are selections in the list box 1151 and Scrolling Subsets 1053 equals zero, then the object will display only those subsets selected, or (c) If nothing is selected in the list box 1151 and Scrolling Subsets 1053 is non-zero, then the object will scroll through subset information by the amount defined by Scrolling Subsets 1053, or (d) If there are selections in the list box 1151 and Scrolling Subsets 1053 is non-zero, then the object will maintain those selected subsets as permanent subsets and revolve through the remaining subsets in increments of Scrolling Subsets.

The ProEssentials charting software customization dialog box “Points” tab 1160 (FIG. 37) enables the user of this invention to define the “Points to Graph” in 1170. If the Graph Object contains a data set with many points, then it may be hard to table or even graph all of the information at one time. The Graph Object gives the user two methods for viewing a smaller amount of points, thus making the information more readable. The first method for viewing is “Sequential” 1161. When choosing the Sequential method, the user can use the scrollbar 1163 to adjust the amount of points to graph. If the amount chosen is less than the total number of points, then a horizontal scrollbar will be visible, allowing the user to scroll left and right through the rest of the data. The second method for viewing is “Selected” 1164. When choosing the “Selected” method, the user can use the list box 1069 to select the points to place in the graph.

The ProEssentials charting software customization dialog box “Points” tab 1160 (FIG. 37) enables the user of this invention to define the “Point Label Orientation” in 1171. There are four possible settings for the Point Label Orientation: (a) Auto—Point Labels are either horizontal or vertical, (b) Vertical—Point Labels are vertical, (c) Horizontal—Point Labels are horizontal, and (d) Slanted—Point Label are slanted. If horizontal point labels are too small to read, then Vertical or Slanted orientation will force them larger.

The ProEssentials charting software customization dialog box “Fonts” tab 1180 (FIG. 38) enables the user of this invention to define the font styles for the “Main Title” 1181, the “Sub-Title” 1182, the “Subset/Point/Axis Labels” 1183 and the “Table Data” 1184. The “Subset/Point/Axis Labels” 1183 include: X axis label, Y axis label, X axis grid numbers or point labels, and Y axis grid numbers. The user can also select font attributes of Boldness 1185, Italics 1186, and Underline 1187.

The ProEssentials charting software customization dialog box “Colors” tab 1190 (FIG. 39) enables the user of this invention to define the various colors associated with the graphs and tables. The Graph Object supports two sets of color parameters. A “Monochrome” color set and a “Color” color set. Depending on the Viewing Style 1006, the Colors Dialog 1190 will customize the appropriate set. To adjust colors, select the desired object attribute in the “Graph Attributes” 1191 section. The corresponding color for that attribute will be highlighted in the color selection grid 1192. To change the color, either use the mouse to click an alternate color 1192, or use the keyboard arrow keys to move to adjacent colors. As the highlighted color selection changes position, the sample image will be updated with the newly selected color. Pressing the “OK” 1193 button will update the color parameters of the object.

The ProEssentials charting software customization dialog box “Colors” tab 1190 (FIG. 39) enables the user of this invention to define the various colors associated with the “Graph Attributes” 1191. These include the following: Desk Background 1195—This is the color that surrounds the bounding rectangle of the graph's grid, “Desk Foreground” 1207—This is the color that is used when placing text onto the Desk Background. This includes the main title, sub title, subset/point labels, grid numbers, and axis labels, “Shadow Color” 1196—The rectangles that make up the graph's grid and table and bounded at the bottom/right edges with shadows. To remove the shadows, choose the same color as the Desk Background, “Graph Background” 1198—This is the color used as the background color of the graph's grid, “Graph Foreground” 1197—This is the color used for the bounding rectangles of the grid, the grid-lines of the graph, and lines that are used to bound some of the plotting methods (like the bounding line around bars of the Bar Plotting Method), “Table Background” 1208—This is the color used in filling the table's rectangle, and “Table Foreground” 1199—This is the color used in bounding the table's rectangle, and for the text inside the table.

The ProEssentials charting software customization dialog box “Style” tab 1200 (FIG. 40) enables the user of this invention to control graphed data subset color 1202, subset line style 1205, and subset point style 1204. For example, to change a color style, the user will perform the following steps: (a) Select the desired subset in the Subsets list box 1201. The corresponding color and possible line and point styles are then highlighted in their respective controls, then (b) To change the color, either use the mouse to click an alternate color, or use the keyboard arrow keys to move to adjacent colors. Adjust the subset line and point styles as desired, and (c) pressing the OK button 1193 will update the object's image.

The ProEssentials charting software customization dialog box “Axis” tab 1290 (FIG. 41) enables the user of this invention to define the axis type and range. The possible axis types include: Linear 1292, and Log 1293. The user can also define possible axis range control as the following: Auto 1295—Graph automatically determines min and max based on data, or Min 1296—Manually set Min and automatically set Max, or Max 1297—Manually set Max and automatically set Min, or Min/Max 1298—Manually set both the Min and Max. Depending upon the Auto, Min, Max, and Min/Max item selected, the appropriate text boxes will be enabled allowing the user to set the axis range.

The ProEssentials charting software Export dialog box 1210 (FIG. 42) enables the user of this invention to define how a table or graph will be exported. All objects have the same exporting capabilities. Objects can export the following formats to the listed destinations: (a) Metafile to Clipboard, File, and Printer, (b) Bitmap to Clipboard and File (c) OLE Object to Clipboard. (d) Text or Data to Clipboard, and File (e) JPEG to File. The user can export the table or graph to the Clipboard 1212, to a File 1213, or to a Printer 1214. If the table or graph will be exported to a file, the user can select the Browse 1217 button to select a directory path location, which will be displayed in the text box 1216. In another embodiment of this invention, the user can export the data in any format to any location.

The ProEssentials charting software Export dialog box 1210 (FIG. 42) enables the user of this invention to define how a table or graph will be printed 1214. The Print Dialog will show the default printer and its current orientation and paper bin. The user can select another printer via the dropdown combo box, which will display all available system and network printers. If printer orientation, paper bin, or other printer option needs to be adjusted, the Setup button can be pressed to invoke the printer's setup dialog.

Existing Product Compatibility and Enhancements

According to another embodiment of the invention, the trading indicators can be defined in TradeStation's EasyLanguage, or as a compatible module within any other existing product. EasyLanguage lets the user describe ideas using simple, English-like statements and trading terms, similar to how a user would describe them to another trader. An EasyLanguage Dictionary includes several hundred pre-written built-in functions covering many of the most popular trading concepts and technical indicators, such as Moving Averages, Stochastics, chart patterns and relative strength formulas. The user can search for a function in the EasyLanguage Dictionary, and then paste it into a strategy with a click of the mouse. This invention improves on the current TradeStation trading indicator variable and timeframe, which is solely based on the last trade price, recorded on a tick-by-tick basis. The invention can simulate trading, provide an alert, or automatically trade based on any of the Level 1, Level 2, or Time and Sales data variables or any other user defined data set, on a message-by-message basis or on a user defined time interval. A sample of the variables include: Best bid price, best ask price, total trade volume, trader bid price, trader ask price, trader bid volume, trader ask volume. Statistical analysis of these variables can also be used to provide a trading indicator, such as: moving average of a trader's bid volume, exponential moving average of a trader's ask volume, number of bid messages at the best bid price, all within a user-defined timeframe.

According to another embodiment of the invention, simulated trading performance can be evaluated with a variety of reports and graphs. The Strategy Performance Report defined in the TradeStation software includes over 180 performance fields to help the user analyze a strategy based on historical data. Some of the performance fields include: strategy's average profitable trade, average losing trade, number of consecutive winning and losing trades, and average time in trades could have been and what the longest time period between winning and losing trades could have been. The user can evaluate a strategy with a list of established risk-reward ratios, and see how the strategy could have performed from perspectives such as entry and exit efficiency, time in the market and stability. A Trade-by-Trade report that the user can sort by several fields, such as: total percentage of profit, total efficiency rating, and run-up. The Strategy Performance Report also includes over 20 graphs to view key simulated performance data visually. The invention is compatible with all of the performance fields and graphs available in the TradeStation software.

According to another embodiment of the invention, the invention is compatible with TradeStation's Custom Continuous Futures Contracts. This enables the user to customize the rules that determine when and how the continuous futures contracts roll from one month to the next. The user can choose the specific months to include in the continuous contract, the data series on which to base the continuous data, the rollover trigger event, and the back adjustment method.

According to another embodiment of the invention, the invention is compatible with various online trading forums, such as TradeStation's Trading Community. The trading community is an online community of members and visitors who offer a variety of content on testing and automating trading strategies. Strategy Articles cover topics on strategy development, testing and automation, conversations with well-known traders, and contributions from community members. Most articles include illustrations, charts and graphs. The EasyLanguage code behind the strategy of analysis tools discussed is available for download in the EasyLanguage Library. Discussion Forums include Trading Discussions, TradeStation EasyLanguage/Software Questions, TradeStation Execution/Automation Questions, and Suggested Feature Polls. The user can ask questions, share experiences and gain new insights from other strategy traders and well-known traders. The EasyLanguage Library is the arena where TradeStation users contribute EasyLanguage studies and exchange them with other community members. The invention is an improvement over the current trading communities by giving the user a broader and more insightful dataset than existing technologies. TradeStation, for example, is based on last trade price, while this invention includes all Level 1, Level 2, and Time and Sales data messages along with any other user defined data sets and user defined time intervals.

According to another embodiment of the invention, it is enhanced with TradeStation's system of using and creating indicators, based on a library of over 100 of the most popular indicators. Using a mouse, the user can apply a Moving Average, Stochastic or other common indicators to a chart. Using TradeStation's EasyLanguage technology, the user can describe any custom indicator from scratch. Once added the indicator becomes part of the user's library and can be applied to any chart. All existing indicators in the library are written in EasyLanguage, so the user can easily modify the standard indicators. The invention is an improvement over the current trading indicators by giving the user a broader and more insightful dataset than existing technologies. TradeStation, for example, is based on last trade price, while this invention includes all Level 1, Level 2, and Time and Sales data messages along with any other user defined data sets and user defined time intervals.

According to another embodiment of the invention, it is enhanced with the alerts used in TradeStation. All indicators have standard alerts built-in, which can be used as designed or can be modified. The user can write a custom alert criteria using EasyLanguage. The invention is an improvement over the current trading alerts by giving the user a broader and more insightful dataset than existing technologies. TradeStation, for example, is based on last trade price, while this invention includes all Level 1, Level 2, and Time and Sales data messages along with any other user defined data sets and user defined time intervals.

According to another embodiment of the invention, it is enhanced with the ShowMe Studies used in TradeStation. ShowMe Studies include 22 built-in alerts based on popular indicators, and the user can create their own custom ShowMe Studies with EasyLanguage. The invention is an improvement over the current trading alerts and indicators by giving the user a broader and more insightful dataset than existing technologies. TradeStation, for example, is based on last trade price, while this invention includes all Level 1, Level 2, and Time and Sales data messages along with any other user defined data sets and user defined time intervals.

According to another embodiment of the invention, it is enhanced with the PaintBar Studies used in TradeStation. PaintBar is a feature that paints a series of bars on a chart a different color to highlight specific market activity. For example, the user can scan a chart to see when the slow moving average is above the fast moving average and automatically display those bars on a chart in a different color. PaintBar works with alerts so the system will tell the user the instant it occurs-in real-time. There are 17 built-in PaintBar Studies with alerts, and gives the user the ability to create and save personal custom PaintBar Studies using EasyLanguage. The invention is an improvement over the current PaintBar feature by giving the user a broader and more insightful dataset than existing technologies. TradeStation, for example, is based on last trade price, while this invention includes all Level 1, Level 2, and Time and Sales data messages along with any other user defined data sets and user defined time intervals.

According to another embodiment of the invention, it is enhanced with the Intelligent drawing tools used in TradeStation. The user can measure, mark and highlight price charts with several intelligent drawing tools. Drawing tools will adjust and recalculate as the user drags them across the chart or change time compression on a chart. The user can click and drag the mouse to draw, resize, move, rotate or extend Trendlines, Gann Fans, Support and Resistance lines and other objects on a chart. The user can also plot space, drawing tools, and indicators to the right of a chart. The user can drag the chart background in any direction within the sub-graph and there is an option to automatically snap trendlines to the nearest open, high, low or close as the user draws or move them. The drawing tools have pre-set and customizable alerts which are able to monitor multiple potential opportunities simultaneously. The chart does not need to be displayed on the computer screen to have TradeStation monitor that condition. Indications are displayed in the status line when a strategy or analysis technique is applied or when a correction for a symbol is received. The indication also provides a way to easily change the automation, alert and pending correction(s) settings through the right mouse-button menu. The invention is an improvement over the current drawing features by giving the user a broader and more insightful dataset than existing technologies. TradeStation, for example, is based on last trade price, while this invention includes all Level 1, Level 2, and Time and Sales data messages along with any other user defined data sets and user defined time intervals.

According to another embodiment of the invention, it is enhanced with the RadarScreen used in TradeStation. The radar screen allows the user to scan hundreds of symbols in real-time based on over 180 technical and fundamental indicators as well as the user's own custom criteria. The data is updated on a tick-by-tick basis, as a multitude of symbols and/or intervals are sorted and ranked in any order defined by the user. EasyLanguage can be used to define anything from the simplest to the most complex criteria for real-time market scanning, ranking and custom indicator column calculation. The user can create custom scanning formulas that reference the current bar's data and historical data for prior bars, with custom filters and indicators. The user can customize the windows to dynamically change color to show various market activities. The RadarScreen can plot Earning per Share, Institutional Ownership, Short Percentage and nearly 1000 other fundamental data fields to scan for trading opportunities, over 180 Indicator columns included, over 160 built-in indicators, all written in EasyLanguage. A library of technical indicators includes some of the most popular trading concepts, such as: moving averages, stochastics, RSIs. The indicators can be applied to the page of symbols using a drag and drop interface. The user can design a custom scanning criteria, define custom indicators and analysis techniques and combine over 100 built-in math functions and technical indicators. The user can insert custom filter columns in EasyLanguage, and can color-code background and foreground indicators as columns. RadarScreen dynamically ranks and sorts up to 1000 symbols in real-time based on custom sort criteria. Symbols are ranked relative to others based on all column headings at once, and on numerous criteria. The user can break up symbol categories into different pages or sub-sort the symbols on a page by including a blank row between categories. With a blank row between groups of stocks, the user can sort and rank within different groups all on the same page.

According to another embodiment of the invention, it is enhanced with the RadarScreen, SmartStyling feature, used in TradeStation. SmartStyling is a feature that allows the user to color-code each cell to change dynamically as the market shifts. For example, if the user would like to see a group of symbols ranked by volume, but also like to identify which stocks and/or futures contracts are trading above the 10-day moving average, the user can ask RadarScreen to color code cells for symbols with that criteria. RadarScreen tracks the markets for the user and sends alerts various ways defined above. The user can have RadarScreen send updates on a list of symbols the user is tracking, and specify any time interval. Updates will not be sent if there has been no change in the specified time. The user can set alerts on every single symbol within the tracking list, every single column and every single indicator, whether custom or built-in. The user will know instantly when a trading opportunity arises based on the criteria.

According to the same embodiment of the invention, it is enhanced with the RadarScreen used in TradeStation. The user can set bar intervals independently for each row in RadarScreen, enabling the user to see and compare chart values and data in a tabular format. The column calculations for each row will be based on the interval specified for that row, providing the ability to see and easily compare chart values in a tabular format. The user can add symbols with customizable lists, and rank and sort them as desired. The user can add symbols by typing them directly in a cell. The RadarScreen includes pre-built symbol lists of industry sectors, exchanges, etc. The user can create and save custom symbol lists, as well. With the mouse, the user can change columns/sorting/ranking criteria by applying favorite RadarScreen template. The user can create custom time sessions to customize what data is seen. The system is designed to include support for Multiple Processors and multi-threaded applications and works with up to eight CPUs on the same machine. The RadarScreen includes the full functionality of the Quotes window in TradeStation. The RadarScreen will indicate when a correction (tick insertion, deletion or edit) is received. The user can apply the pending corrections by right-clicking the mouse. The invention is an improvement over the current RadarScreen by giving the user a broader and more insightful dataset than existing technologies. TradeStation, for example, is based on last trade price, while this invention includes all Level 1, Level 2, and Time and Sales data messages along with any other user defined data sets and user defined time intervals. Additionally, the TradeStation system is updated on a tick-by-tick basis, while the invention is updated much faster, on a message-by-message basis for Level 1, Level 2, and Time and Sales data.

According to another embodiment of the invention, it is enhanced with the Matrix Window used in TradeStation. Matrix Window combines the market depth window, an order entry tool, and an order tracking system, all in one window. The user is able to see all bids, bid sizes, asks, ask sizes, last trade and trading volume at each price level for the day. The user can also show bid/ask market depth for futures, equities (including ECNs) and options. By clicking on any row in the Bid or Ask column, the user is able to place an order. The order then appears in the Order column. To cancel an order, the user would mouse click on that order in the Order column. To cancel or replace an order, drag and drop the order to a different price. Once an order is filled, the user can view the open position profit/loss in the P&L column and place an order to close the position at the desired level with a click of your mouse. The Matrix supports the full functionality of TradeStation's Futures, Equities, and Options order execution capabilities. That means that the user can specify order types, order duration, and other settings, in addition to advanced orders for equities, including Show Only, Discretionary, Non-Display, Peg, etc. The Matrix window is similar in design to the standard Level II table available from most systems. The invention is an improvement over the current Matrix Window by giving the user a variety of charts to view all of the Level 1, Level 2, and Time and Sales data messages across time along with any other user defined data sets and user defined time intervals.

According to another embodiment of the invention, it is enhanced with trading features available through the Matrix Window used in TradeStation. The user can place a limit or stop order depending on where the user clicks on the Bid Size and Ask Size columns, without having to change the Order Type. For example, clicking on the Bid Size column above the inside ask will place a stop order, while clicking any row below that will place a limit order. A shortcut menu allows the user to change an order route and/or cancel or replace an order with a single click.

According to another embodiment of the invention, it is enhanced with trading features available in TradeStation. The user can roll an option position to the next expiration date without exposing to other traders by legging out and then back into your position. The user can choose to roll an option position by closing an existing position and creating a new position in the next expiration all in one order.

According to another embodiment of the invention, it is enhanced with trading features available in TradeStation. The user is able to see all bids, bid sizes, asks, ask sizes and last trades for futures, equities (including ECNs), options and Forex. The user can place orders directly from a Market Depth window using the Market Depth Trade Bar. There is a view for open orders and positions in the Market Depth display, as well as the last order message in the Order Status bar. The user can customize the color bands in each column to highlight the best displayed bid and ask quotes at a glance. A depth, size and spread window is also included to help the user to quickly spot possible imbalances in the bid or ask side and to determine support and resistance levels. Finally, the user can view the full depth of the market at every price level.

According to another embodiment of the invention, it is enhanced with the Quotes window features available in TradeStation. It shows the activity of the markets in real-time. The user can create and save multiple quote pages with up to 60 columns, such as: Last Trade, Bid/Ask, Intraday High/Low, $Change, % Change, Volume. The user can save favorite column layouts, including color, font and sorting options. The user has the ability to sort by any column in a quote list, and have all rows dynamically re-sorting in real-time every 5 seconds. The Quotes window has the ability to set alerts on any column or symbol, and have TradeStation instantly notify the user when a high or low threshold is triggered based on last price, bid, ask or volume target. The user can insert the symbols in over 100 built-in Industry Groups, and custom symbol lists, into a Quote window. Industry Groups are stored centrally on servers and include a wide variety of existing Industry Groups and Indexes. The user can also insert all of the components of a particular index, such as the 30 stocks making up the Dow Jones Industrial Average or the 100 stocks making up the Nasdaq 100 Index. There are custom symbol lists that give ability to create and save personal lists of symbols. The invention is an improvement over the current Quotes window by not having a 60 column limit and having the rows updated based on a user-defined interval. The invention is an improvement over the current Quotes window by giving the user a broader and more insightful dataset than existing technologies. TradeStation, for example, is based on trade price and volume, while this invention includes all Level 1, Level 2, and Time and Sales data messages along with any other user defined data sets and user defined time intervals. Additionally, the TradeStation system is updated on a tick-by-tick basis, while the invention is updated much faster, on a message-by-message basis for Level 1, Level 2, and Time and Sales data.

According to another embodiment of the invention, it is enhanced with the Hot Lists features available in TradeStation. The Ranking Lists show the user which stocks are making big moves enabling the user to pinpoint the biggest winners and losers instantly. The user can view the stocks that have experienced the greatest volume or price spikes, with updates every 30 seconds. The user can follow real-time ranked lists for Nasdaq, AMEX and NYSE stocks, revealing the most active stocks and highest gainers or losers, displayed by exchange. The user can see NASDAQ, NYSE and AMEX symbols in a single window, allowing the user to see rankings across all exchanges. The user can add drag and drop over 15 columns, view the highest and lowest price gains in percentage or dollar terms, and view volume increases by either trades or dollars. The invention is an improvement over the current Hot Lists by having the updates based on a user-defined interval, rather than every 30 seconds. The invention is an improvement over the current Hot Lists by giving the user a broader and more insightful dataset than existing technologies. TradeStation, for example, is based on trade price and volume, while this invention includes all Level 1, Level 2, and Time and Sales data messages along with any other user defined data sets and user defined time intervals. Additionally, the TradeStation system is updated on a tick-by-tick basis, while the invention is updated much faster, on a message-by-message basis for Level 1, Level 2, and Time and Sales data.

According to another embodiment of the invention, it is enhanced with the Color-Coded Time & Sales features available in TradeStation. The Time & Sales window lets the user track bids, asks and trades in real-time. A color-coded view of the bid, ask and trade history for a symbol (including date, time, price, volume, price changes and exchange traded) in real-time and for the 10 prior days. This gives the ability to color each trade in the Time & Sales window based on whether it is above the ask price, at the ask price, between the ask price and bid price, at the bid price or below the bid price. If a data correction (tick insertion, deletion or edit) for a symbol in the Time & Sales window is received, it is automatically applied and reflected in the Time & Sales display. Variables included in the window also include Time, Type, Price, Size and Condition of each tick. The condition column indicates trades that do not coincide with current trading activity and the condition type is shown to explain why. For example, an “out of sequence” trade may indicate a price higher or lower than the stock is actually trading. Because this trade is “out of sequence,” the point at which this trade was actually placed is unknown so it is removed from charted data, but will still appear in the Time & Sales window and be flagged as “out of sequence.”

According to another embodiment of the invention, it is enhanced with the Ticker Bar features available in TradeStation. The Ticker Bar offers scrolling real-time quotes and news updates. There is no limit as to the number of ticker symbols that can be tracked and the display can be placed anywhere on the screen. Ticker Hot Lists offer the user the ability to create a ticker that displays symbol rankings based on actives (with updates every 30 seconds). The user can set up and format the displayed symbols and can insert major market or sector indexes. With a right-click of the mouse on any symbol, the user can spawn a Chart Analysis, Level II, or any other window for that symbol. A click of the mouse on any news headline displays the full-text story in a pop-up window. The invention is an improvement over the current Ticker Bar by having the updates based on a user-defined interval, rather than every 30 seconds. The invention is an improvement over the current Ticker Bar by giving the user a broader and more insightful dataset than existing technologies. TradeStation, for example, is based on trade price, while this invention includes all Level 1, Level 2, and Time and Sales data messages along with any other user defined data sets and user defined time intervals. Additionally, the TradeStation system is updated on a tick-by-tick basis, while the invention is updated much faster, on a message-by-message basis for Level 1, Level 2, and Time and Sales data along with any other user defined data sets and user defined time intervals.

According to another embodiment of the invention, it is enhanced with the Streaming News with Real-Time Alerts features available in TradeStation. The user can view full-text news stories gathered from over 45 of the most respected sources, including Business Wire, PR Newswire, Internet Wire and the Knight Ridder/Tribune News Service. With a mouse over any symbol in the story text and TradeStation's ActiveQuotes Tool Tips feature will give the user real-time quotes such as last price and net changes for that symbol, without having to open another window. The user can search for the news by symbol, keywords (such as “mergers”), or logical expressions (such as “analysts ratings”). The user can set alerts based on their specific searches. The user can receive company and industry news, economic and political events, updates on all major financial markets, as well as exclusive columns, interviews with market leaders, and analysis of trends. News stories from The Wall Street Journal, Barron's, and SmartMoney are some examples. The invention is an improvement over the current Streaming News with Real-Time Alerts giving the user a broader and more insightful dataset than existing technologies. TradeStation, for example, is based on trade price, while this invention includes all Level 1, Level 2, and Time and Sales data messages along with any other user defined data sets and user defined time intervals. The user can select an option to automatically perform a Liquidity Flow analysis once a news alert is triggered. The user then can view any of the related charts or tables for that security. Automated trading can be enabled based on the news alert or the chart related alerts. Additionally, the TradeStation system is updated on a tick-by-tick basis, while the invention is updated much faster, on a message-by-message basis for Level 1, Level 2, and Time and Sales data.

According to another embodiment of the invention, it is enhanced with the Research Window features available in TradeStation. The TradeStation Research Window features Reuters fundamental data, gives the user the tools to evaluate stocks from the bottom up. For example, the user can check a stock's valuation, profitability, financial strength, capitalization, and quarterly results. The user can also perform an Industry comparison to measure the stock against its peers. The TradeStation Research Window includes a “Go To” menu, enabling the user to select from 24 research links, including company financials, analyst opinions, research reports, ETF specific links and Bond and Fund Screeners. The Company Research link includes over 250 different fields in 6 different categories. The invention is an improvement over the current Research Window features giving the user a broader and more insightful dataset than existing technologies. TradeStation, for example, is based on trade price, while this invention includes all Level 1, Level 2, and Time and Sales data messages along with any other user defined data sets and user defined time intervals. The user can select an option to automatically perform a Liquidity Flow analysis once a fundamental alert is triggered. The user then can view any of the related charts or tables for that security. Automated trading can be enabled based on the fundamental alert or the chart related alerts. Additionally, the TradeStation system is updated on a tick-by-tick basis, while the invention is updated much faster, on a message-by-message basis for Level 1, Level 2, and Time and Sales data.

According to another embodiment of the invention, the software checks if there are any updates on a centralized server. If updates are available, the software verifies with the user that it is okay to download and install the updates.

According to another embodiment of the invention, the software performs a security check prior to loading. The security check verifies the software serial number, username and password with a centralized database. The centralized database verifies the user has a current subscription to use the software. If the security check in the database indicates an invalid or expired user account, then the software presents a notification dialog box directing the user to contact support personnel to continue operation of the product and the product will not be available for operation.

According to another embodiment of the invention, the user data such as historical Level 1, Level 2, Times and Sales, Earning Ratio, Insider Trading and News Events are downloaded during non-trading hours. The user can define which hours are optimal to perform this download while minimizing the impact to trading activity.

According to another embodiment of the invention, the Graphical User Interface (GUI) forms are customized for each user, depending on their preferences. For example, if a user decides to not subscribe to the Automated Trading feature, that button or checkbox is either grayed out or not present in their particular version of the invention.

According to another embodiment of the invention, the invention can receive the same data type from multiple sources. The multiple sources of data can then be graphed on the same chart, a split chart or on separate charts. The user can then compare the quality, time delay, and accuracy of each data source. For example, a user may desire to have a data source that provides the most real-time Level 2 data, with minimal delay in processing and delivery. By subscribing to several data sources at the same time and plotting the Level 2 data across time for each data source, the user can easily compare the various data sources for minimal delay. The user could also identify anomilies in the data from a specific source when comparing multiple sources, thus concluding the received data from that specific source has suspect quality. The invention can also perform a statistical analysis of the various data feeds and provide a summary report. As an example, the summary report may contain relative time delay between data sources, missing data, and filtered data. The multiple data sources comparison can be applied to any data source outlined in this invention, such as Time and Sales, Level 1, Level 2, News Reports, Options Quotes, Insider Trading Updates, and Fundamental Indicators.

According to another embodiment of the invention, the invention can receive the same data through multiple sources of connectivity. For example, the various connectivity sources can include broad band cable, DSL, dial-up modem, T1 line, and satellite. The multiple sources of connectivity can then be graphed on the same chart, a split chart or on separate charts. The user can then compare the time delay of each connectivity source. For example, a user may desire to have a data source that provides the most real-time Level 2 data, with minimal delay in processing and delivery. By subscribing to several connectivity sources at the same time and plotting the Level 2 data across time for each connectivity source, the user can easily compare the various connectivity sources for minimal delay. The invention can also perform a statistical analysis of the various data connectivity sources and provide a summary report. As an example, the summary report may contain relative time delay between data connectivity sources. The multiple data connectivity sources comparison can be applied to any data source outlined in this invention, such as Time and Sales, Level 1, Level 2, News Reports, Options Quotes, Insider Trading Updates, and Fundamental Indicators.

An architecture, process and computer system has been described as useful for securities liquidity flow analysis and securities trading. Specific applications and exemplary embodiments of the invention that provide a basis for practicing the invention in a variety of ways and in a variety of circuit structures have been illustrated and discussed. Numerous variations are possible within the scope of the invention. Features and elements associated with one or more of the described embodiments are not to be construed as required elements for all embodiments. The invention is limited only by the claims that follow.

What is claimed is:

1. A method for analyzing whether to purchase or sale a security or an option for a security, the method comprising:
receiving trading data associated one or more securities;
defining analysis parameters for the trading data;
defining one or more analysis alerts for the trading data;
analyzing the trading data according to the analysis parameters and the analysis alerts to generate analysis results;
displaying selected elements of the trading data and the analysis results in accordance with the defined display parameters; and
displaying a trading alert or engaging in a securities trade or simulating a securities trade in response to the analysis results.

2. The method of claim 1 wherein the trading data comprises one or more of insider trading information, security trade price information, news events, financial results for an industry sector, financial results for one or more companies with issued securities, security orders to buy or sell, security trading information, option orders, option trading information, level one data, level two data and time and sales data.

3. The method of clam 1 wherein the trading data comprises level one data and level two data, wherein the level one data further comprises one or more of a last trade price, a best bid price, a best ask price, and the level two data further comprises one or more of bid prices, bid times, bid volumes, a security identifier, an ask price, an ask time, an ask volume and a security identifier and a market maker identifier associated with each level two data element.

4. The method of claim 3 wherein the level one and level two data are grouped within one of a plurality of tiers.

5. The method of claim 1 wherein the trading data comprises trading information from user-selected market makers, exchanges and ECN'S.

6. The method of claim 1 wherein the trading data comprises trading data associated with a plurality of securities or with an identified security.

7. The method of claim 1 wherein the trading data comprises trading data of insider traders for securities in which the insider traders hold a position.

8. The method of claim 1 wherein the step of receiving trading data comprises receiving trading data from a plurality of sources, and wherein the step of analyzing comprises comparing the trading data from the plurality of sources.

9. The method of claim 1 wherein the step of receiving trading data comprises receiving trading data over a plurality of different connectivity sources, and wherein the step of analyzing comprises comparing the trading data from the plurality of connectivity sources.

10. The method of claim 1 wherein the analysis parameters comprise gain trade opportunities and gain loss opportunities during a predetermined time window, and wherein the step of displaying displays one or both of the gain trade and gain loss opportunities.

11. The method of clam 1 wherein the analysis parameters relate to level two data for a security and the step of analyzing determines subsequent price changes in the security.

12. The method of claim 1 wherein the analysis parameters relate to bid and ask prices and their corresponding volumes over a time interval.

13. The method of claim 12 wherein the analysis parameters relate to a market maker for a specific security.

14. The method of claim 1 wherein the analysis parameters comprise user-defined patterns in one or more of level one information, level two information and time and sales information.

15. The method of clam 1 wherein the analysis parameters comprise best bid price, best ask price, total trade volume, bid price for an identified trader, ask price for an identified trader, bid volume for an identified trader and ask volume for an identified trader within a predetermined time interval.

16. The method of claim 1 wherein the analysis parameters comprise most active securities in trading volume, most active stocks in share trade price change, securities with the highest gain and securities with the highest loss.

17. The method of claim 1 wherein the step of analyzing comprises:
determining that a relationship between a first element of trading data or an analysis parameter derived from the first element of trading data and a second element of trading data or an analysis parameter derived from the second element of trading data satisfies a first condition over a defined time interval;
determining that a relationship between a third element of trading data or an analysis parameter derived from the third element of trading data and a fourth element of trading data or an analysis parameter derived from the fourth element of trading data satisfies a second condition over a defined time interval; and
determining whether a third defined relationship exists between the first condition and the second condition.

18. The method of claim 17 wherein the first, second, third and fourth elements of trading data comprise one of bid volume, ask volume, last securities price, bid price, ask price and last traded volume during user-defined time intervals.

19. The method of claim 17 wherein the first and the second desired relationships comprise a correlation factor.

20. The method of claim 17 wherein the third defined relationship is identified by an algorithm number

21. The method of claim 1 wherein the step of analyzing comprises analyzing the trading data from one or more user-selected market makers, exchanges and ECN'S.

22. The method of claim 1 wherein the step of analyzing comprises identifying a first time period during which a trade price of the security has experienced a largest increase or a largest decrease during a second time period.

23. The method of claim 1 wherein the step of analyzing further comprises determining a statistical measure of the trading data

24. The method of claim 23 wherein the statistical measure comprises a moving average, an average during a predetermined time frame, an exponential moving average, a weighted moving average and a moving average ratio of bid volumes and ask volumes.

25. The method of claim 1 wherein the step of analyzing further comprises analyzing current trading data according to user-defined thresholds and user-defined market patterns.

26. The method of claim 1 wherein the step of analyzing further comprises conducting a statistical analysis of level two data, the statistical analysis further comprising an average, moving average, convergence, divergence, momentum relative strength index and on-balance volume.

27. The method of claim 1 wherein the step of analyzing further comprises determining a relationship between level two data and subsequent price activity for the security over a determined time interval.

28. The method of claim 1 wherein the step of analyzing further comprises analyzing bids and asks over a plurality of time windows for isolating short and long term trading patterns.

29. The method of claim 1 wherein the trading data comprises a first group of liquidity variables further comprising one or more of bid volume, bid price, ask price and ask volume for each market maker and last trade price and last trade volume, and wherein the analysis parameters comprise a second group of liquidity variables further comprising one or more of bid volume and ask volume per price tier, a statistical bid volume and a statistical ask volume per price tier over a predetermined time interval and a statistical bid volume and a statistical ask volume for each market maker over a predetermined time interval.

30. The method of claim 29 wherein the analysis results comprise user-defined security trades based on the first and second group of liquidity variables.

31. The method of claim 1 wherein the step of analyzing comprises determining an imbalance between supply and demand for a security and a resulting price reaction to the security imbalance.

32. The method of claim 1 wherein the analysis alerts relate to one or more of insider trading activity, security orders, security trading prices, security trading volume, news events, publicly reported financial results, option orders, option trading prices, option trading volume, level one data, level two data and time and sales data.

33. The method of claim 1 wherein the step of displaying selected elements of the trading data comprises displaying selected elements of trading data from selected market payers between a start time and an end time.

34. The method of claim 1 wherein the step of displaying or engaging further comprises trading in a security or an option or simulating trading in a security or an option.

35. The method of claim 34 wherein the step of simulating trading comprises simulating a securities trade using level two data to determine the likelihood that the simulated trade would have occurred.

36. The method of claim 1 wherein a trading alert comprises a liquidity imbalance.

37. The method of claim 1 wherein the step of engaging in the securities trade comprises exiting a position in an identified security, placing a bid or a short order for the identified security, covering a short position of the identified security or executing a simulated trade for the identified security.

38. The method of claim 1 further comprising identifying errors in engaged securities trades.

39. The method of claim 1 wherein the trading alert is provided to a user as a message on a computer screen, as an email addressed to the user, as a text message sent to a user's mobile phone or to a user's pager.

40. The method of claim 1 further comprising a replay mode wherein the step of analyzing is executed on historical trading data and the method further comprising a simulating trading step using the historical data.

41. The method of claim 1 further comprising a step of identifying a liquidity trade imbalance and a security price reaction in response thereto over a time interval.

42. The method of claim 1 wherein the method is executed by a stand-alone device or by as a module for use with existing trading products.

43. The method of claim 1 wherein the step of analyzing the trading data further comprises determining whether a trailing stop, market stop, sell algorithm or cover algorithm indicate that a user should exit the securities position.

44. The method of claim 1 wherein the step of analyzing the trading data comprises determining whether a user should enter a new position for a security.

45. A method for analyzing whether to purchase or sale a product, the method comprising:
receiving trading data related to purchase prices, sale prices, purchase volumes and sale volumes for the product from a plurality of buyers and sellers for a predetermined time interval;
defining analysis parameters for the trading data;
defining one or more analysis alerts for the trading data;
analyzing the trading data according to the analysis parameters and the analysis alerts to generate analysis results;
displaying selected elements of the trading data and the analysis results; and
engaging in a product purchase or sell responsive to the analysis results.

46. The method of claim 45 wherein the trading data comprises one or more of product price information, news events, financial results for an industry associated with the product, orders to buy or sell the product, option orders

47. The method of claim 45 wherein the analysis parameters comprise gain trade opportunities and gain loss opportunities, product volumes, best bid price, best ask price, total trade volume, bid price, bid volume, ask price or ask volume for an identified purchaser or seller of the product within a predetermined time interval.

48. The method of claim 45 wherein the step of analyzing further comprises determining a statistical measure of the trading data, the statistical measure comprising one of a moving average, an average during a predetermined time frame, an exponential moving average, a weighted moving average.

49. A computer program product for executing by a computer, the computer program product for analyzing whether to purchase or sale a security or an option for a security, the computer program product comprising:
a computer readable storage medium for storing computer readable program code modules, the computer readable program code modules comprising:
a computer readable first program code module for receiving trading data associated with the one or more securities;
a computer readable second program code module for defining analysis parameters for the trading data;
a computer readable third program code module for defining one or more analysis alerts for the trading data;
a computer readable fourth program code module for analyzing the trading data according to the analysis parameters and the analysis alerts to generate analysis results;
a compute readable fifth program code module for displaying selected elements of the trading data and the analysis results in accordance with the defined display parameters; and
a computer readable sixth program code module for displaying a trading alert or engaging in a securities trade or a simulated securities trade in response to the fourth program code module.
